(19) United States
(12) Patent Application Publication
(10) Pub. No.: US 2002/0162409 A1
(43) Pub. Date: Nov. 7, 2002

(54) Thrust converter, and method and apparatus for controlling thrust converter

(76) Inventors: Hidenobu Ito, Tokyo (JP); Seiichi Mimura, Tokyo (JP); Kouichi Takamune, Tokyo (JP); Takao Mizutani, Tokyo (JP)

Correspondence Address: Sughrue Mion, 2100 Pennsylvania Avenue NW, Washington, DC, 20037-3213, US

(21) Appl. No.: 10/049,309

(22) PCT Filed: Feb. 14, 2001
(86) PCT No.: PCT/JP01/01033

(30) Foreign Application Priority Data
Jun. 13, 2000 (JP) 2000-176749

(51) Int. Cl. F16H 25/20; B23B 31/26

(52) U.S. Cl. 74/89.23

(57) ABSTRACT

To obtain a thrust converter constituted by a reciprocating means 1, a reciprocation-to-rotation converting means 5 for converting a reciprocating motion of the reciprocating means 1 into a rotary motion, a rotation-to-reciprocation converting means 11 located on the same axial line as that of the reciprocation-to-rotation converting means 5 for converting the rotary motion of the reciprocation-to-rotation converting means 5 into a reciprocating motion, a reaction force receiving means 15 for receiving reaction force against the reciprocating motion of the rotation-to-reciprocation converting means 11, and a moving means 92 for moving the reciprocation-to-rotation converting means 5 and the rotation-to-reciprocation converting means 11 in an axial direction separately from driving force due to the reciprocating motion of the reciprocating means 1. Accordingly, the length for the trust converting quantity can be shortened in proportion to the ratio of the stroke.

### TECHNICAL FIELD

The present invention relates to a thrust converter for driving a pressing working machine, a chucking machine for holding a work on a lathe, or the like, and a method and apparatus for controlling the thrust converter.

### BACKGROUND ART

Generally, a driving source using a thrust force due to a hydraulic cylinder or a pneumatic cylinder is in most cases used as a source for driving a press working machine or as a source for driving a chucking machine for holding a work on a machine tool or the like.

In the press working or chucking machine using such a hydraulic or pneumatic cylinder, however, the thrust force is determined on the basis of the pressure allowed to be generated by hydraulic or pneumatic equipment and the diameter of the cylinder. If a large amount of thrust force is required, the equipment must be changed to equipment having a large capacity. There were various problems such as increase in cost, and so on.

On the other hand, there is a reduction gear using gears as a torque amplifying (or torque reducing) mechanism. Generally, the reduction gear receives an input as a rotation input, amplifies (or reduces) the rotation input and outputs it as a rotation output. To amplify (or reduce) an axial input (thrust) and output it as an axial output (thrust), mechanical parts such as various gears or the like need to be combined. Accordingly, this brings about increase in size. Moreover, reaction force is applied on bearings for rotatably bearing the gears. Accordingly, there is a problem such as reduction in the life of the reduction gear or the like. Therefore, there has been required an inexpensive, small-size, simple-configuration and long-life thrust converter in which the axial input (thrust) can be amplified (or reduced) so as to be output as an axial output (thrust).

When, for example, a reduction gear using a gearing mechanism for amplifying the rotational torque of a motor is used as shown in a chucking machine disclosed in JP-A-62-34708, an electromagnetic clutch is required for disconnecting a draw bar driving system and a main shaft rotating system from each other at the time when a work is being worked. Hence, there arises a problem that the number of parts increases to bring about increase in cost.

In the electrically-operated chucking machine, an axial thrust force is given to the draw bar to thereby grip the work. At the time when the work is being worked, however, the bearing rotatably supporting the draw bar receives all reaction force of the axial thrust. Hence, there are various problems, for example, the life of the bearing is reduced a lot because of increase in the rotational velocity of the main shaft or because of holding force strengthened by increase in the axial thrust of the draw bar.

Therefore, to solve the above-mentioned various conventional problems, the inventors of the present invention have proposed (invented) a totally novel thrust converter as shown in FIG. 24.

FIG. 24 is a partly cross-sectional view of a chucking machine to which the thrust converter proposed by the inventors is applied.

In FIG. 24, the reference numeral 600 designates a motor rotation-to-reciprocation converting means as a motor rotation-to-reciprocation converting means. The motor rotation-to-reciprocation converting means 600 includes: a servomotor 601; a motor shaft 601a; a third screw shaft 602 fixed at a load-side end of the motor shaft 601a; a third nut 603 thread-engaged with the third screw shaft 602; a motor load-side end bracket 604b; and a third linear guide 605 for whirl-stopping the third nut 603 movable only axially relative to the motor load-side end bracket 604b. A motor rotational position detecting portion 606 which is means for detecting the rotational position of the motor is disposed at an end reverse to the load-side end of the motor shaft 601a.

The reference numeral 200 designates a reciprocation-to-rotation converting means as a reciprocation-to-rotation converting means. The reciprocation-to-rotation converting means 200 includes: a first screw shaft 203 thread-engaged with the first nut 201 in the condition that a non-thread-engagement portion of the first nut 201 extended to the motor-side end is rotatably and axially immovably supported through a second bearing 202 relative to a non-thread-engagement portion of the third nut 603 extended to the end reverse to the motor-side end; a main rotary shaft 204; and a first linear guide 205 for whirl-stopping the first nut 201 movable only axially relative to the main rotary shaft 204.

The reference numeral 300 designates a rotation-to-reciprocation converting means as a rotation-to-reciprocation converting means. The rotation-to-reciprocation converting means 300 includes: a second nut 301 fixed in the inside of the first screw shaft 203; a second screw shaft 302 thread-engaged with the second nut 301; a main rotary shaft 204; and a second linear guide 303 for whirl-stopping the second screw shaft 302 movable only axially relative to the main rotary shaft 204. A pull rod 500 is fixed at a front end of the second screw shaft 302.

The reference numeral 400 designates a reaction force receiving portion as a reaction force receiving means. The reaction force receiving portion 400 includes: a main rotary shaft 204; a first screw shaft 203; and a first bearing 401 for bearing the first screw shaft 203 rotatable and axially immovable relative to the main rotary shaft 204.

A rear end of the main shaft 502 is fixed at the load-side end of the main rotary shaft 204 through an adapter 501a. A chuck 503 is fixed at a front end of the main shaft 502 through an adapter 501b. A draw bar 504 is axially movably inserted in an axial center hollow portion of the main shaft 502. A front end of the draw bar 504 is fitted to a chuck claw 506 through an operation converting mechanism 505. The operation converting mechanism 505 converts an axial operation of the drawbar 504 into a radial operation of the chuck claw 506 through a cam lever, a taper, or the like. A rear end of the draw bar 504 is fixed to a front end of the pull rod 500.

A motor 601 and a main shaft motor portion 507 are fixed to each other through a mount frame 508. Hence, the rotation-to-reciprocation converting means 600, the reciprocation-to-rotation converting means 200, the rotation-to-reciprocation converting means 300, the reaction force receiving portion 400 and the second bearing 202 are supported by the main shaft motor portion 507.

The operation will be described below with reference to FIG. 23.

In the chuck drive machine configured as described above, when the motor shaft 601a rotates with predetermined rotational torque, the third screw shaft 602 fixed at the load-side end of the motor shaft 601a also rotates. The third nut 603 thread-engaged with the third screw shaft 602 moves axially because the third linear guide 605 whirl-stops the third nut 603 only axially movably. Hence, the rotational motion torque of the motor shaft 601a and the third screw shaft 602 is converted into thrust force for axial movement of the third nut 603.

When the third nut 603 moves axially, the first nut 201 rotatably and axially immovably supported through the second bearing 202 is also moved axially by the thrust force for the axial movement of the third nut 603.

When the first nut 201 is pressed axially, the first screw shaft 203 thread-engaged with the first nut 201 rotates because the first linear guide 205 whirl-stops the first nut 201 only axially movably. Hence, the thrust force for the axial movement of the first nut 201 is converted into rotational torque for rotational motion of the first screw shaft 203.

When the first screw shaft 203 rotates, the second nut 301 fixed in the inside of the first screw shaft 203 also rotates. Hence, the second screw shaft 302 thread-engaged with the second nut 301 moves axially because the second linear guide 303 whirl-stops the second screw shaft 302 only axially movably. Hence, the rotational motion torque of the second nut 301 is converted into thrust force for axial movement of the second screw shaft 302.

When the second screw shaft 302 moves axially, the pull rod 500 fixed to the second screw shaft 302 moves axially. Hence, the draw bar 504 fixed to the pull rod 500 moves axially with the same thrust force, so that the axial movement of the draw bar 504 is converted into the radial movement of the chuck claw 506. Hence, the chuck 503 holds the work 508.

When the main shaft 502 is rotated by the main shaft motor portion 507 after the work 508 is held by the chuck claw 506, the work 508 is cut while the draw bar 504, the chuck 503, the operation converting mechanism 505, the work 508, the adapters 501a and 501b, the pull rod 500, the rotation-to-reciprocation converting means 300 and the reciprocation-to-rotation converting means 200 are dragging.

Even in the case where the main shaft 502 rotates, the motor rotation-to-reciprocation converting means 600 never rotates because the first nut 201 of the rotation-to-reciprocation converting means 200 is rotatably supported by the bearing 202 of the third nut 603 of the motor rotation-to-reciprocation converting means 600.

Incidentally, here is the relation:

F1=(2π·TM·η)/L1 (Expression 1)

in which TM is the rotational torque for rotational motion of the motor rotary shaft 601a and the third screw shaft 602, F1 is the thrust force for pressing the third nut 603 axially, L1 is the screw lead of the third nut 603, and η is the rotation-to-reciprocation converting efficiency.

When the first nut 201 is pressed by the axial thrust force of the third nut 603, the first screw shaft 203 thread-engaged with the first nut 201 rotates. Hence, the thrust force for axial movement of the first nut 201 is converted into rotational torque for rotational motion of the first screw shaft 203.

Here is the relation:

T2=(L2·F1·2)/2π (Expression 2)

in which F1 is the thrust force for pressing the first nut 201 as obtained in the above description, T2 is the rotational torque of the first screw shaft 203, L2 is the lead of the first nut 201, and η2 is the reciprocation-to-rotation converting efficiency.

When the first screw shaft 203 rotates, the second nut 301 fixed in the inside of the first screw shaft 203 also rotates. Hence, the second screw nut 302 thread-engaged with the second nut 301 moves axially. Hence, the rotational motion torque of the second nut 301 is converted into thrust force for axial movement of the second screw shaft 302.

Here is the relation:

F3=(2π·T2·η3)/L3 (Expression 3)

in which T2 is the rotational torque for rotational motion of the first screw shaft 203 and the second nut 301 as obtained in the above description, F3 is the thrust force for axial movement of the second screw shaft 302, L3 is the screw lead of the second screw shaft 302, and η3 is the rotation-to-reciprocation converting efficiency.

From the expressions 2 and 3, the axial movement thrust force F1 given from the servomotor 601 to the first nut 201 and the axial thrust force F3 generated in the second screw shaft 302 have the relation:

F3/F1=(L2/L3)·ηc (Expression 4)

in which ηc is the motion conversion efficiency of the screw.

That is, when screw leads of L2>L3 are formed, the thrust force F3 generated in the second screw shaft 302 is converted into amplified thrust force which is (L2/L3)·ηc times as large as the thrust force F1, that is, the thrust force F3 is generated as the amplified thrust force. Even in the case where the thrust force of the servomotor 601 is small, a large amount of thrust force for axial movement can be obtained in the pull rod 500.

When the pull rod 500 and the draw bar 504 are moved axially toward the side reverse to the load side by the amplified thrust force F3, the operation converting mechanism 505 converts the axial operation into the radial operation of the chuck claw 506. Hence, the chuck 503 holds the work 508 by the amplified holding force.

Incidentally, as is obvious from the expression 4, a larger amount of thrust force F3 can be obtained by smaller rotational torque TM if the lead L2 of the first nut 201 is made large. When, for example, the motion conversion efficiency of the screw is 100%, F1 is amplified to 100 times in the case of L2=100 mm and L3=1 mm. Assuming that the stroke of the draw bar 504 required for opening/closing the chuck claw 506 is 15 mm, then 15 revolutions of the second nut 301 are required for moving the second screw shaft 302 by 15 mm.

Accordingly, 15 revolutions of the first screw shaft 203 are required for 15 revolutions of the second nut 301. Because the lead L2 of the first nut 201 is 100 mm, the first nut 201 needs to have a length sufficient to move by 1500 mm. Accordingly, there is a problem that the axial length of the thrust converter becomes long.

### DISCLOSURE OF THE INVENTION

The present invention is devised to solve the aforementioned problems and an object thereof is to provide a thrust converter in which the axial length of a thrust conversion portion can be shortened in accordance with a necessary stroke ratio.

Another object of the present invention is to provide a method and apparatus for controlling the thrust converter.

Although the present invention is devised for various objects, these objects will become clear from the description of the best mode for carrying out the present invention which will be described later.

Accordingly, according to the present invention, there is provided a thrust converter constituted by: a reciprocating means; a reciprocation-to-rotation converting means for converting a reciprocating motion of the reciprocating means into a rotary motion; a rotation-to-reciprocation converting means located on the same axial line as that of the reciprocation-to-rotation converting means for converting the rotary motion of the reciprocation-to-rotation converting means into a reciprocating motion; a reaction force receiving means for receiving reaction force against the reciprocating motion of the rotation-to-reciprocation converting means; and a moving means for moving the reciprocation-to-rotation converting means and the rotation-to-reciprocation converting means in an axial direction separately from driving force due to the reciprocating motion of the reciprocating means.

Further, according to the present invention, there is provided a thrust converter configured such that, when the reciprocation-to-rotation converting means and the rotation-to-reciprocation converting means are moved by the moving means, a quantity of the movement is absorbed by a part of the reciprocating means.

Further, according to the present invention, there is provided a thrust converter configured such that the moving means includes: a connection means having a first screw, and a second screw thread-engaged with the first screw; and a driving means for driving rotation of at least one screw of the connection means to thereby move the reciprocation-to-rotation converting means and the rotation-to-reciprocation converting means.

Further, according to the present invention, there is provided a thrust converter configured such that the moving means includes: a connection means having a first screw, and a second screw thread-engaged with the first screw; a driving means for driving rotation of both screws of the connection means to thereby move the reciprocation-to-rotation converting means and the rotation-to-reciprocation converting means; and a rotation transferring means constituted by gears and interposed between the driving means and the connection means for transferring driving force of the driving means so that the first and second screws of the connection means rotate at different rotational velocities.

Further, according to the present invention, there is provided a thrust converter configured such that the moving means includes: a connection means having a first screw, and a second screw thread-engaged with the first screw; a driving means for driving rotation of at least one screw of the connection means to thereby move the reciprocation-to-rotation converting means and the rotation-to-reciprocation converting means; and a transfer/disconnection means interposed between the driving means and the connection means for transferring driving force of the driving means to the connection means and disconnecting the transfer.

Further, according to the present invention, there is provided a thrust converter configured such that the moving means includes: a motor having a feed screw on its rotary shaft; a moving shaft thread-engaged with a feed screw portion of the rotary shaft so that the moving shaft moves axially with the rotation of the rotary shaft and stops in a predetermined position to rotate; a first driving gear provided on the moving shaft; a second driving gear provided on the moving shaft at a predetermined distance from the first driving gear; a connection means having a first screw, and a second screw thread-engaged with the first screw; a first driven gear provided on the first screw of the connection means so as to mesh with the first driving gear; and a second driven gear provided on the second screw of the connection means so as to mesh with the second driving gear and having teeth different in number from those of the first driven gear, wherein: the motor is driven to move the moving shaft to a position where the first and second driving gears and the first and second driven gears mesh with each other simultaneously; the moving shaft is stopped in this position and driven to rotate to thereby drive the first and second screws of the connection means to rotate by differential motion through the first and second driving gears and the first and second driven gears to move the reciprocation-to-rotation converting means and the rotation-to-reciprocation converting means to predetermined positions; and when the reciprocation-to-rotation converting means and the rotation-to-reciprocation converting means are moved to the predetermined positions, the moving shaft is moved to a position where the first and second driving gears do not mesh with the first and second driven gears respectively.

Further, according to the present invention, there is provided a thrust converter configured such that the moving means includes: a motor having a feed screw on its rotary shaft; a moving shaft thread-engaged with a feed screw portion of the rotary shaft so that the moving shaft moves axially with rotation of the rotary shaft and stops in a predetermined position to rotate; a driving gear provided on the moving shaft; a connection means having a first screw, and a second screw thread-engaged with the first screw; a driven gear provided on the first screw of the connection means so as to mesh with the driving gear; and a whirl-stop means for whirl-stopping the second screw of the connection means at a desired time; wherein the motor is driven to move the moving shaft to a position where the driving gear and the driven gear mesh with each other; the moving shaft is stopped in this position and driven to rotate while the second screw is whirl-stopped by the whirl-stop means to thereby drive the first screw of the connection means to rotate through the driving gear and the driven gear to move the reciprocation-to-rotation converting means and the rotation-to-reciprocation converting means to predetermined positions; and when the reciprocation-to-rotation converting means and the rotation-to-reciprocation converting means are moved to the predetermined positions, the moving shaft is moved to a position where the driving gear does not mesh with the driven gear.

Further, according to the present invention, there is provided a thrust converter configured such that the moving means includes: a connection means having a first screw, and a second screw thread-engaged with the first screw; a motor using the first screw of the connection means as a rotor; and a whirl-stop means for whirl-stopping the second screw of the connection means at a desired time, wherein, in a condition that the second screw of the connection means is whirl-stopped by the whirl-stop means, the motor is driven to drive the first screw of the connection means to rotate to thereby move the reciprocation-to-rotation converting means and the rotation-to-reciprocation converting means to predetermined positions.

Further, according to the present invention, there is provided a thrust converter configured such that the moving means includes: a connection means having a first screw, and a second screw thread-engaged with the first screw; a first motor using the first screw of the connection means as a rotor; and a second motor using the second screw of the connection means as a rotor, wherein, in a condition that the second screw of the connection means is whirl-stopped by excitation of the second motor, the first motor is driven to drive the first screw of the connection means to rotate to thereby move the reciprocation-to-rotation converting means and the rotation-to-reciprocation converting means to predetermined positions.

Further, according to the present invention, there is provided a thrust converter configured such that the moving means includes: a connection means having a first screw, and a second screw thread-engaged with the first screw; and a motor using the first screw of the connection means as a first rotor and using the second screw of the connection means as a second rotor, the first rotor being different in number of poles from the second rotor, wherein the motor is driven to drive the first and second screws of the connection means to rotate to thereby move the reciprocation-to-rotation converting means and the rotation-to-reciprocation converting means to predetermined positions.

Further, according to the present invention, there is provided a thrust converter configured such that the reciprocating means includes: a motor; and a motor rotation-to-reciprocation converting means for converting a rotary motion of the rotary shaft of the motor into a reciprocating motion.

Further, according to the present invention, there is provided a thrust converter configured such that the reciprocating means includes: a motor disposed on an axis different from the axial line of the reciprocation-to-rotation converting means; a motor rotation-to-reciprocation converting means disposed on the same axis as the axial line of the reciprocation-to-rotation converting means for converting a rotary motion of the rotary shaft of the motor into a reciprocating motion; and a motor rotation transferring means for transferring the rotation driving force of the motor to the motor rotation-to-reciprocation converting means.

Further, according to the present invention, there is provided a thrust converter configured such that the reciprocating means includes: a motor disposed on an axis different from the axial line of the reciprocation-to-rotation converting means; a motor rotation-to-reciprocation converting means disposed on an axis the same as an axial line of a rotary axis of the motor for converting a rotary motion of the rotary shaft of the motor into a reciprocating motion; and a thrust transferring means for transferring the axial thrust force of the motor rotation-to-reciprocation converting means to the reciprocation-to-rotation converting means.

Further, according to the present invention, there is provided a thrust converter configured such that the motor rotation-to-reciprocation converting means has a screw provided on the rotary shaft of the motor, and a nut thread-engaged with the screw; and the thrust transferring means has a reciprocating portion for supporting a bearing for rotatably bearing the reciprocation-to-rotation converting means, and a thrust transfer plate for connecting the reciprocating portion and the nut to each other.

Further, according to the present invention, there is provided a thrust converter configured such that the thrust transfer plate is connected to the nut through a flexible coupling.

Further, according to the present invention, there is provided a thrust converter configured such that one screw of the connection means is rotatably supported with respect to the reciprocation-to-rotation converting means.

Further, according to the present invention, there is provided a thrust converter configured such that one screw of the connection means is rotatably supported with respect to the reciprocation-to-rotation converting means, and the other screw of the connection means is rotatably supported with respect to a part of the reaction force receiving means.

Further, according to the present invention, there is provided a thrust converter configured such that the whirl-stop means is constituted by an electromagnetic brake, and a part of the whirl-stopped screw of the connection means is provided as a brake disk.

Further, according to the present invention, there is provided a thrust converter configured such that the whirl-stop means is constituted by an electromagnetic brake, and the second screw prohibited from rotating by the electromagnetic brake is connected to an external driving means.

Further, according to the present invention, there is provided a control method for controlling such a thrust converter, constituted by the steps of: driving the moving means to move the reciprocation-to-rotation converting means and the rotation-to-reciprocation converting means to predetermined positions; and driving the reciprocating means after the arrival of the reciprocation-to-rotation converting means and the rotation-to-reciprocation converting means at the predetermined positions to thereby operate the reciprocating portion of the rotation-to-reciprocation converting means through the reciprocation-to-rotation converting means and the rotation-to-reciprocation converting means.

Further, according to the present invention, there is provided a control method for controlling such a thrust converter, constituted by the steps of: performing an operation in a first operation mode in which, in a condition that the moving means is stopped, the reciprocating means is driven to operate the reciprocating portion of the rotation-to-reciprocation converting means through a reciprocation-rotation means and the rotation-to-reciprocation converting means; performing an operation in a second operation mode in which the moving means is driven to move the reciprocation-to-rotation converting means and the rotation-to-reciprocation converting means; and limiting driving force for at least one of the reciprocating means and the moving means when thrust force is generated.

Further, according to the present invention, there is provided a controller for controlling such a thrust converter, constituted by means for driving the moving means to move the reciprocation-to-rotation converting means and the rotation-to-reciprocation converting means to predetermined positions and for driving the reciprocating means after the arrival of the reciprocation-to-rotation converting means and the rotation-to-reciprocation converting means at the predetermined positions to thereby operate the reciprocating portion of the rotation-to-reciprocation converting means through the reciprocation-to-rotation converting means and the rotation-to-reciprocation converting means.

Further, according to the present invention, there is provided a controller for controlling such a thrust converter, constituted by means for performing an operation in a first operation mode in which, in a condition that the moving means is stopped, the reciprocating means is driven to operate the reciprocating portion of the rotation-to-reciprocation converting means through a reciprocation-rotation means and the rotation-to-reciprocation converting means, for performing an operation in a second operation mode in which the moving means is driven to move the reciprocation-to-rotation converting means and the rotation-to-reciprocation converting means, and for limiting driving force for at least one of the reciprocating means and the moving means when thrust force is generated.

Further, according to the present invention, there is provided a method for controlling such a thrust converter, constituted by the steps of: making sensors detect the positions of teeth of the driving gear and the driven gear when the driving gear is made to mesh with the driven gear; and rotating the gears at angles enabling the mesh on the basis of signals detected by the sensors.

Further, according to the present invention, there is provided a controller for controlling such a thrust converter, constituted by: sensors for detecting the positions of teeth of the driving gear and the driven gear; and means for rotating the gears at angles enabling the gears in mesh on the basis of signals detected by the sensors when the driving gear is made to mesh with the driven gear.

Further, according to the present invention, there is provided a controlling method for controlling such a thrust converter, constituted by the steps of: storing gear angles at a time of shifting from a gear mesh state to a gear separation state; stopping rotation of the first and second driving gears in the gear separation state; and rotating the first and second driven gears at the stored gear angles when the first and second driving gears are made to mesh with the first and second driven gears from the gear separation state.

Further, according to the present invention, there is provided a controller for controlling such a thrust converter, constituted by: a storage means for storing gear angles at the time of shifting from a gear mesh state to a gear separation state; means for stopping the rotation of the first and second driving gears in the gear separation state; and means for reading the gear angles stored in the storage means and rotating the first and second driven gears at the gear angles when the first and second driving gears are made to mesh with the first and second driven gears from the gear separation state.

Further, according to the present invention, there is provided a method for controlling such a thrust converter, constituted by the steps of: performing an operation to drive the moving means and the reciprocating portion of the rotation-to-reciprocation converting means in reverse directions to each other; and restoring the thrust converter to an origin on the basis of a position where the thrust converter arrives at an operating range limit due to a mechanism limitation of either a mechanical stopper or the thrust converter.

Further, according to the present invention, there is provided a controller for controlling such a thrust converter, constituted by means for performing an operation to drive the moving means and the reciprocating portion of the rotation-to-reciprocation converting means in reverse directions to each other and for restoring the thrust converter to an origin on the basis of a position where the thrust converter arrives at an operating range limit due to a mechanism limitation of either a mechanical stopper or the thrust converter.

Further, according to the present invention, there is provided a controller for controlling such a thrust converter, constituted by: a high-order controller; a first controller for controlling the moving means; and a second controller for controlling the reciprocating means, wherein, in a second operation mode in which the moving means is driven to move the reciprocation-to-rotation converting means and the rotation-to-reciprocation converting means, the first controller controls the moving means on the basis of an instruction given from the high-order controller and outputs an instruction based on a quantity of movement of the moving means to the second controller, and the second controller controls the reciprocating means on the basis of the instruction based on a quantity of movement of the moving means from the first controller, and in a first operation mode in which the reciprocating means is driven to operate the reciprocating portion of the rotation-to-reciprocation converting means through a reciprocation-rotation means and the rotation-to-reciprocation converting means in a condition that the moving means is stopped, the second controller controls the reciprocating means on the basis of an instruction outputted from the high-order controller and inputted through the first controller.

### BRIEF DESCRIPTION OF THE DRAWINGS

FIG. 1 is a view in vertical section of a chucking machine to which a thrust converter according to First embodiment for carrying out the present invention is applied;

FIG. 2 is a view for explaining the operation according to First embodiment;

FIG. 3 is a view in vertical section of a chucking machine to which a thrust converter according to Second embodiment for carrying out the present invention is applied;

FIG. 4 is a view for explaining the operation according to Second embodiment;

FIG. 5 is a view in vertical section of a chucking machine to which a thrust converter according to Third embodiment for carrying out the present invention is applied;

FIG. 6 is a view in vertical section of a chucking machine to which a thrust converter according to Fourth embodiment for carrying out the present invention is applied;

FIG. 7 is a view in vertical section of a main part of a chucking machine to which a thrust converter according to Fifth embodiment for carrying out the present invention is applied;

FIG. 8 is a view in vertical section of a main part of a chucking machine to which a thrust converter according to Sixth embodiment for carrying out the present invention is applied;

FIG. 9 is a view in vertical section of a main part of a chucking machine to which a thrust converter according to Seventh embodiment for carrying out the present invention is applied;

FIG. 10 is a view showing the configuration of an apparatus according to Ninth embodiment for carrying out the present invention for controlling the chucking machine to which the thrust converter according to First embodiment for carrying out the present invention is applied;

FIG. 11 is a flow chart showing the operation (of closing the chuck claw) of the apparatus according to Ninth embodiment for carrying out the present invention for controlling the chucking machine to which the thrust converter according to First embodiment for carrying out the present invention is applied;

FIG. 12 is a flowchart showing the operation (of arranging gears in mesh) of the apparatus according to Ninth embodiment for carrying out the present invention for controlling the chucking machine to which the thrust converter according to First embodiment for carrying out the present invention is applied;

FIG. 13 is a view showing the mount state of a magnetic sensor, according to Ninth embodiment of the present invention, used in the chucking machine to which the thrust converter according to First embodiment for carrying out the present invention is applied;

FIG. 14 is a view showing the action of the magnetic sensor, according to Ninth embodiment for carrying out the present invention, used in the chucking machine to which the thrust converter according to First embodiment for carrying out the present invention is applied;

FIG. 15 is a flow chart showing the operation (of opening the chuck claw) of the apparatus according to Ninth embodiment for carrying out the present invention for controlling the chucking machine to which the thrust converter according to First embodiment for carrying out the present invention is applied;

FIG. 16 is a flow chart showing the operation (of closing the chuck claw) of the apparatus according to Tenth embodiment for carrying out the present invention for controlling the chucking machine to which the thrust converter according to Second embodiment for carrying out the present invention is applied;

FIG. 17 is a flowchart showing the operation (of arranging gears in mesh) of the apparatus according to Tenth embodiment for carrying out the present invention for controlling the chucking machine to which the thrust converter according to Second embodiment for carrying out the present invention is applied;

FIG. 18 is a view showing the configuration of an apparatus according to Eleventh embodiment for carrying out the present invention for controlling the chucking machine to which the thrust converter according to Fifth embodiment for carrying out the present invention is applied;

FIG. 19 is a flow chart showing the operation (of closing the chuck claw) of the apparatus according to Eleventh embodiment for carrying out the present invention for controlling the chucking machine to which the thrust converter according to Fifth embodiment for carrying out the present invention is applied;

FIG. 20 is a flow chart showing the operation (of opening the chuck claw) of the apparatus according to Eleventh embodiment for carrying out the present invention for controlling the chucking machine to which the thrust converter according to Fifth embodiment for carrying out the present invention is applied;

FIG. 21 is a view for explaining the operation of the thrust converter of the Fifth embodiment according to Eleventh embodiment for carrying out the present invention;

FIG. 22 is a view for explaining the origin-restoration operation of the thrust converter of the Fifth embodiment according to Eleventh embodiment for carrying out the present invention;

FIG. 23 is a flow chart for explaining the origin-restoration operation of the thrust converter of the Fifth embodiment according to Eleventh embodiment for carrying out the present invention; and

FIG. 24 is a view in vertical section of a chucking machine to which a thrust converter having already proposed (invented) by the inventors of the present invention is applied.

### BEST MODE FOR CARRYING OUT THE INVENTION

First Embodiment

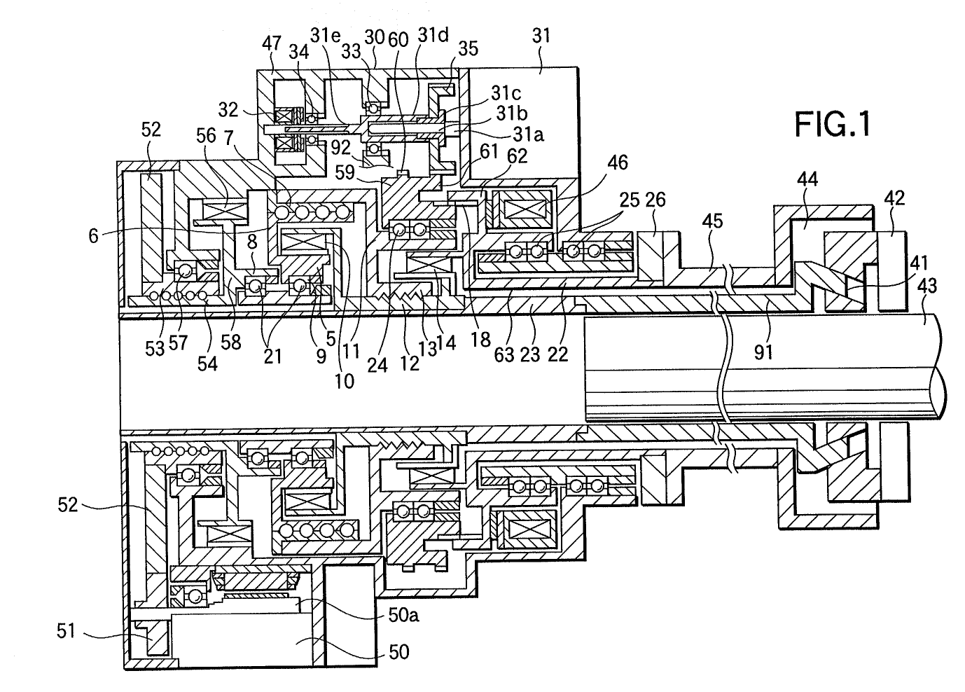

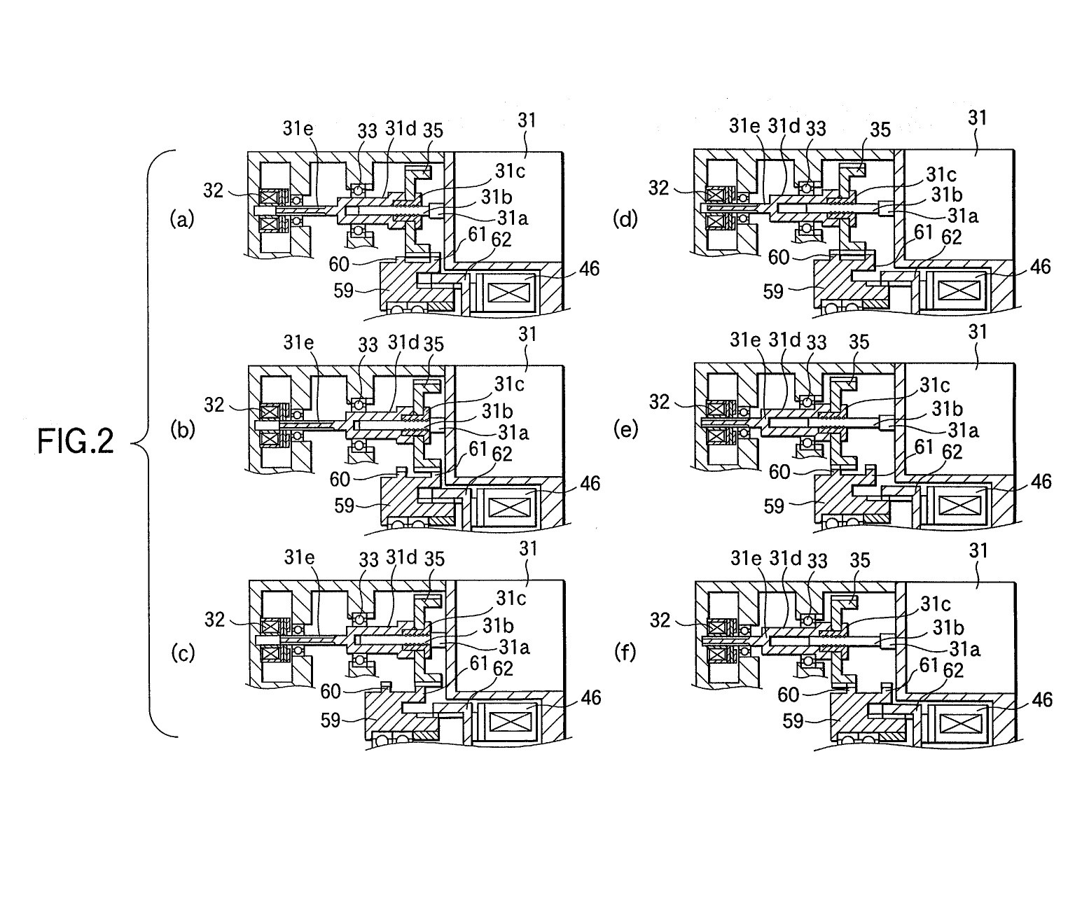

First embodiment for carrying out the present invention will be described below with reference to FIGS. 1 and 2.

FIG. 1 is a view in vertical section of a chucking machine to which a thrust converter according to First embodiment for carrying out the present invention is applied. FIG. 2 is a view for explaining the operation thereof. In each of the drawings, the right shows the load side and the left shows the side reverse to the load side.

In FIG. 1, the reference numeral 58 designates a reciprocating means. The reciprocating means 58 includes a first servomotor 50 having a motor rotary shaft 50a, a gear 51 fixed on the motor rotary shaft 50a, a gear 52 meshing with the gear 51, a third nut 53 for fixing the gear 52, a third screw shaft 54 thread-engaged with the third nut 53, a third linear guide 56 for whirl-stopping the third screw shaft 54 axially movably relative to a frame 47, and a bearing 57 for bearing the third nut 53 rotatable and axially immovable relative to the frame 47. Incidentally, the third nut 53, the third screw shaft 54, the third linear guide 56 and the bearing 57 form a motor rotation-to-reciprocation converting means.

The center of the rotary shaft of the first servomotor 50 is not coaxial with the axial center of the thrust converter. The load side of the third servomotor 50 is reverse to the load side of the thrust converter. Though not shown, a rotation detector which is means for detecting the rotational position of the motor rotary shaft 50a is disposed at the end opposite to the load-side end of the motor rotary shaft 50a.

The reference numeral 5 designates a reciprocating-rotation converting means, which includes a first screw shaft 6 having a bearing housing portion 9 and rotatably and axially immovably supported through the second bearing 21 relative to a bearing housing portion 8 provided in the third screw shaft 54, a first nut 7 thread-engaged with the first screw shaft 6, and a first linear guide 10 for axially movably whirl-stopping the first screw shaft 6 relative to the second screw shaft 12.

The reference numeral 11 designates a rotation-to-reciprocation converting means, which includes a second nut 13 fixed to the first nut 7 and having a screw portion located in the inside of the first nut 7 (center line side of the main shaft), a second screw shaft 12 thread-engaged with the second nut 13, and a second linear guide 14 for axially movably whirl-stopping the second screw shaft 12 relative to the main rotary shaft 22.

Incidentally, a hollow pull rod 23 is fixed into the second screw shaft 12.

The second screw shaft 12 is constituted by a screw so that the screw lead angle β1 of the second screw shaft 12 has the relation tanβ1<μ1 when μ1 is the friction coefficient of the screw.

The reference numeral 63 designates a reaction force receiving means. The reaction force receiving means 63 includes a main rotary shaft 22; a first bearing 25 for rotatably and axially immovably bearing the main rotary shaft 22; a connection means 18 composed of a connection nut 62 as a second screw provided in the outer circumferential portion of the main rotary shaft 22, and a connection screw shaft 59 as a first screw thread-engaged with the connection nut 62; and a third bearing 24 for bearing the connection screw shaft 59 rotatable and axially immovable relative to the first nut 7.

The connection means 18 is constituted by a screw having the relation tanβ2<μ2 when β2 is the screw lead angle of the connection screw shaft 59, and μ2 is the friction coefficient of the screw.

The reference numeral 30 designates a driving means, which includes a second servomotor 31 having a rotation detector and mounted to a frame 47 to make the loaded shaft side direction the same as the loaded shaft side direction of the first servomotor 50, a feed screw shaft 31b extended on the load side of the motor rotary shaft 31a of the second servomotor 31, a feed screw nut 31c thread-engaged with the feed screw shaft 31b, a moving shaft 31d having a non-through hole provided for fixing the feed screw nut 31c and receiving the feed screw shaft 31b, a moving shaft 31e provided to be extended on the side opposite to the motor side of the moving shaft 31d, a hollow electromagnetic brake 32 spline-connected to the moving shaft 31e to thereby prevent the moving shafts 31d and 31e from rotating and to thereby make the moving shaft 31e move through axially, a bearing 33 for rotatably and movably bearing the moving shaft 31d relative to the frame 47, a bearing 34 for rotatably and movably bearing the moving shaft 31e to the frame 47, a driving gear 35 fixed to the moving shaft 31d, driven gears 60 and 61 capable of meshing with the driving gear 35 and provided in parallel with each other with separation of a predetermined distance from the outer circumference of the connection screw shaft 59, and an electromagnetic brake 46 fixed to the frame 47 for preventing the rotation of the connection nut 62 and opening/closing the connection nut 62.

Incidentally, the moving shafts 31d and 31e and the feed screw nut 31c form a moving shaft.

A part of the connection nut 62 is formed as a brake plate of an electromagnetic brake 46.

The reference numeral 92 designates a moving means. The moving means 92 includes a driving means 30, and a connection means 18. The moving means 92 operates also as a part of the reaction force receiving means 63.

The screw direction of each screw in the reciprocating means 58, the reciprocation-to-rotation converting means 5 and the rotation-to-reciprocation converting means 11 are formed, considering that the second screw shaft 12 moves finally axially toward the side reverse to the load side when the third screw shaft 54 moves axially toward the side reverse to the load side. As is obvious from the drawing, the reciprocating means 58, the reciprocation-to-rotation converting means 5, the rotation-to-reciprocation converting means 11, etc. are disposed on one and the same axial line. Although various considerations are made upon the screw lead angle, screw lead, etc. of each screw, the details of these items will become clear from the following description of the operation.

A bracket 26 is provided on the load side of the main rotary shaft 22. A rear end of the main shaft 45 is fixed to the bracket 26. A chuck 44 is fixed to a front end of the main shaft 45. A drawbar 91 is axially movably inserted in an axial center hollow portion of the main shaft 45. A front end of the drawbar 91 is connected to a chuck claw 42 through an operation converting mechanism 41. A rear end of the draw bar 91 is fixed to a front end of the pull rod 23.

The main shaft 45 is driven by a main shaft motor not shown and finally rotatably supported by bearings 21 and 25 so as to rotate integrally with the chuck 44, the main rotary shaft 22, the draw bar 91, the pull rod 23, the connection nut 62, the connection screw shaft 59, the second screw shaft 12, the second nut 13, the first nut 7, the first screw shaft 6, etc.

The operation converting mechanism 41 is configured so that the front end of the draw bar 91 presses a predetermined portion of a taper-like groove, for example, formed in the chuck claw 42 to thereby operate the chuck claw 42 in a direction of releasing the hold of the work 43 when the draw bar 91 is moved right in the drawing while the front end of the draw bar 91 is inserted in the groove, and so that the front end of the draw bar 91 presses the predetermined portion of the groove to thereby operate the chuck claw 42 in a direction of holding the work 43 when the draw bar 91 is moved left in the drawing. Incidentally, the operation converting mechanism 41 is commonly known.

The first servomotor 50 and the driving means 30 are fixed to the frame 47. The main rotary shaft 22 is supported rotatably and axially immovably relative to the frame 47 through the first bearing 25.

The operation of the First embodiment will be described below also with reference to FIG. 2. The holding operation of the driving means 30 by which the work 43 is held by the chuck claw 42 will be described first.

That is, in a state of (a) of FIG. 2 in which the driving gear 35 meshes neither with the driven gear 60 nor with the driven gear 61, the second servomotor 31 is operated to rotate the motor rotary shaft 31a with predetermined torque in the condition that the main shaft motor and the first servomotor 50 stop.

On this occasion, the electromagnetic brake 32 is in a state of locking the rotation of the moving shafts 31d and 31e. The feed screw shaft 31b rotates as the motor rotary shaft 31a rotates. Hence, the feed screw nut 31c thread-engaged with the feed screw shaft 31b, the moving shafts 31d and 31e and the driving gear 35 move toward the motor 31 because rotational motion of the feed screw nut 31c, the moving shafts 31d and 31e and the driving gear 35 is stopped by the electromagnetic brake 32. Because a gear sensor (not shown) makes the phase of the driving gear 35 coincident with the phase of the driven gear 61, the driving gear 35 and the driven gear 61 moves until the feed screw nut 31c comes into contact with a step portion of the motor rotary shaft 31a while the teeth of the driving gear 35 mesh with the teeth of the driven gear 61. As a result, a state of (b) of FIG. 2 is obtained.

In the state of (b) of FIG. 2, when the electromagnetic brake 32 is released while the electromagnetic brake 46 is excited to thereby lock the connection nut 62, the feed screw nut 31c can make rotational motion. In the state at this time, the feed screw nut 31c coming into contact with the step portion of the motor rotary shaft 31a cannot move axially. Hence, when the motor rotary shaft 31a rotates continuously, the feed screw nut 31c begins to rotate in the position. Along with this rotation, the gear 35 fixed to the feed screw nut 31c rotates to thereby rotate the connection screw shaft 59 in which the driven gear 61 capable of meshing with the gear 35 is provided. Because the connection nut 62 is whirl-stopped by the electromagnetic brake 46, the connection nut 62 is not dragged by the rotation of the connection screw shaft 59 but the connection screw shaft 59 moves rotationally in a direction reverse to the motor 31 up to a state of (c) of FIG. 2.

At this time, the rotation-to-reciprocation converting means 11 is connected to the connection screw shaft 59 through the bearing 24. Further, the reciprocation-to-rotation converting means 5 is connected to the rotation-to-reciprocation converting means 11 through the first nut 7 and the first screw shaft 6. Furthermore, the reciprocating means 58 is connected to the reciprocation-to-rotation converting means 5 through the bearing 21. Configuration is made so that the first servomotor 50, etc. of the reciprocating means 58 cannot move axially, and so that the third screw shaft 54 cannot move axially so long as the third nut 53 is not rotated. Hence, the first servomotor 50 is operated in synchronism with the second servomotor 31 of the driving means 30 (operated synchronously in a direction in which the third screw shaft 54 can move left in the drawing) to thereby rotate the third nut 53.

As a result, the movement of the connection screw shaft 59 can be absorbed between the third nut 53 and the third screw shaft 53, so that the rotation-to-reciprocation converting means 11, the reciprocation-to-rotation converting means 5 and the third screw shaft 54 of the reciprocating means 58 integrally move left in the drawing by the same distance as the moving distance of the connection screw shaft 59.

Incidentally, on this occasion, as described above, the connection screw shaft 59 is rotatably supported by the bearing 24 and the first servomotor 50 is operated in synchronism with the second servomotor 31 of the driving means 30 to thereby rotate the third nut 53 so that the movement of the connection screw shaft 59 is absorbed between the third nut 53 and the third screw shaft 54. Hence, the first nut 7 does not rotate but moves axially toward the side reverse to the load side (left in the drawing).

When the first servomotor 50 is driven, the motor rotary shaft 50a is rotated with predetermined torque. The torque is transferred to the gear 52 through the gear 51 fixed on the motor rotary shaft 50a to thereby rotate the third nut 53 to which the gear 52 is fixed. Because the third screw shaft 54 thread-engaged with the third nut 53 is whirl-stopped relative to the frame 47 by the linear guide 56, the third screw shaft 54 is not dragged with the third nut 53 but makes reciprocating motion.

Along with the movement of the rotation-to-reciprocation converting means 11, the pull rod 23 and the draw bar 91 move axially toward the side reverse to the load side. Hence, the axial operation of the pull rod 23 and the drawbar 91 is converted into the radial operation of the chuck claw 42 by the operation converting mechanism 41, so that the chuck 44 holds the work 43.

When the second servomotor 31 is stopped running and the first servomotor 50 is continuously rotated with the predetermined torque after the chuck 44 holds the work 43, the third nut 53 connected to the motor rotary shaft 50a through the gears 51 and 52 rotates. Because the third screw shaft 54 thread-engaged with the third nut 53 is whirl-stopped relative to the frame 47 by the linear guide 56, the third screw shaft 54 moves axially toward the side reverse to the load side. With the movement of the third screw shaft 54, the reciprocation-to-rotation converting means 5 including the first screw shaft 6 also moves. When the reciprocation-to-rotation converting means 5 moves axially toward the side reverse to the load side, the first screw shaft 6 is pulled.

Here is the relation:

F1=(2π·TM·η)/L1 (Expression 1)

in which TM is the rotational torque for rotational motion of the third nut 53, F1 is the thrust force for pulling the third screw shaft 54 axially, L1 is the screw lead of the third screw shaft 54, and η is the rotation-to-reciprocation converting efficiency.

When the first screw shaft 6 is pulled, the first nut 7 thread-engaged with the first screw shaft 6 rotates. Hence, the thrust force for axial movement of the first screw shaft 6 is converted into rotational torque for rotational motion of the first nut 7.

Here is the relation:

T2=(L2·F1·η2)/2π (Expression 2)

in which F1 is the thrust force for pulling the first screw shaft 6 as obtained in the above description, T2 is the rotational torque of the first nut 7, L2 is the lead of the first screw shaft 6, and η2 is the reciprocating-to-rotation converting efficiency.

When the first nut 7 rotates, the second nut 13 fixed in the inside of the first nut 7 (on the center line side of the main shaft) also rotates. Hence, the second screw shaft 12 thread-engaged with the second nut 13 moves axially in a direction reverse to the load side. Hence, the rotational motion torque of the second nut 13 is converted into thrust force for axial movement of the second screw shaft 12.

Here is the relation:

F3=(2π·T2·η3)/L3 (Expression 3)

in which T2 is the rotational torque for rotational motion of the first nut 7 and the second nut 13 as obtained in the above description, F3 is the thrust force for axial movement of the second screw shaft 12, L3 is the screw lead of the second screw shaft 12, and η3 is the rotation-to-reciprocation converting efficiency.

From the expressions 2 and 3, the axial movement thrust force F1 given from the first servomotor 50 to the first screw shaft 6 and the axial thrust force F3 generated in the second screw shaft 12 have the relation:

F3/F1=(L2/L3)·ηc (Expression 4)

in which ηc is the motion conversion efficiency of the screw.

That is, when screw leads of L2>L3 are formed, the thrust force F3 generated in the second screw shaft 12 is converted into amplified thrust force which is (L2/L3)·ηc times as large as the thrust force F1, that is, the thrust force F3 is generated as the amplified thrust force. Even in the case where the thrust force of the first servomotor 50 is small, a large amount of thrust force for axial movement can be obtained in the pull rod 23.

When the pull rod 23 and the draw bar 91 are moved axially toward the side reverse to the load side by the amplified thrust force F3, the operation converting mechanism 41 converts the axial operation of the pull rod 23 and the draw bar 91 into the radial operation of the chuck claw 42. Hence, the chuck 44 holds the work 43 by the amplified holding force.

Incidentally, as obvious also from the expression 4, larger thrust force F3 can be obtained by smaller rotational torque TM if the lead L2 of the first screw shaft 6 is made large. When, for example, the motion conversion efficiency of the screw is set to 100%, F1 is amplified to 100 times in the case of L2=100 mm and L3=1 mm. Assuming that the stroke of the draw bar 91 required for opening/closing the chuck claw 42 is 15 mm, then 15 revolutions of the second nut 13 are required for moving the second screw shaft 12 by 15 mm.

Accordingly, in order to make 15 revolutions of the second nut 13, 15 revolutions of the first nut 7 are required. Because the lead L2 of the first screw shaft 6 is 100 mm, the first nut 7 needs to have a length sufficient to move by 1500 mm.

Accordingly, as described above, the driving means 30 is operated in synchronism with the first servomotor 20 so that the rotation-to-reciprocation converting means 11, the reciprocation-to-rotation converting means 5, etc. can be moved axially without rotating the first nut 7. Hence, it becomes unnecessary for the first nut 7 to make 15 revolutions.

The torque TM of the first servomotor is converted into a large amount of thrust force F so that the work 43 can be held by required holding force. The stroke maybe slight because the chuck claw 42 has already held the work 43. When, for example, the stroke needs to be 0.1 mm, 1/10 revolution of the second nut 13 may be required and the first nut 7 may have the stroke corresponding to 10 mm.

Hence, the axial length of the thrust converter can be shortened greatly.

Then, the motor rotary shaft 31a is rotated in a direction reverse to that carried out in the holding operation in the condition that, after the work 43 is held by the chuck claw 42, the first servomotor 50 is stopped and the second servomotor 31 is operated again so that the moving shaft 31e and the connection nut 62 are locked by the electromagnetic brakes 32 and 46 respectively. As the motor rotary shaft 31a rotates, the feed screw shaft 31b rotates and the feed screw nut 31c thread-engaged with the feed screw shaft 31b moves axially toward the side reverse to the load side. The driving gear 35 fixed on the feed screw shaft 31c moves together from a state of (c) of FIG. 2 to a state of (d) of FIG. 2, that is, to a state in which the first driving gear 35 meshes neither with the gear 60 nor with the gear 61. When the state of (d) of FIG. 2 is obtained, the second servomotor 31 is stopped.

Incidentally, the reason why the state of (d) of FIG. 2 in which the first driving gear 35 meshes neither with the gear 60 nor with the gear 61 is obtained is to prevent the gear 35 or the like not contributing to working at the time of performing working, from rotating to thereby attain high efficiency, and to prevent noise from being generated due to the driving gear 35 and the gear 61 in mesh.

When the main shaft 45 supported by the bearings 21 and 25 is then finally rotated by a main shaft motor (not shown), the work 43 is cut while the draw bar 91, the chuck 44, the rotation-to-reciprocation converting means 11 and the reciprocation-to-rotation converting means 5 are dragged as described above.

Incidentally, on this occasion, the first and second servomotors 50 and 31 are stopping and the electromagnetic brakes 32 and 46 are in a state of being not excited.

Further, on this occasion, the second screw shaft 12 thread-engaged with the second nut 13 is constituted by a screw having the relation tanβ1<μ1 in which β1 is the screw lead angle of the second screw shaft 12 thread-engaged with the second nut 13, and μ1 is the friction coefficient of the screw. In the screw satisfying this conditional expression, conversion efficiency is negative (−) when thrust force is converted into rotational torque. Hence, it is possible to convert rotational torque into axial thrust force when the rotational torque is given to the screw. It is however impossible to convert axial thrust force into rotational torque when the axial thrust force is given to the screw.

That is, when the second nut 13 is rotated with predetermined torque, the rotational torque can be converted into thrust force for axial movement of the second screw shaft 12 thread-engaged with the second nut 13 whirl-stopped. However, even in the case where thrust force for axial movement is given to the second screw shaft 12, the second nut 13 cannot rotate.

Also in the connection means 18, the connection screw shaft 59 is constituted by a screw having the relation tanβ2<μ2 in which β2 is the screw lead angle of the connection screw shaft 59, and μ2 is the friction coefficient of the screw. Hence, even in the case where axial thrust force is given from the main shaft 45, the connection screw shaft 59 cannot rotate.

This means that the draw bar 91 giving force to the chuck claw 42 in the work-holding direction never moves axially toward the load side, this is, the work-holding force of the chuck claw 42 is never reduced even in the case where the first servomotor 50 is switched off at the time when a work is being worked.

Then, to release the work 43 from the chuck claw 42, the first servomotor 50 is operated to rotate the motor rotary shaft 50a in a direction reverse to that carried out in the above-mentioned holding operation to thereby loosen the chuck claw 42. Then, the second servomotor 31 is operated to move the feed screw shaft 31c toward the side reverse to the motor 31 side of the second servomotor while making the electromagnetic brake 32 lock the moving shaft 31e. Because the phase of the driving gear 35 and the phase of the driven gear 60 are made coincident with each other by a gear sensor (not shown), the moving shaft 31d moves until the step portion of the moving shaft 31d comes into contact with the bearing 33 while the teeth of the driving gear 35 mesh with the teeth of the driven gear 60. Thus, the state of (d) of FIG. 2 changes to the state of (e) of FIG. 2.

Then, in the state of (e) of FIG. 2, the electromagnetic brake 32 is released and the connection nut 62 is locked by the electromagnetic brake 46. The feed screw shaft 31c integrated with the moving shaft 31d rotates in this position because the step portion of the moving shaft 31d is in contact with the bearing 33 so that the feed screw shaft 31c is axially immovable but rotatable in the rotation direction. Along with this rotation, the driving gear 35 also rotates to thereby rotate the connection screw shaft 59 having the gear 60 driven by the driving gear 35. Because the connection nut 62 is whirl-stopped by the electromagnetic brake 46, the connection nut 62 is not dragged by the rotation of the connection screw shaft 59 but the connection screw shaft 59 rotationally moves right to be in a state of (f) of FIG. 2.

Further, on this occasion, the rotation-to-reciprocation converting means 11 is connected to the connection screw shaft 59 through the bearing 24. The reciprocation-to-rotation converting means 5 is connected to the rotation-to-reciprocation converting means 11 through the first nut 7 and the first screw shaft 6. The reciprocating means 58 is connected to the reciprocation-to-rotation converting means 5 through the bearing 21. Configuration is made so that the first servomotor 50 of the reciprocating means 58, or the like, cannot move axially, and so that the third screw shaft 54 cannot move axially so long as the third nut 53 is not rotated. Therefore, the first servomotor 50 is operated in synchronism with the second servomotor 31 of the driving means 30 (operated synchronously in a direction in which the third screw shaft 54 can move right in the drawing) to thereby rotate the third nut 53. As a result, the movement of the connection screw shaft 59 can be absorbed between the third nut 53 and the third screw shaft 54, so that the rotation-to-reciprocation converting means 11, the reciprocation-to-rotation converting means 5 and the third screw shaft 54 of the reciprocating means 58 integrally move right in the drawing by the same distance as the moving distance of the connection screw shaft 59.

Incidentally, as described above, on this occasion, the connection screw shaft 17 is rotatably supported by the bearing 24 and the first servomotor 50 is operated in synchronism with the second servomotor 31 of the driving means 30 to rotate the third nut 53, so that the movement of the connection screw shaft 59 is absorbed between the third nut 53 and the third screw shaft 54. Hence, the first nut 7 moves axially toward the load side (right in the drawing) without rotation.

Along with the movement of the rotation-to-reciprocation converting means 11, the pull rod 23 and the draw bar 91 move axially toward the load side. The axial operation of the pull rod 23 and the drawbar 91 is converted into the radial operation of the chuck claw 42 by the operation converting mechanism 41, so that the work 43 is released from the chuck 44.

Then, after a new work 43 is set, the second servomotor 31 is rotated to return the state to the state of (a) of FIG. 2. Then, operation shown in (b) to (f) of FIG. 2 is repeated.

Second Embodiment

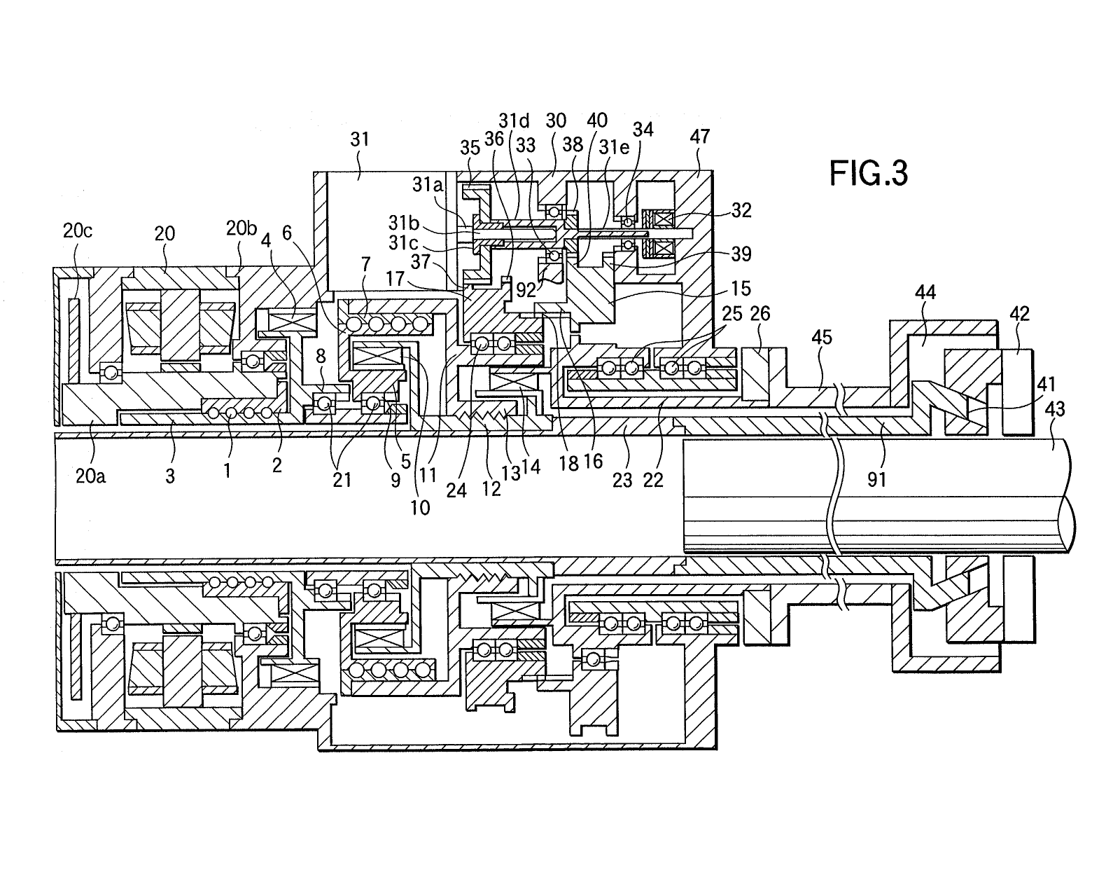

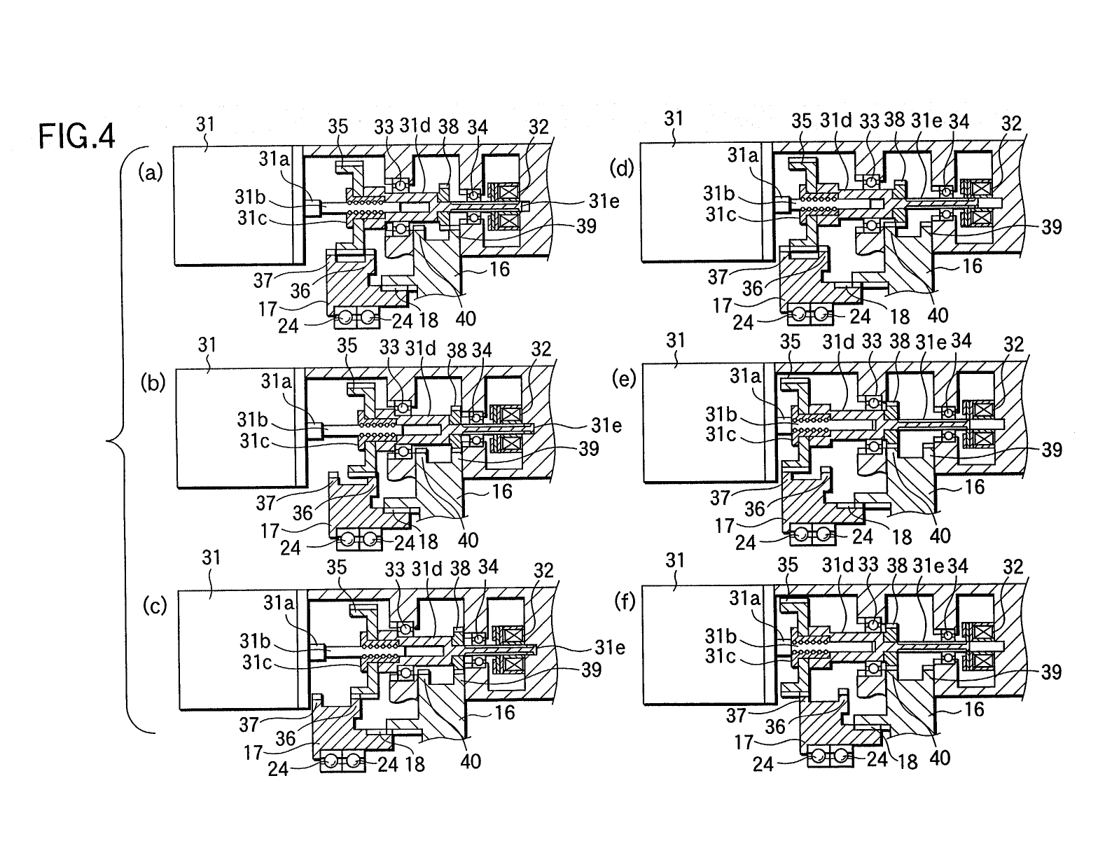

Second embodiment for carrying out the present invention will be described below with reference to FIGS. 3 and 4.

FIG. 3 is a view in vertical section of a chucking machine to which a thrust converter according to Second embodiment for carrying out the present invention is applied. FIG. 4 is a view for explaining the operation thereof. In each of the drawings, the right shows the load side and the left shows the side reverse to the load side.

In the drawings, the reference numeral 1 designates a reciprocating means. The reciprocating means 1 includes: a first servomotor 20 having a motor rotary shaft 20a; a third nut 2 fixed to the load side of the motor rotary shaft 20a; a third screw shaft 3 thread-engaged with the third nut 2; a load-side bracket 20b; and a third linear guide 4 for whirl-stopping the third screw shaft 3 axially movable relative to the load-side bracket 20b. Incidentally, the third nut 2, the third screw shaft 3, the load-side bracket 20b and the third linear guide 4 form a motor rotation-to-reciprocation converting means.

A rotation detector 20c which is means for detecting the rotational position of the motor rotary shaft 20a is disposed at the end reverse to the load-side end of the motor rotary shaft 20a.

The reference numeral 5 designates a reciprocating-rotation converting means, which includes a first screw shaft 6 having a bearing housing portion 9 and rotatably and axially immovably supported through the second bearing 21 relative to a bearing housing portion 8 provided in an end reverse to the motor-side end of the third screw shaft 3, a first nut 7 thread-engaged with the first screw shaft 6, and a first linear guide 10 for whirl-stopping the first screw shaft 6 only axially movable relative to the second screw shaft 12.

The reference numeral 11 designates a rotation-to-reciprocation converting means, which includes a second nut 13 fixed to the first nut 7 and having a screw portion located in the inside of the first nut 7 (center line side of the main shaft), a second screw shaft 12 thread-engaged with the second nut 13, and a second linear guide 14 for whirl-stopping the second screw shaft 12 only axially movable relative to the main rotary shaft 22.

Incidentally, a hollow pull rod 23 is fixed into the second screw shaft 12.

The second screw shaft 12 is constituted by a screw so that the screw lead angle β1 of the second screw shaft 12 has the relation tanβ1<μ1 when μ1 is the friction coefficient of the screw.

The reference numeral 15 designates a reaction force receiving means. The reaction force receiving means 15 includes a main rotary shaft 22; a first bearing 25 for rotatably and axially immovably bearing the main rotary shaft 22; a connection means 18 composed of a connection nut 16 as a second screw provided in the outer circumferential portion of the main rotary shaft 22, and a connection screw shaft 17 as a first screw thread-engaged with the connection nut 16; and a third bearing 24 for bearing the connection screw shaft 17 rotatable and axially immovable relative to the first nut 7.

The connection means 18 is constituted by a screw having the relation tanβ2<μ2 when β2 is the screw lead angle of the connection screw shaft 17, and μ2 is the friction coefficient of the screw.

The reference numeral 30 designates a driving means. The driving means 30 includes: a second servomotor 31 having a motor rotary shaft 31a, and a feed screw shaft 31b extended on the load side of the motor rotary shaft 31a; a feed screw nut 31c thread-engaged with the feed screw shaft 31b; a moving shaft 31d having a non-through hole provided for fixing the feed screw nut 31c and receiving the feed screw shaft 31b; a moving shaft 31e provided to be extended on the load side of the moving shaft 31d; a hollow electromagnetic brake 32 through which the moving shaft 31e can pass axially while the moving shafts 31d and 31e are prevented from rotating at the time of excitation; a bearing 33 for bearing the moving shaft 31d rotatable and movable relative to the frame 47; a bearing 34 for bearing the moving shaft 31e rotatable and movable relative to the frame 47; a first driving gear 35 fixed on the moving shaft 31d; first driven gears 36 and 37 capable of meshing with the first driving gear 35 and provided in parallel with each other with separation of a predetermined distance from the outer circumference of the connection screw shaft 17; a second driving gear 38 fixed on the moving shaft 31e; and second driven gears 39 and 40 capable of meshing with the second driving gear 38 and provided in parallel with each other with separation of a predetermined distance from the outer circumference of the connection nut 16.

Incidentally, the moving shafts 31d and 31e and the feed screw nut 31c form a moving shaft.

The first driving gear 35 is formed to have a different number of teeth from the number of teeth in the second driving gear 38. The respective numbers of teeth in the first driven gears 36 and 37 and the second driven gears 39 and 40 are set so that the rotational velocity Na of the connection screw shaft 17 rotated by the first driving gear 35 and the rotational velocity Nb of the connection nut 16 rotated by the second driving gear 38 have the relation Na>Nb.

The reference numeral 92 designates a moving means. The moving means 92 includes: a driving means 30; and a connection means 18. The moving means 92 acts also as apart of the reaction force receiving means 15.

The screw direction of each screw in the reciprocating means 1, the reciprocation-to-rotation converting means 5 and the rotation-to-reciprocation converting means 11 are formed, considering that the second screw shaft 12 moves finally axially toward the side reverse to the load side when the third screw shaft 3 moves axially toward the side reverse to the load side. As is obvious from the drawing, the reciprocating means 1, the reciprocation-to-rotation converting means 5, the rotation-to-reciprocation converting means 11, etc. are disposed on one and the same axial line. Although various considerations are made upon the screw lead angle, screw lead, etc. of each screw, the details of these items will become clear from the following description of the operation.

A bracket 26 is provided on the load side of the main rotary shaft 22. A rear end of the main shaft 45 is fixed to the bracket 26. A chuck 44 is fixed to a front end of the main shaft 45. A draw bar 91 is axially movably inserted in an axial center hollow portion of the main shaft 45. A front end of the drawbar 91 is connected to a chuck claw 42 through an operation converting mechanism 41. A rear end of the draw bar 91 is fixed to a front end of the pull rod 23.

The main shaft 45 is driven by a main shaft motor not shown and finally rotatably supported by bearings 21 and 25 so as to rotate integrally with the chuck 44, the main rotary shaft 22, the draw bar 91, the pull rod 23, the connection nut 16, the connection screw shaft 17, the second screw shaft 12, the second nut 13, the first nut 7, the first screw shaft 6, etc.

The operation converting mechanism 41 is configured so that the front end of the draw bar 91 presses a predetermined portion of a taper-like groove, for example, formed in the chuck claw 42 to thereby operate the chuck claw 42 in a direction of releasing the hold of the work 43 when the draw bar 91 is moved right in the drawing while the front end of the draw bar 91 is inserted in the groove, and so that the front end of the draw bar 91 presses the predetermined portion of the groove to thereby operate the chuck claw 42 in a direction of holding the work 43 when the draw bar 91 is moved left in the drawing. Incidentally, the operation converting mechanism 41 is commonly known.

The first servomotor 20 and the driving means 30 are fixed to the frame 47. The main rotary shaft 22 is supported rotatably and axially immovably relative to the frame 47 through the first bearing 25.

The operation of the Second embodiment will be described below also with reference to FIG. 4. The holding operation of the driving means 30 by which the work 43 is held by the chuck claw 42 will be described first.

In a state of (a) of FIG. 4 in which the gear 35 meshes neither with the gear 36 nor with the gear 37 and the gear 38 meshes neither with the gear 39 nor with the gear 40, the second servomotor 31 is operated to rotate the motor rotary shaft 31a with predetermined torque in the condition that the main shaft motor and the first servomotor 20 stop.

On this occasion, the electromagnetic brake 32 locks the moving shaft 31e. Hence, the feed screw shaft 31b rotates as the motor rotary shaft 31a rotates. Hence, the feed screw nut 31c thread-engaged with the feed screw shaft 31b, the moving shafts 31d and 31e, and the first and second driving gears 35 and 38 move axially toward the load side without being dragged.

A gear sensor (not shown) makes the phase of the first gear 35 coincident with the phase of the first driven gear 36 and makes the phase of the second driving gear 38 coincident with the phase of the second driven gear 39, so that the step portion of the moving shaft 31d moves to come into contact with the bearing 33 while the teeth of the first and second driving gears 35 and 38 mesh with the teeth of the first and second driven gears 36 and 39 respectively. As a result, a state of (b) of FIG. 4 is obtained.

Next, in the state of (b) of FIG. 4, when the electromagnetic brake 32 is released, the step portion of the moving shaft 31d abuts on the inner race of the bearing 33 and cannot move axially toward the load side any more so that the feed screw nut 31c is axially immovable but rotatable in the rotation direction. Accordingly, the feed screw nut 31c rotates in this position. Along with this rotation, the first and second driving gears 35 and 38 rotate to thereby rotate the connection screw shaft 17 and the connection nut 16 in which the first and second driven gears 36 and 39 driven by the first and second driving gears 35 and 38 respectively are provided.

Incidentally, on this occasion, as described above, the first driving gear 35 is formed to have a different number of teeth from the number of teeth of the second driving gear 38. Further, the respective numbers of teeth in the first driven gears 36 and 37 and the second driven gears 39 and 40 are set so that the rotational velocity Na of the connection screw shaft 17 rotated by the first driving gear 35 and the rotational velocity Nb of the connection nut 16 rotated by the second driving gear 38 have the relation Na>Nb. Hence, the rotational velocity of the connection screw shaft 17 is different from that of the connection nut 16, so that the connection screw shaft 17 rotationally moves toward the side reverse to the load side up to a state of (c) of FIG. 4 by differential motion.

At this time, the rotation-to-reciprocation converting means 11 is connected to the connection screw shaft 17 through the bearing 24. Further, the reciprocation-to-rotation converting means 5 is connected to the rotation-to-reciprocation converting means 11 through the first nut 7 and the first screw shaft 6. Furthermore, the reciprocating converting means 1 is connected to the reciprocation-to-rotation converting means 5 through the bearing 21. Configuration is made so that the first servomotor 20, etc. of the rotation-to-reciprocation converting means 1 cannot move axially, and so that the third screw shaft 3 cannot move axially so long as the third nut 2 is not rotated. Hence, the first servomotor 20 is operated in synchronism with the second servomotor 31 of the driving means 30 (operated synchronously in a direction in which the third screw shaft 3 can move left in the drawing) to thereby rotate the third nut 2.

As a result, the movement of the connection screw shaft 17 can be absorbed between the third nut 2 and the third screw shaft 3, so that the rotation-to-reciprocation converting means 11, the reciprocation-to-rotation converting means 5 and the third screw shaft 3 of the reciprocating converting means 1 integrally move axially toward the side reverse to the load by the same distance as the moving distance of the connection screw shaft 17.

Incidentally, on this occasion, as described above, the connection screw shaft 17 is rotatably supported by the bearing 24 and the first servomotor 20 is operated in synchronism with the second servomotor 31 of the driving means 30 to thereby rotate the third nut 2 so that the movement of the connection screw shaft 17 is absorbed between the third nut 2 and the third screw shaft 3. Hence, the first nut 7 does not rotate but moves axially toward the side reverse to the load side.

Along with the movement of the rotation-to-reciprocation converting means 11, the pull rod 23 and the draw bar 91 move axially toward the side reverse to the load side. Hence, the axial operation of the pull rod 23 and the draw bar 91 is converted into the radial operation of the chuck claw 42 by the operation converting mechanism 41, so that the chuck 44 holds the work 43.

When the second servomotor 31 is stopped running and the first servomotor 20 is continuously rotated with the predetermined torque after the chuck 44 holds the work 43, the third nut 2 fixed on the motor rotary shaft 20a rotates. Because the third screw shaft 3 thread-engaged with the third nut 2 is whirl-stopped relative to the load-side bracket 20b by the linear guide 4, the third screw shaft 3 moves axially toward the side reverse to the load side. With the movement of the third screw shaft 3, the reciprocation-to-rotation converting means 5 including the first screw shaft 6 also moves. When the reciprocation-to-rotation converting means 5 moves axially toward the side reverse to the load side, the first screw shaft 6 is pulled.

Here is the relation:

F1=(2π·TM·η)/L1 (Expression 1)

in which TM is the rotational torque for rotational motion of motor rotary shaft 20a and the third nut 2, F1 is the thrust force for pulling the third screw shaft 3 axially, L1 is the screw lead of the third screw shaft 3, and η is the rotation-to-reciprocation converting efficiency.

When the first screw shaft 6 is pulled, the first nut 7 thread-engaged with the first screw shaft 6 rotates. Hence, the thrust force for axial movement of the first screw shaft 6 is converted into rotational torque for rotational motion of the first nut 7.

Here is the relation:

T2=(L2·F1·η2)/2π (Expression 2)

in which F1 is the thrust force for pulling the first screw shaft 6 as obtained in the above description, T2 is the rotational torque of the first nut 7, L2 is the lead of the first screw shaft 6, and η2 is the reciprocation-to-rotation converting efficiency.

When the first nut 7 rotates, the second nut 13 fixed in the inside of the first nut 7 (on the center line side of the main shaft) also rotates. Hence, the second screw shaft 12 thread-engaged with the second nut 13 moves axially toward the side reverse to the load side. Hence, the rotational motion torque of the second nut 13 is converted into thrust force for axial movement of the second screw shaft 12.

Here is the relation:

F3=(2π·T2·η3)/L3 (Expression 3)

in which T2 is the rotational torque for rotational motion of the first nut 7 and the second nut 13 as obtained in the above description, F3 is the thrust force for axial movement of the second screw shaft 12, L3 is the screw lead of the second screw shaft 12, and η3 is the rotation-to-reciprocation converting efficiency.

From the expressions 2 and 3, the axial movement thrust force F1 given from the first servomotor 20 to the first screw shaft 6 and the axial thrust force F3 generated in the second screw shaft 12 have the relation:

F3/F1=(L2/L3)·ηc (Expression 4)

in which ηc is the motion conversion efficiency of the screw.

That is, when screw leads of L2>L3 are formed, the thrust force F3 generated in the second screw shaft 12 is converted into amplified thrust force which is (L2/L3)·ηc times as large as the thrust force F1, that is, the thrust force F3 is generated as the amplified thrust force. Even in the case where the thrust force of the first servomotor 20 is small, a large amount of thrust force for axial movement can be obtained in the pull rod 23.

When the pull rod 23 and the draw bar 91 are moved axially toward the side reverse to the load side by the amplified thrust force F3, the operation converting mechanism 41 converts the axial operation of the pull rod 23 and the draw bar 91 into the radial operation of the chuck claw 42. Hence, the chuck 44 holds the work 43 by the amplified holding force.

Incidentally, as obvious also from the expression 4, a larger amount of thrust force F3 can be obtained by smaller rotational torque TM if the lead L2 of the first screw shaft 6 is made large. When, for example, the motion conversion efficiency of the screw is set to 100%, F1 is amplified to 100 times in the case of L2=100 mm and L3=1 mm. Assuming that the stroke of the draw bar 91 required for opening/closing the chuck claw 42 is 15 mm, then 15 revolutions of the second nut 13 are required for moving the second screw shaft 12 by 15 mm.

Accordingly, in order to make 15 revolutions of the second nut 13, 15 revolutions of the first nut 7 are required. Because the lead L2 of the first screw shaft 6 is 100 mm, the first nut 7 needs to have a length sufficient to move by 1500 mm.

Accordingly, as described above, the driving means 30 is operated in synchronism with the first servomotor 20 so that the rotation-to-reciprocation converting means 11, the reciprocation-to-rotation converting means 5, etc. can be moved axially without rotating the first nut 7. Hence, it becomes unnecessary for the first nut 7 to make 15 revolutions.

The torque TM of the first servomotor is converted into a large amount of thrust force F so that the work 43 can be held by required holding force. The stroke may be slight because the chuck claw 42 has already held the work 43. When, for example, the stroke needs to be 0.1 mm, 1/10 revolution of the second nut 13 may be required and the first nut 7 may have the stroke corresponding to 10 mm.

Hence, the axial length of the thrust converter can be shortened greatly.

The motor rotary shaft 31a is rotated in a direction reverse to that carried out in the holding operation in the condition that, after the work 43 is held by the chuck claw 42, the first servomotor 20 is stopped and the second servomotor 31 is operated again so that the moving shaft 31e is locked by the electromagnetic brake 32. As the motor rotary shaft 31a rotates, the feed screw shaft 31b rotates and the feed screw nut 31c thread-engaged with the feed screw shaft 31b moves axially toward the side reverse to the load side.

Along with the movement, teeth portions of the first and second driving gears 35 and 38 fixed to the feed screw nut 31c and the moving shaft 31e respectively move from a state of (c) of FIG. 4 to a state of (d) of FIG. 4, that is, to a state in which the first driving gear 35 does not mesh with any one of the first driven gears 36 and 37 and the second driving gear 38 does not mesh with any one of the second driven gears 39 and 40. When the state of (d) of FIG. 4 is obtained, the second servomotor 31 is stopped.

Next, when the main shaft 45 supported by the bearings 21 and 25 is then finally rotated by a main shaft motor (not shown) in the condition that the first and second servomotors 20 and 31 are stopped, the work 43 is cut while the draw bar 91, the chuck 44, the rotation-to-reciprocation converting means 11, the reciprocation-to-rotation converting means 5, etc. are dragged as described above.

Further, as described above, the second screw shaft 12 thread-engaged with the second nut 13 is constituted by a screw having the relation tanβ1<μ1 in which β1 is the screw lead angle of the second screw shaft 12 thread-engaged with the second nut 13, and μ1 is the friction coefficient of the screw. In the screw satisfying this conditional expression, conversion efficiency is negative (−) when thrust force is converted into rotational torque. Hence, it is possible to convert rotational torque into axial thrust force when the rotational torque is given to the screw. It is however impossible to convert axial thrust force into rotational torque when the axial thrust force is given to the screw.

That is, when the second nut 13 is rotated with predetermined torque, the rotational torque can be converted into thrust force for axial movement of the second screw shaft 12 thread-engaged with the second nut 13 whirl-stopped. However, even in the case where thrust force for axial movement is given to the second screw shaft 12, the second nut 13 cannot rotate.

Also in the connection means 18, the connection screw shaft 17 is constituted by a screw having the relation tanβ2<μ2 when β2 is the screw lead angle of the connection screw shaft 17, and μ2 is the friction coefficient of the screw. Hence, even in the case where axial thrust force is given from the main shaft 45, the connection screw shaft 17 cannot rotate.

This means that the draw bar 91 giving force to the chuck claw 42 in the work-holding direction never moves axially toward the load side, this is, the work-holding force of the chuck claw 42 is never reduced even in the case where the first servomotor 20 is switched off at the time when a work is being worked.

Immediately after cutting of the work 43 is finished, an operation of releasing the work 43 from the chuck claw 42 is carried out. The motor rotary shaft 20a of the first servomotor 20 is rotated reversely with predetermined torque to move the pull rod 23 axially slightly toward the load side in the reverse operation to the work-holding operation to thereby loosen the chuck claw 42.

Then, in the condition that the electromagnetic brake 32 is excited again, the second servomotor 31 is operated to rotate the motor rotary shaft 31a from the state of (d) of FIG. 4 to a state of (e) of FIG. 4 to thereby move the feed screw shaft 31c, the moving shafts 31d and 31e and the first and second driving gears 35 and 38 axially toward the side reverse to the load side.

A gear sensor (not shown) makes the phase of the first driving gear 35 coincident with the phase of the first driven gear 37 and makes the phase of the second driving gear 38 coincident with the phase of the second driven gear 40, so that the feed screw nut 31c moves to come into contact with the motor rotary shaft 31a while the teeth of the first and second driving gears 35 and 38 mesh with the teeth of the first and second driven gears 37 and 40 respectively. As a result, a state of (e) of FIG. 4 is obtained.

Next, in the state of (e) of FIG. 4, when the electromagnetic brake 32 is released, the feed screw nut 31c abuts on the step portion of the motor rotary shaft 31a and cannot move axially toward the side reverse to the load side any more so that the feed screw nut 31c is axially immovable but rotatable in the rotation direction. Accordingly, the feed screw nut 31c rotates in this position.

Because the second servomotor 31 rotates in a direction reverse to that carried out in the work-holding operation, the first and second driving gears 35 and 38 rotate along with the rotation to thereby rotate the connection screw shaft 17 and the connection nut 16 in which the first and second driven gears 37 and 40 driven by the first and second driving gears 35 and 38 respectively are provided. Because the rotational velocity of the connection screw shaft 17 is different from the rotational velocity of the connection nut 16 as described above, the connection screw shaft 17 is thrust into the connection nut 16 by differential motion. Thus, the connection screw shaft 17 rotationally moves toward the load side up to a state of (f) of FIG. 4.

On this occasion, as described above, the rotation-to-reciprocation converting means 11 is connected to the connection screw shaft 17 through the bearing 24. The reciprocation-to-rotation converting means 5 is connected to the rotation-to-reciprocation converting means 11 through the first nut 7 and the first screw shaft 6. The reciprocation converting means 1 is connected to the reciprocation-to-rotation converting means 5 through the bearing 21. Configuration is made so that the first servomotor 20 of the reciprocation converting means 1 cannot move axially, and so that the third screw shaft 3 cannot move axially so long as the third nut 2 is not rotated. Therefore, the first servomotor 20 is successively operated in synchronism with the second servomotor 31 of the driving means 30 (operated synchronously in a direction in which the third screw shaft 3 can move right in the drawing) to thereby rotate the third nut 2.

As a result, the movement of the connection screw shaft 17 can be absorbed between the third nut 2 and the third screw shaft 3, so that the rotation-to-reciprocation converting means 11, the reciprocation-to-rotation converting means 5 and the third screw shaft 3 of the reciprocation converting means 1 integrally move toward a load side by the same distance as the moving distance of the connection screw shaft 17.

Incidentally, as described above, on this occasion, the connection screw shaft 17 is rotatably supported by the bearing 24 and the first servomotor 20 is operated in synchronism with the second servomotor 31 of the driving means 30 to rotate the third nut 2, so that the movement of the connection screw shaft 17 is absorbed between the third nut 2 and the third screw shaft 3. Hence, the first nut 7 moves axially toward the load side without rotation.

Along with the movement of the rotation-to-reciprocation converting means 11, the pull rod 23 and the draw bar 91 move axially toward the load side. The axial operation of the pull rod 23 and the draw bar 91 is converted into the radial operation of the chuck claw 42 by the operation converting mechanism 41, so that the work 43 is released from the chuck 44.

Then, after a new work 43 is set, the second servomotor 31 is rotated to return the state to the state of (a) of FIG. 4. Then, operation shown in (b) to (f) of FIG. 4 is repeated.

Incidentally, it is a matter of course that the reciprocating means 1 in the Second embodiment may be replaced by the reciprocating means 58 in First embodiment.

Third Embodiment

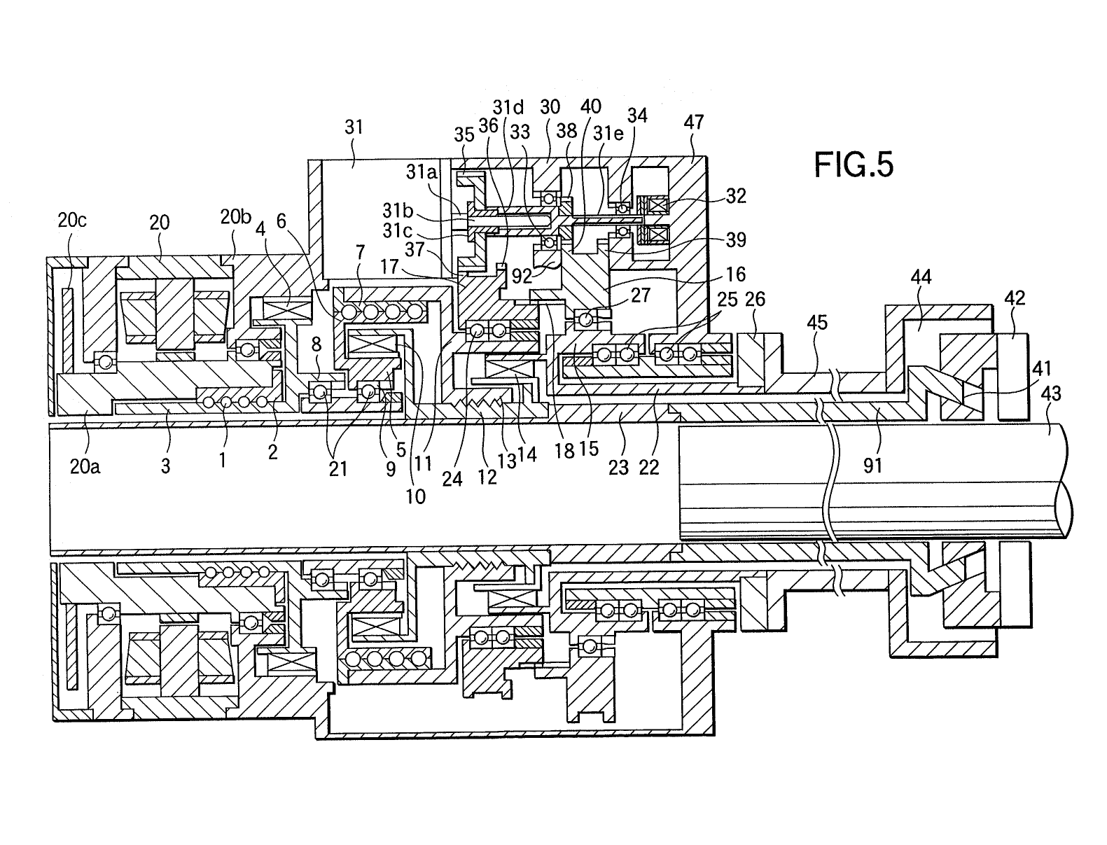

Third embodiment for carrying out the present invention will be described below with reference to FIG. 5 (which is a view in vertical section of a chucking machine to which the thrust converter is applied).

The reference numeral 15 designates a reaction force receiving means. The reaction force receiving means 15 includes: a main rotary shaft 22; a first bearing 25 for rotatably but axially immovably bearing the main rotary shaft 22; a connection means 18 including a connection nut 16 which is a second screw rotatably but axially immovably supported through a bearing 27 on an outer circumferential portion of the main rotary shaft 22, and a connection screw shaft 17 which is a first screw thread-engaged with the connection nut 16; and a third bearing 24 for bearing the connection screw shaft 17 rotatable but axially immovable relative to the first nut 7.

Incidentally, other configuration is the same as that in Second embodiment.

The operation will be described below. In the holding operation shown in (b) to (c) of FIG. 4, when the second servomotor 31 is operated in synchronism with the first servomotor 20, the feed screw nut 31c, the first driving gear 35 meshing with the first driven gear 36, and the second driving gear 38 meshing with the second driven gear 39 rotate as the motor rotary shaft 31a rotates.

The connection screw shaft 17 and the connection nut 16, in which the first and second driven gears 36 and 39 are provided respectively, rotate along with the rotation of the first and second driven gears 36 and 39.

On this occasion, the connection nut 16 rotates without being dragged with the rotary shaft 22 because the connection nut 16 is supported by the bearing 27. Hence, a motor not requiring any torque for driving the main rotary shaft 22 or the like can be provided as the second servomotor 31.

Also at the time when the work is being worked, the connection nut 16 and the connection screw shaft 17 do not rotate integrally with the main rotary shaft 22 or the like because the connection nut 16 and the connection screw shaft 17 are rotatably supported by the bearings 24 and 27 respectively.

Because the rotational velocity of the connection screw shaft 17 is different from the rotational velocity of the connection nut 16, the connection screw shaft 17 rotationally moves toward the side reverse to the load side up to a state of (c) of FIG. 4 due to differential motion. Further, the chuck-opening operation shown in (d) to (f) of FIG. 4 is reverse in rotating direction to the above-mentioned holding operation. Along with the rotation, the connection screw shaft 17 is thrust into the connection nut 16 so that the connection screw shaft 17 rotationally moves toward the load side up to a state of (f) of FIG. 4.

Incidentally, in the holding operation and the opening operation, an operation of synchronously operating the first servomotor 20 to reciprocate the reciprocation-to-rotation converting means 5 or the like following the axial movement of the connection screw shaft 17 to thereby prevent the first nut 7 from rotating is similar to that in Second embodiment.

Third embodiment as to other operations is the same as Second embodiment.

Fourth Embodiment

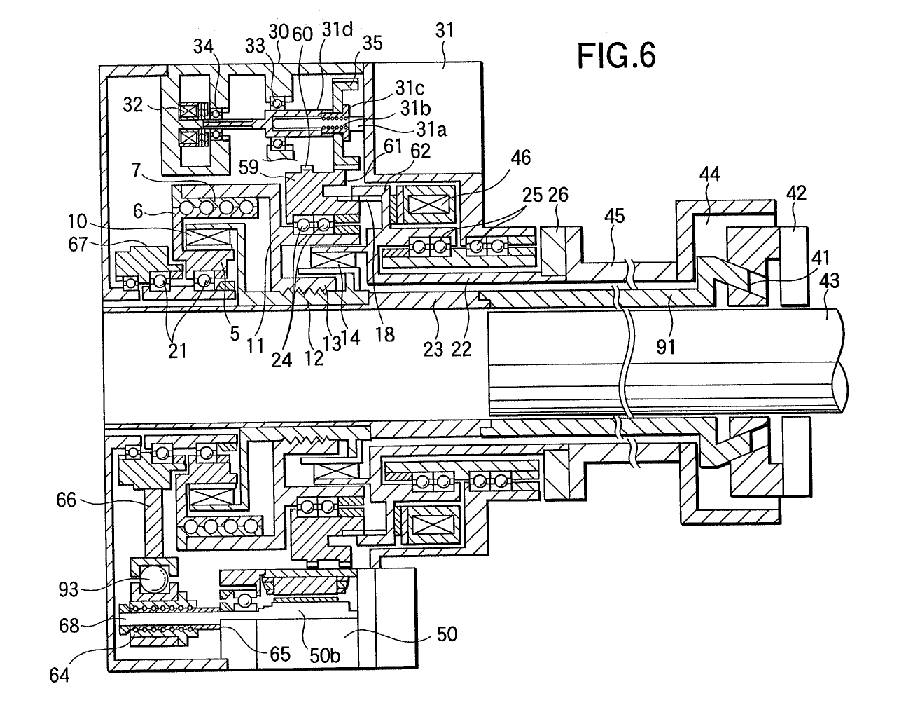

Fourth embodiment for carrying out the present invention will be described below with reference to FIG. 6 (which is a view in vertical section of a chucking machine to which the thrust converter is applied).

The reference numeral 68 designates a reciprocating means which is equivalent to the reciprocating means 58 in First embodiment. The reciprocating means 68 includes: a first servomotor 50 having a motor rotary shaft 50b; a third screw shaft 65 fixed on the same axial line as that of the motor rotary shaft 50b; a third nut 64 thread-engaged with the third screw shaft 65; and a reciprocating portion 67 connected to the third nut 64 through a flexible coupling 93 and a reciprocating thrust transfer plate 66. Incidentally, the third screw shaft 65 and the third nut 64 form a motor rotation-to-reciprocation converting means.

Fourth embodiment as to other configuration is similar to First embodiment.

In the case of Fourth embodiment, along with the rotation of the motor rotary shaft 50b, the third screw shaft 65 fixed on the motor rotary shaft 50b rotates so that the third nut 64 thread-engaged with the third screw shaft 65 moves axially. The operation similar to that carried out in First embodiment is performed except that the axial movement of the third nut 64 is transferred, through the flexible coupling 93 and the reciprocating thrust transfer plate 66, to the reciprocating portion 67 connected to the reciprocation-to-rotation converting means 5 through the bearing 21.

Hence, the movement of the rotation-to-reciprocation converting means 11 and the reciprocation-to-rotation converting means 5 along with the movement of the connection screw shaft 59 described with reference to FIG. 2 is absorbed between the third nut 64 and the third screw shaft 65 through the reciprocating portion 67, the reciprocating thrust transfer plate 66 and the flexible coupling 93.

Incidentally, it is a matter of course that the reciprocating means 68 in Fourth embodiment can be applied to the reciprocating means 1 in Second embodiment or 3.

Fifth Embodiment

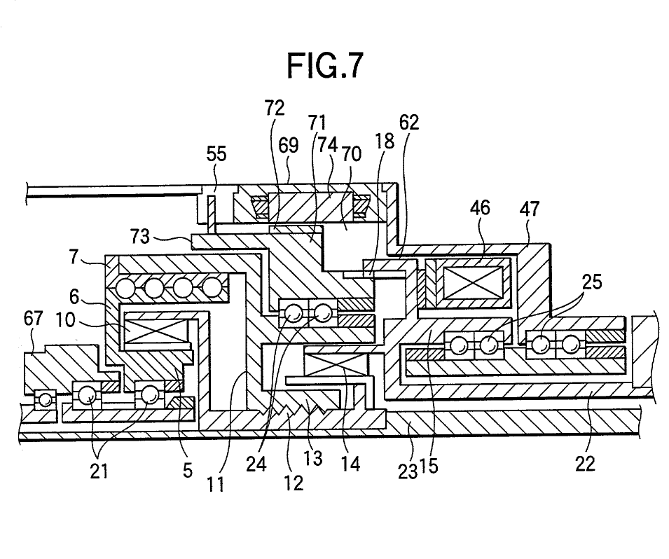

Fifth embodiment for carrying out the present invention will be described below with reference to FIG. 7 (which is a view in vertical section mainly showing a driving means of the thrust converter).

Fifth embodiment is different from Fourth embodiment only in the portion of the driving means but similar to Fourth embodiment in other configuration and operation than the driving means. Hence, only the configuration and operation of the driving means will be described here.

The reference numeral 70 designates a driving means. The driving means 70 includes: a feed servomotor 69 having a rotational position detector 55; and a motor rotary shaft 73 disposed outside a connection screw shaft 71 and rotatably supported by a bearing 24. A permanent magnet 72 is disposed outside the motor rotary shaft 73 so as to be opposite to a stator 74 of the feed servomotor 69.

Further, the relation L2+S≦L1 is established among the axial length L2 of the permanent magnet 72, the required feed stroke S thereof and the axial length L1 of the stator 74. That is, the size of a portion not contributing to motor-generated torque is shortened as extremely as possible in order to make the motor 69 more inexpensive.

An electromagnetic brake 46 is fixed to the frame 47. A part of the connection nut 62 is used as a brake disk.

The operation of the driving means 70 will be described below.

First, the connection nut 62 is locked by the electromagnetic brake 46 so as to be disabled from rotating. Then, the feed servomotor 69 is operated to rotate the motor rotary shaft 73. Because the connection screw shaft 71 is formed in the motor rotary shaft 73, the connection screw shaft 71 makes rotational reciprocating motion as the motor rotary shaft 73 rotates. On this occasion, the rotation-to-reciprocation converting means 11, the reciprocating-rotation means 5 and the reciprocating portion 67 are reciprocated in synchronism with the reciprocating motion of the connection screw shaft 71, so that the holding operation or the releasing operation can be made without rotation of the first nut 7.

Incidentally, it is a matter of course that the driving means 70 in the Fifth embodiment can be applied also to the driving means 30 in any one of The embodiments 1 through 3.

Sixth Embodiment

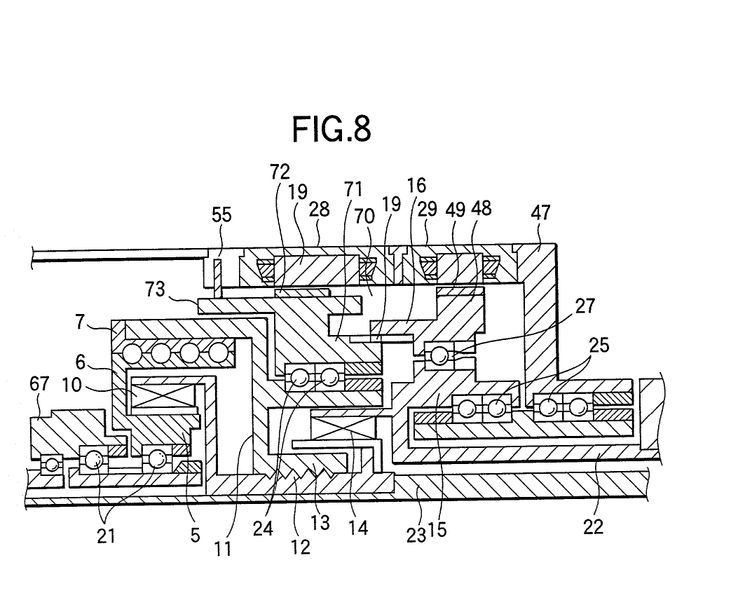

Sixth embodiment for carrying out the present invention will be described below with reference to FIG. 8 (which is a view in vertical section mainly showing a driving means of the thrust converter).

The Sixth embodiment is different from Fourth embodiment only in the portion of the driving means but similar to Fourth embodiment in other configuration and operation than the driving means. Hence, only the configuration and operation of the driving means will be described here.

The reference numeral 70 designates a driving means. The driving means 70 includes: a feed servomotor 28 having a rotational position detector 55; a brake servomotor 29; a motor rotary shaft 73 disposed outside a connection screw shaft 71 and rotatably supported by a bearing 24; a permanent magnet 72 fixed to the motor rotary shaft 73; a motor rotary shaft 48 disposed outside a connection nut 16 and rotatably supported by a bearing 27; and a permanent magnet 49 fixed to the motor rotary shaft 48.

The relation L2+S≦L1 is established among the axial length L2 of the permanent magnet 72, the quick-feed necessary stroke S thereof and the axial length L1 of the stator 19. That is, the size of a portion not contributing to motor-generated torque is shortened as extremely as possible in order to make the motor 28 more inexpensive.

The operation of the driving means 70 will be described below.

First, the feed servomotor 28 is operated to rotate the motor rotary shaft 73 including the connection screw shaft 71. On the other hand, the brake servomotor 29 is servo-locked to disable the motor rotary shaft 48 including the connection nut 16 from rotating. With the rotation of the motor rotary shaft 73 including the connection screw shaft 71, the connection screw shaft 71 makes rotational reciprocating motion.

The rotation-to-reciprocation converting means 11, the reciprocating-rotation means 5 and the reciprocating portion 67 are reciprocated in synchronism with the reciprocating motion of the connection screw shaft 71, so that the holding operation or the releasing operation can be made without rotation of the first nut 7. For example, the quantity of the reciprocating motion is calculated on the basis of the screw lead and rotational velocity of the connection screw shaft 71 by the rotation detector 55 of the feed servomotor 28.

Incidentally, it is a matter of course that the driving means 70 in Sixth embodiment can be applied to the driving means 30 in any one of The embodiments 1 through 3.

Seventh Embodiment

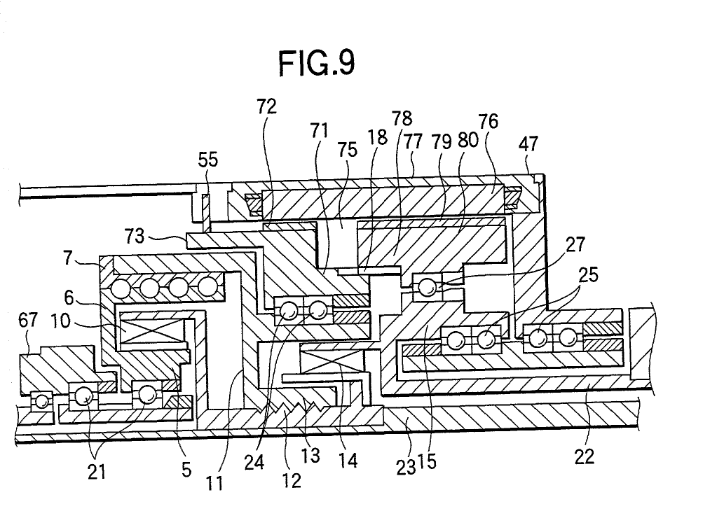

Seventh embodiment for carrying out the present invention will be described below with reference to FIG. 9 (which is a view in vertical section mainly showing a driving means of the thrust converter).

Seventh embodiment is different from Fourth embodiment only in the portion of the driving means but similar to Fourth embodiment in other configuration and operation than the driving means. Hence, only the configuration and operation of the driving means will be described here.

The reference numeral 75 designates a driving means. The driving means 75 includes: a feed servomotor 77 which is a driving means having a rotational position detector 55; a second motor rotary shaft 73 disposed outside the connection screw shaft 71 and rotatably supported by the bearing 24; a permanent magnet 72 fixed to the outside of the second motor rotary shaft 73; a third motor rotary shaft 80 disposed outside the connection nut 78 and rotatably supported by the bearing 27; and a permanent magnet 79 fixed to the outside of the third motor rotary shaft 80. Incidentally, the permanent magnets 72 and 79 are disposed opposite to a stator 76.

The second motor rotary shaft 73 and the third motor rotary shaft 80 are provided so as to be different from each other in the number of poles. In this embodiment, the number of poles in the second motor rotary shaft 73 is set to be twice as large as the number of poles in the third motor rotary shaft 80.

Configuration is made so that there is a relation of Lm72+Lm79+Ls2<Lf2 among the axial length Lm72 of the permanent magnet 72, the axial length Lm79 of the permanent magnet 79, the feed necessary stroke Ls2 and the axial length Lf2 of the stator 76.

The operation of the driving means 75 will be described below.

First, the feed servomotor 77 is operated to generate rotational magnetic field. On this occasion, the second motor rotary shaft 73 is rotated by the rotational magnetic field generated, so that the second motor rotary shaft 73 makes a normal servo operation. On the other hand, the third motor rotary shaft 80 makes stepping-rotation in the same direction on the basis of the relation in magnetic poles. Accordingly, a rotational velocity difference is generated between the second motor rotary shaft 73 and the third motor rotary shaft 80, so that the connection screw shaft 71 makes rotational reciprocating motion by differential motion.

For example, the rotational difference between the second motor rotary shaft 73 and the third motor rotary shaft 80 is obtained on the basis of comparison between an output from an angle sensor (not shown) for detecting the rotational angle of the third motor rotary shaft 80 and an output from the rotation detector 55 of the feed servomotor 77 for detecting the rotational angle of the second motor rotary shaft 73. The quantity of the reciprocating motion of the connection screw shaft 71 is obtained on the basis of the difference and the lead of the connection screw shaft 71.

On this occasion, the reciprocation-to-rotation converting means 5 and the reciprocating portion 67 are reciprocated in synchronism with the obtained reciprocating motion of the connection screw shaft 71, so that the holding operation or the releasing operation can be made without rotation of the first nut 7.

Incidentally, when the number of magnetic poles in the stator 76, the number of poles in the second motor rotary shaft 73 and the number of poles in the third motor rotary shaft 80 are set to satisfy a predetermined relation, the third motor rotary shaft 80 can be provided to make stepping-rotation in a direction reverse to that of the second motor rotary shaft 73 due to the relation of the magnetic poles.

It is a matter of course that the driving means 75 in the Sixth embodiment can be applied to the driving means 30 in any one of Embodiments 1 through 3.

Eighth Embodiment

Although each of the aforementioned respective embodiments has shown the case where the connection nut which is a second screw is provided on the main rotary shaft while the connection screw shaft which is a first screw is driven to reciprocate by the driving means, it is obvious that the same action and effect as described above is obtained even in the reverse configuration to the above-mentioned case, that is, even if the connection screw shaft equivalent to the second screw is provided on the main rotary shaft while the connection nut equivalent to the first screw is driven to reciprocate by the driving means.

Although each of the aforementioned respective embodiments has shown the case where the first servomotor having a rotor is used as a main driving source of the thrust converter so that the rotational torque of the first servomotor is converted into axial thrust force by the rotation-to-reciprocation converting means, it is obvious that, if a driving source such as a linear motor not required for converting rotational torque into axial thrust force is used as a main driving source of the thrust converter, the rotation-to-reciprocation converting means becomes unnecessary and the driving source such as a linear motor provided as a reciprocating means will be sufficient.

Ninth Embodiment

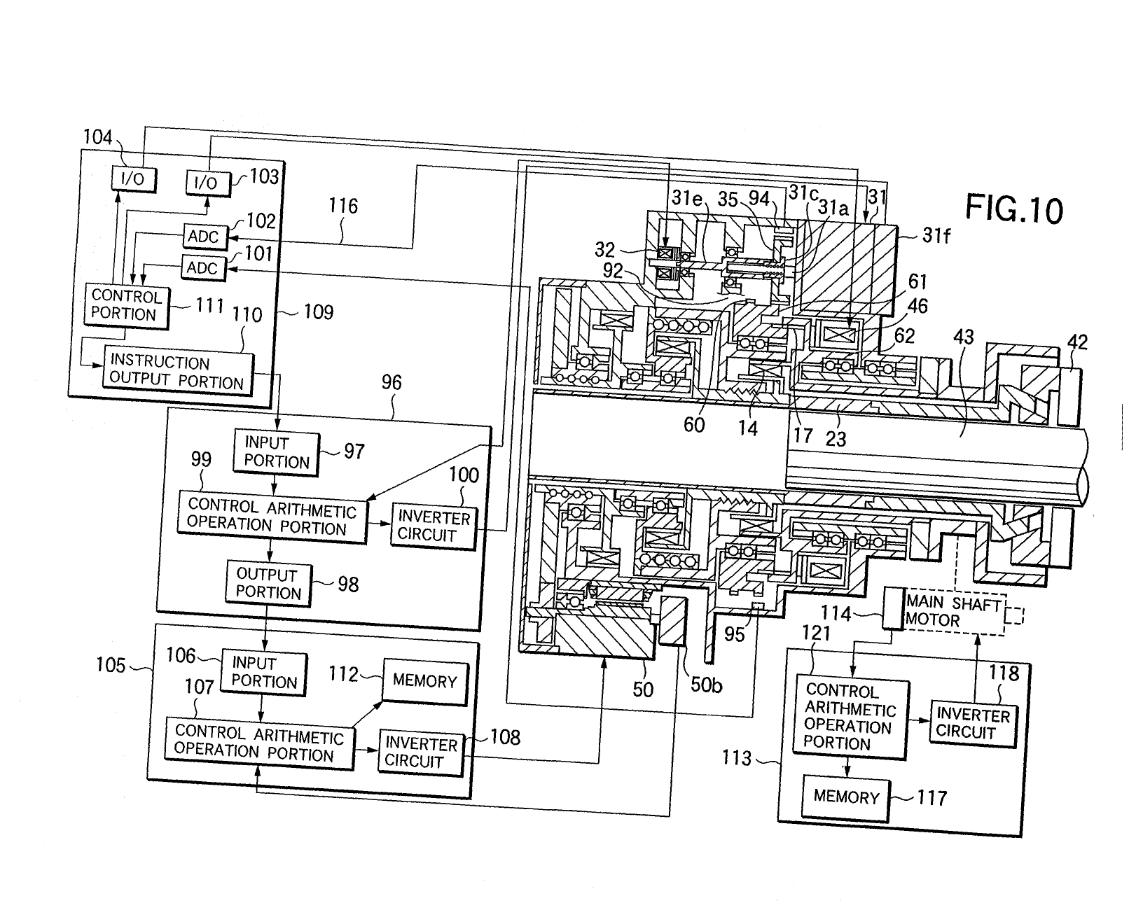

Ninth embodiment for carrying out the present invention will be described below with reference to FIGS. 10 through 15.

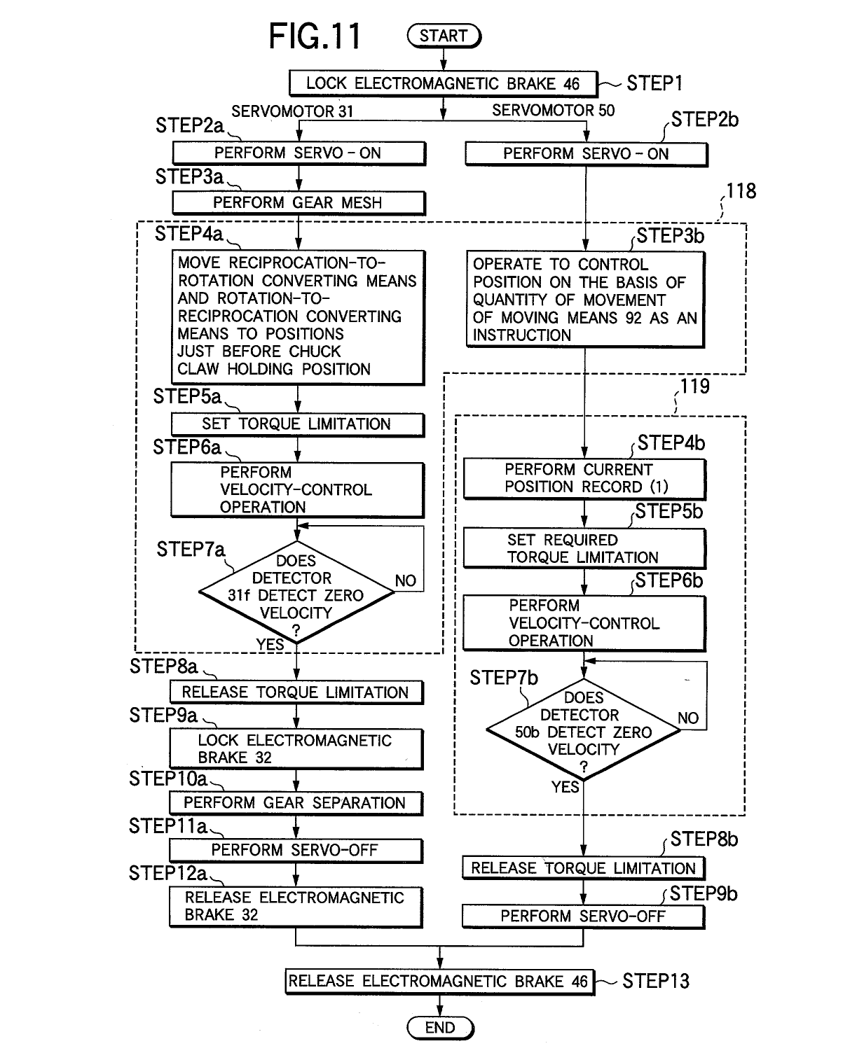

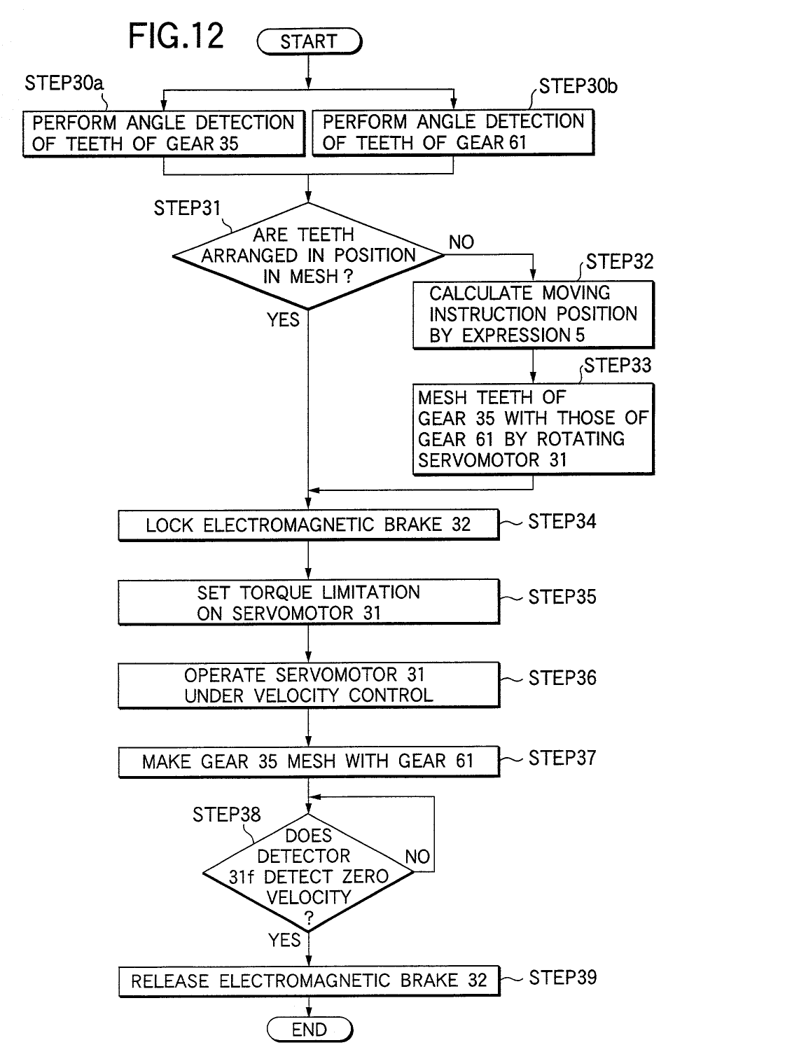

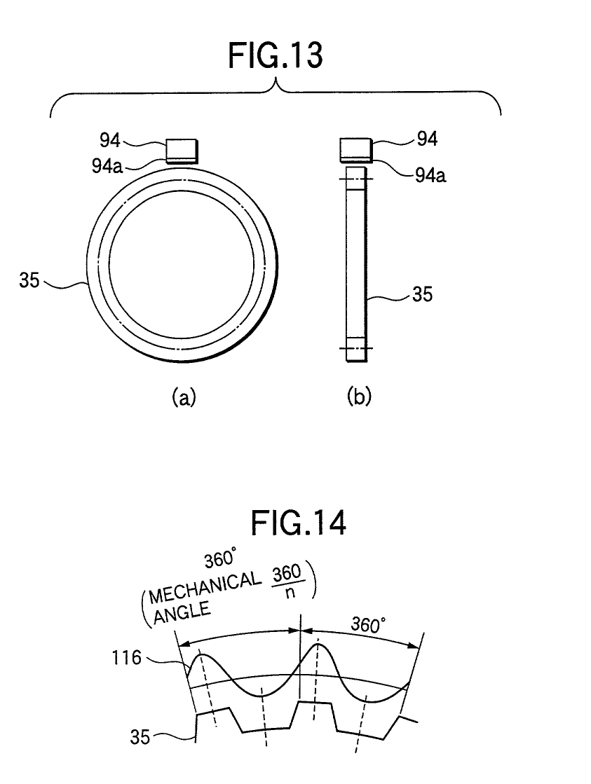

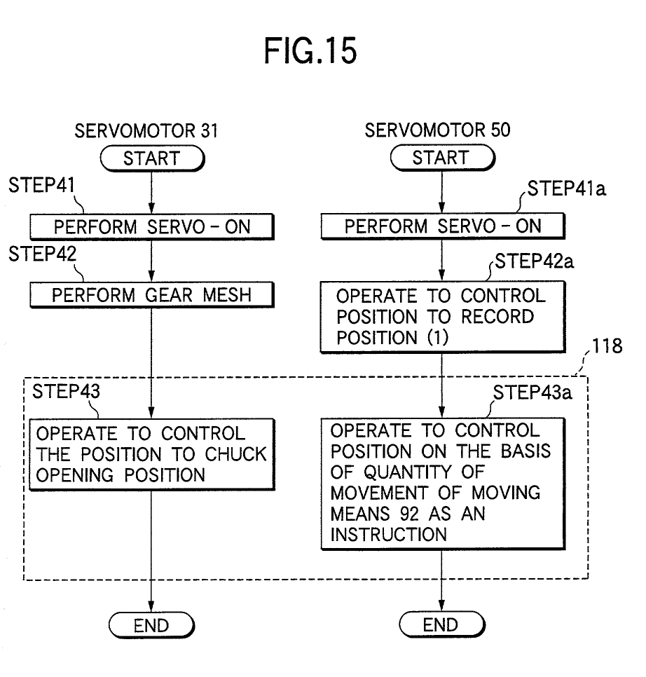

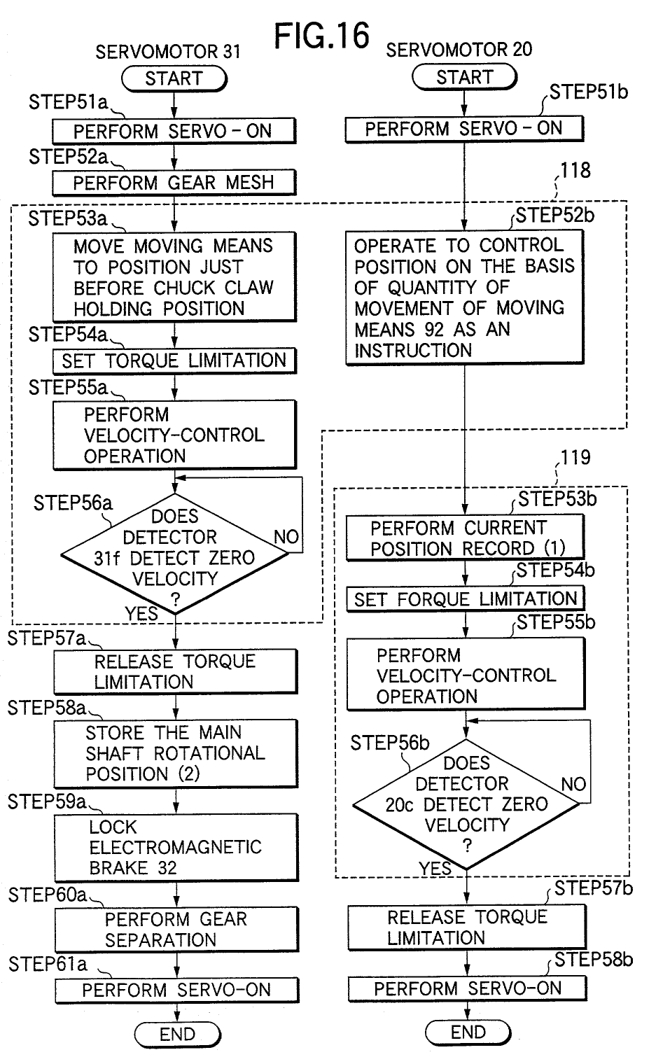

Incidentally, this embodiment relates to a controller for operating the thrust converter having the configuration described in First embodiment (FIGS. 1 and 2). FIG. 10 is a view showing the configuration of the controller. FIG. 11 is a flow chart for explaining the holding operation until the work 43 is held by the chuck claw 42. FIG. 12 is a flow chart showing the operation related to the mesh of the driving gear 35 with the gear 60 or 61. FIG. 13 is a view for explaining the mount state of a magnetic sensor. (a) of FIG. 13 is a front view and (b) of FIG. 13 is a right side view. FIG. 14 is a view for explaining the action of the magnetic sensor. FIG. 15 is a flow chart for explaining the operation when the work 43 held by the chuck claw 42 is released.

In FIG. 10, a high-order controller 109 outputs an instruction from its control portion 111 to a controller 96 through a first instruction output portion 110. The controller 96 receives the instruction through its input portion 97. A control arithmetic operation portion 99 of the controller 96 drives an inverter circuit 100 by feedback control to operate the second servomotor 31 on the basis of the instruction and the quantity of rotation detected by the rotation detector 31f of the second servomotor 31. The control arithmetic operation portion 99 further outputs an instruction from its output portion 98 to the first servomotor 50.

A controller 105 of the first servomotor 50 receives the instruction through its input portion 106. A control arithmetic operation portion 107 of the controller 105 drives an inverter circuit 108 by feedback control to operate the first servomotor 50 on the basis of the instruction and the quantity of rotation detected by the rotation detector 50b of the first servomotor 50. A memory 112 of the controller 105 stores the current position when the chuck claw 42 driven by the second servomotor 31 holds the work 43.

An analog signal detected by a magnetic sensor 94 disposed opposite to the teeth of the driving gear 35 at a predetermined distance and an analog signal detected by a magnetic sensor 95 disposed opposite to the teeth of the driven gear 61 at a predetermined distance are converted into digital data by A/D converters 102 and 101 of the high-order controller 109, so that the digital data are transmitted to the control portion 111. The control portion 111 controls excitation/non-excitation of the electromagnetic brake 32 through an input/output portion 103 of the high-order controller 109 and controls excitation/non-excitation of the electromagnetic brake 46 through an input/output portion 104.

A controller 113 of the main shaft motor drives the inverter circuit 108 by feedback control to operate the main shaft motor on the basis of the instruction given from a control arithmetic operation portion 121 to the main shaft motor and the quantity of rotation detected by the rotation detector 114 of the main shaft motor.

A memory 117 of the controller 113 stores the rotational position (obtained from an output of the detector 114) of the main shaft in which the respective gears mesh with each other.

Incidentally, the details of the magnetic sensors 94 and 95 will be described later.

The operation of the Ninth embodiment will be described below with reference to FIGS. 10 through 15.

First, the holding operation in which the work 43 is finally held by the chuck claw 42 will be described with reference to the flowchart of FIG. 11 in connection with FIG. 2. Further, the operation related to the mesh of the driving gear 35 with the gear 60 or 61 will be described with reference to FIGS. 12 through 14.

That is, in FIG. 11 (showing the operation of the second servomotor 31 in the left column and the operation of the first servomotor 50 in the right column), in a state of (a) of FIG. 2 in which the driving gear 35 meshes neither with the driven gear 60 nor with the driven gear 61, first, the electromagnetic brake 46 is locked by the control portion 111 of the high-order controller 109 (step 1). The second servomotor 31 and the first servomotor 50 are made servo-on by the controllers 96 and 105 (steps 2a and 2b). Incidentally, on this occasion, the first servomotor 50, the second servomotor 31 and the main shaft motor are in a stop state because there is no instruction inputted thereto yet. Then, the gear mesh (step 3a) is performed to make the driving gear 35 mesh with the driven gear 61.

Incidentally, the gear mesh (step 3a) is executed as shown in FIG. 12.

That is, first, the angles of teeth of the driving gear 35 and the driven gear 61 are detected by the magnetic sensors 94 and 95 respectively (steps 30a and 30b).

Incidentally, the magnetic sensor 94 is a magnetic sensor using a magnetic reluctance device and having a sensor face 94a disposed opposite to teeth of the driving gear 35 at a predetermined distance as shown in FIG. 13. Incidentally, the magnetic sensor 95 also uses a magnetic reluctance device in the same manner as the magnetic sensor 94 and has a sensor face disposed opposite to teeth of the driven gear 61 at a predetermined distance.

A signal waveform obtained by the magnetic sensor 94 in the aforementioned arrangement becomes a signal waveform, as represented by 116 in FIG. 14, having peaks when any one of the teeth of the driving gear 35 comes near to the magnetic sensor 94 and when any of the teeth of the driving gear 35 goes away from the magnetic sensor 94. Incidentally, the signal waveform 116 is not perfect sine wave but can be regarded as sine wave approximately when the sensitivity of the magnetic sensor 94 and the distance between the magnetic sensor 94 and the driving gear 35 are taken moderately.

Accordingly, in FIG. 10, the positions of the teeth of the gear can be detected if the analog output 116 of the magnetic sensor 94 is digitized by use of the A/D converter 102 and interpolation-divided by the controller 111. Incidentally, the position of the gear is expressed as an angle obtained by inverse sine transformation of sine wave. That is, the gear position is detected while the angle from the passage of one gear through the front face 94a of the magnetic sensor to the arrival of the next gear at the front face of the magnetic sensor 94 is regarded as 360 degrees. As shown in FIG. 14, in the case of a gear having teeth n in number, this is equivalent to a mechanical angle of 360/n degrees.

Also the magnetic sensor 95 uses a magnetic reluctance device for detecting the positions of teeth of the driven gear 61 in the same manner as described above. The detected data are outputted to the control portion 111 of the high-order controller 109 through the A/D converters 101 and 102 respectively. Here, the control portion 111 of the high-order controller 109 compares angles of teeth of gears while a value in a phase shifted by 180 degrees from the detected angle of the gear position of the driven gear 61 is regarded as the instructed position of the driving gear 35.

Specifically, because the magnetic sensor generally outputs two-phase signals having two phases shifted by 90 degrees from each other, the detected angle of the driving gear 35 is calculated as

$$θ = {tan}^{- 1} \frac{{k}_{sin} ( {v}_{a} - {Off}_{sin} )}{{k}_{cos} ( {v}_{b} - {Off}_{cos} )} .$$

In the above Expression, θ is the gear position detection angle, tan⁻¹ is arctangent, kₛᵢₙ and k_{cos} are correction factors by which the amplitudes of two signals outputted from the magnetic sensor are made coincident with each other, Offₛᵢₙ and Off_{cos} are intermediate voltages (offsets) of the detection signals, and Vₐ and V_{b} are voltages detected by the magnetic pole sensors with the phases shifted by 90°. One of teeth of one gear has to come into a portion between adjacent teeth of the other gear so that the gears mesh with each other. Accordingly, mesh can be made if a teeth of the driving gear 35 is located in a position of θ+180 degrees with respect to the angle θ of a teeth of the driven gear 61.

When the two gears are not located in the mesh position, it is necessary to rotate the driving gear 35 with the angle of θ+180 as an instructed position. The instructed position is calculated by the following expression using the number n of teeth of the gear.

$$\begin{matrix}( Instructed Position ) = \frac{θ + 180}{n} \\ = \frac{{tan}^{- 1} \frac{{k}_{sin} ( {v}_{a} - {Off}_{sin} )}{{k}_{cos} ( {v}_{b} - {Off}_{cos} )} + 180}{n}\end{matrix} \qquad ( Expression 5 )$$

The angles of teeth of the gears are detected by the aforementioned method and a judgment is made as to whether the gears meshes with each other or not (step 31). If the gears are not in the mesh position, the moving instruction position is calculated by the aforementioned expression 5 (step 32). Because the electromagnetic brake 32 is in a released state, the controller 96 drives the second servomotor 31 to rotate the driving gear 35 to the position indicated by the expression 5 (step 33).

After the driving gear 35 is moved to the angle for meshing with the driven gear 61, the electromagnetic brake 32 is locked by the control portion 111 of the high-order controller 109 (step 34). The rotational torque of the second servomotor 31 is set to be torque required when the feed screw shaft 31c is pressed against the step portion of the motor rotary shaft 31a (step 35). Then, the second servomotor 31 is rotated by velocity control (step 36). On this occasion, the feed screw nut 31c thread-engaged with the feed screw shaft 31b, the moving shafts 31d and 31e and the driving gear 35 move to the second servomotor 31 side because the electromagnetic brake 32 prevents the feed screw nut 31c, the moving shafts 31d and 31e, and the driving gear 35 from making motion in the rotating direction. Because the magnetic sensors 94 and 95 make the phase of the driving gear 35 and the phase of the driven gear 61 coincident with each other as described above, the feed screw nut 31c moves to come into contact with the step portion of the motor rotary shaft 31a while the teeth of the driving gear 35 mesh with the teeth of the driven gear 61 (step 37). On this occasion, the control arithmetic operation portion 99 of the controller 96 monitors whether zero velocity is detected by the detector 31f or not (step 38). When the control arithmetic operation portion 99 confirms that zero velocity is detected by the detector 31f, the control arithmetic operation portion 99 unlock the electromagnetic brake 32 (step 39) on the basis of the conclusion that the feed screw nut 31c is in contact with the step portion of the motor rotary shaft 31a. At this point of time, a state of (b) of FIG. 2 is obtained.

Incidentally, a torque limitation is set with respect to the second servomotor 31 in the step 35 to control the torque so that torque higher than required is not generated for the following reason. That is, if operation is made only by the normal position control, there is the possibility that the quantity of movement of the feed screw nut 31c may run short or excessively so that the second servomotor 31 operates with the maximum torque, so that it is necessary that the feed screw nut 31c is pressed against the step portion of the motor rotary shaft 31a by appropriate pressure as shown in (b) of FIG. 2.

The topic will be returned to the description of the flow chart shown in FIG. 11. After the gear mesh (step 3a) is executed as described above, that is, after the state of (b) of FIG. 2 is obtained, the second servomotor 31 is rotated continuously.

As a result, the electromagnetic brake 46 is locked to thereby lock the connection nut 62, the electromagnetic brake 32 is unlocked to thereby make the feed screw nut 31c movable in the rotation direction and the feed screw nut 31c comes into contact with the step portion of the motor rotary shaft 31a so as to be axially immovable. Accordingly, if the second servomotor 31 rotates continuously, the feed screw nut 31c rotates in that position. With this rotation, the driving gear 35 fixed to the feed screw nut 31c also rotates to thereby rotate the connection screw shaft 59 on which the driven gear 61 meshing with the driving gear 35 is provided. Because the connection nut 62 is whirl-stopped by the electromagnetic brake 46, the connection nut 62 is not dragged with the rotation of the connection screw shaft 59 but only the connection screw shaft 59 rotates so that the reciprocation-to-rotation converting means 5 and the rotation-to-reciprocation converting means 11 connected to the connection screw shaft 59 through the bearing 24 are moved by position control to positions just before the chuck claw 42 holds the work 43 (step 4a).

After the reciprocation-to-rotation converting means 5 and the rotation-to-reciprocation converting means 11 are moved to positions just before the chuck claw 42 holds the work 43, a torque limitation is set to the second servomotor 31 (step 5a). An instruction is outputted from the controller 96 to perform an operation (step 7a) until the chuck claw 42 stops while holding the work 43 under the set pressure by low velocity speed control (step 6a), that is, until the detector 31f detects zero velocity.

Incidentally, the required time for executing steps 6a and 7a is short, because the chuck nail 42 is moved to a position immediately before the work holding in step 4a.

Further, when the work holding due to the drive of the moving means 92 (the drive of the second servomotor 31) is executed by simple position control, the work size may vary as follows. When, for example, the work size is larger than the designed value, the chuck claw 42 is urged to be operated excessively to thereby apply a high load onto the driving means 30 of the moving means 92. On the contrary, when the work size is smaller, the work is held imperfectly. The variation in the work size, however, can be taken into consideration by the manipulation in the steps 4a to 7a so that the chuck claw 42 can be moved to the work-holding position rapidly.

At the time of the operation of the steps 4a to 7a, the first servomotor 50 is operated to follow the second servomotor 31. That is, the quantity of movement of the moving means 92 calculated on the basis of data of the detector 31f by the controller 96 is inputted as an instruction of the first servomotor 50 to the controller 105 from the controller 96, so that the controller 105 operates to control the position of the first servomotor 50 on the basis of the instruction (step 3b).

Incidentally, the reason why the first servomotor 50 is operated to follow the second servomotor 31 at the time of the operation of the step 4a to 7a is as follows. As described above also in First embodiment, the rotation-to-reciprocation converting means 11 is connected to the connection screw shaft 59 through the bearing 24. The reciprocation-to-rotation converting means 5 is connected to the rotation-to-reciprocation converting means 11 through the first nut 7 and the first screw shaft 6. The reciprocating means 58 is connected to the reciprocation-to-rotation converting means 5 through the bearing 21. Configuration is made so that the first servomotor 50, or the like, of the reciprocating means 58 is axially immovable and so that the third screw shaft 54 is axially immovable if the third nut 53 is not rotated.

Hence, when the first servomotor 50 is operated to follow the second servomotor 31, the movement of the connection screw shaft 59 can be absorbed between the third nut 53 and the third screw shaft 54. As a result, the rotation-to-reciprocation converting means 11, the reciprocation-to-rotation converting means 5 and the third screw shaft 54 of the reciprocating means 58 integrally move left in the drawing by a distance substantially equal to the moving distance of the connection screw shaft 59.

Incidentally, when the first servomotor 50 is driven, the motor rotary shaft 50a is rotated with predetermined torque. The torque is transferred to the gear 52 through the gear 51 fixed to the motor rotary shaft 50a to thereby rotate the third nut 53 to which the gear 52 is fixed. Because the third screw shaft 54 thread-engaged with the third nut 53 is whirl-stopped relative to the frame 47 by the linear guide 56, the third screw shaft 54 is not dragged with the third nut 53 but makes reciprocating motion.

On this occasion, the controller 96 inputs the data detected by the detector 31f. The control arithmetic operation portion 99 calculates the quantity of movement of the moving means 92 on the basis of the input detected data. The calculated value is outputted as an instruction to the controller 105. In the aforementioned relation, the first servomotor 50 operates the leading edge's time late after the second servomotor 31 operates. This delay reduces the quantity of movement of the reciprocating portion of the rotation-to-reciprocation converting means 11 correspondingly to the delay time through the reciprocation-to-rotation converting means 5 and the rotation-to-reciprocation converting means 11. The reduction of the quantity of movement, however, may be ignored in terms of operation because the reduction through the reciprocation-to-rotation converting means 5 or the like is very small and because the delay is recovered when the moving means 92 stops finally.

After the operation (118 in the dotted line in FIG. 11) in the second operation mode in which the second servomotor 31 (and the first servomotor 50) is operated to move the rotation-to-reciprocation converting means 11, the reciprocation-to-rotation converting means 5 and the third screw shaft 54 of the reciprocating means 58, the drive of the moving means 92 (the drive of the second servomotor 31) to move the reciprocation-to-rotation converting means 5 and the rotation-to-reciprocation converting means 11 becomes unnecessary. Hence, the torque limitation on the second servomotor 31 is released (step 8a) and the electromagnetic brake 32 is unlocked (step 9a).

On the other hand, after the detector 31f detects zero velocity in the step 7a, the controller 105 performs an operation (119 in the dotted line frame in FIG. 11) in a so-called first operation mode in which the rotational torque of the first servomotor 50 is converted into predetermined axial thrust force by the rotation-to-reciprocation converting means 11, the reciprocation-to-rotation converting means 5, or the like, on the basis of the instruction given from the high-order controller 109 through the controller 96.

That is, the current position (the position where the chuck claw 42 holds the work 43 under the predetermined pressure by the drive of the second servomotor 31) transmitted to the controller 105 through the controller 96 is recorded as a record position (1) in the memory 112 contained in the controller 105 (step 4b). The required torque limitation is set on the holding force of the chuck claw 42 calculated by the expressions 1 to 4 (step 5b). Then, the first servomotor 50 is operated by a velocity-control operation (step 6b) to thereby generate the set holding force in the chuck claw 42. Incidentally, a torque-control operation may be made in the step 6b. When the detector 50b detects zero velocity (step 7b), the torque limitation on the first servomotor 50 is released (step 9b) and the first servomotor 50 is made servo-on (step 9b).

As a result, the thrust converter is in a state of (c) of FIG. 2.

On the other hand, as described above, after the work 43 is held by the chuck claw 42 with predetermined torque, the second servomotor 31 is operated (rotated in a direction reverse to that for the holding operation) in the condition that the electromagnetic brake 32 is locked (step 9a) to lock the moving shaft 31e. With the rotation of the motor rotary shaft 31a, the feed screw shaft 31b also rotates. As a result, the feed screw nut 31c, or the like, thread-engaged with the feed screw shaft 31b moves axially toward the side reverse to the load side (in the direction of the second servomotor).

The driving gear 35 fixed on the feed screw nut 31c also moves together from the state of (c) of FIG. 2 to a state of (d) of FIG. 2, that is, to a state in which the first driving gear 35 meshes neither with the gear 60 nor with the gear 61 (step 10a). When the state of (d) of FIG. 2 is obtained, the second servomotor 31 is made servo-off (step 11a) to be stopped and the electromagnetic brake 32 is unlocked (step 12a) Finally, the electromagnetic brake 46 is unlocked (step 13).

Incidentally, the reason why the work is worked in the state of (d) of FIG. 2 is to prevent noise from being caused by the gear mesh and to prevent increase in load or the like from being imposed on the main shaft motor because of the unnecessary rotation of the driving gear 35 or the like for working of a work.

As a result, the thrust converter is in a state of (d) of FIG. 2.

Incidentally, the connection nut 62 is locked in the rotation direction relative to the pull rod 23 by the action of the second linear guide 14. At the time of working, the connection nut 62 rotates together with the pull rod 23 which is driven to rotate by the main shaft motor. Accordingly, the electromagnetic brake 46 provided for fixing the connection nut 62 at the time of opening/closing the chuck as described above can be used as a main shaft brake in addition to force for reducing the velocity of the main shaft motor when the rotational velocity of the main shaft is reduced.

The operation of opening the chuck claw 42 will be described below on the basis of the flow chart of FIG. 15. Incidentally, in FIG. 15, the left column shows the operation of the second servomotor 31 and the right column shows the operation of the first servomotor 50.

That is, first, while the electromagnetic brake 46 is locked to lock the connection nut 62, the first servomotor 50 is made servo-on (step 41a). The control arithmetic operation portion 107 reads the record position (1) recorded in the memory 112 and performs an operation of controlling the position to the record position (1) (rotates the motor rotary shaft 50a in a direction reverse to that for the holding operation) (step 42a) to thereby loosen the chuck claw 42.

The second servomotor 31 is also made servo-on (step 41) and the mesh of the driving gear 35 with the gear 60 is executed (step 42) to thereby obtain a state of (e) of FIG. 2 (in which the step portion of the moving shaft 31d comes into contact with the inner race of the bearing 33).

Incidentally, the gear mesh operation is as described with reference to the flow chart of FIG. 12.

Then, the second servomotor 31 is continuously operated to control the position (step 43). As a result, the step portion of the moving shaft 31d comes into contact with the inner race of the bearing 33 so that the feed screw shaft 31c integrated with the moving shaft 31d is axially immovable but rotatable in the rotation direction. Accordingly, the feed screw nut 31c rotates in this position. Along with this rotation, the driving gear, the driving gear 35 rotates to thereby rotate the connection screw shaft 59 on which the gear 60 driven by the driving gear 35 is provided. Because the connection nut 62 is whirl-stopped by the electromagnetic brake 46, the connection nut 62 is not dragged with the rotation of the connection screw shaft 59 but only the connection screw shaft 59 rotationally moves right in the drawing up to a state of (f) of FIG. 2.

On this occasion, the rotation-to-reciprocation converting means 11 is connected to the connection screw shaft 59 through the bearing 24. The reciprocation-to-rotation converting means 5 is connected to the rotation-to-reciprocation converting means 11 through the first nut 7 and the first screw shaft 6. The reciprocating means 58 is connected to the reciprocation-to-rotation converting means 5 through the bearing 21. Configuration is made so that the first servomotor 50, or the like, of the reciprocating means 58 is axially immovable and so that the third screw shaft 54 is axially immovable if the third nut 53 is not rotated. Therefore, the first servomotor 50 is operated in synchronism with the second servomotor 31 (operated synchronously in a direction in which the third screw shaft 54 can move right in the drawing) (step 43a). Incidentally, on this occasion, the quantity of movement of the moving means 92 calculated on the basis of the data of the detector 31f by the controller 96 is outputted as an instruction from the controller 96 to the controller 105. The first servomotor 50 is operated to control the position in accordance with the instruction.

As a result, the third nut 53 rotates with the operation of the first servomotor 50. The movement of the connection screw shaft 59 can be absorbed between the third nut 53 and the third screw shaft 54. The rotation-to-reciprocation converting means 11, the reciprocation-to-rotation converting means 5 and the third screw shaft 54 of the reciprocating means 58 integrally move right in the drawing by a distance substantially equal to the moving distance of the connection screw shaft 59.

Incidentally, as described above, on this occasion, the connection screw shaft 59 is rotatably supported by the bearing 24 and the first servomotor 50 is operated in synchronism with the second servomotor 31 of the driving means 30 to rotate the third nut 53 so that the movement of the connection screw shaft 59 is absorbed between the third nut 53 and the third screw shaft 54. Hence, the first nut 7 moves axially toward the load side (right in the drawing) without rotation. Along with the movement of the rotation-to-reciprocation converting means 11, the pull rod 23 and the draw bar 91 move axially toward the load side. The axial operation of the pull rod 23 and the draw bar 91 is converted into the radial operation of the chuck claw 42 by the operation converting mechanism 41, so that the work 43 is released from the chuck claw 42.

Also on this occasion, the controller 96 inputs the data detected by the detector 31f. The control arithmetic operation portion 99 calculates the quantity of movement of the moving means 92 on the basis of the input detected data. The calculated value is outputted as an instruction to the controller 105. In the aforementioned relation, the first servomotor 50 operates the leading edge's time later after the second servomotor 31 operates. This delay reduces the quantity of movement of the reciprocating portion of the rotation-to-reciprocation converting means 11 correspondingly to the delay time through the reciprocation-to-rotation converting means 5 and the rotation-to-reciprocation converting means 11. The reduction of the quantity of movement, however, can be ignored in terms of operation because the reduction through the reciprocation-to-rotation converting means 5 or the like is very small and because the delay is recovered when the moving means 92 stops finally.

After a new work 43 is set, the electromagnetic brake 32 is locked and the second servomotor 31 is rotated to return to the state of (a) of FIG. 2. Then, the operation in (b) to (f) of FIG. 2 is repeated.

Tenth Embodiment

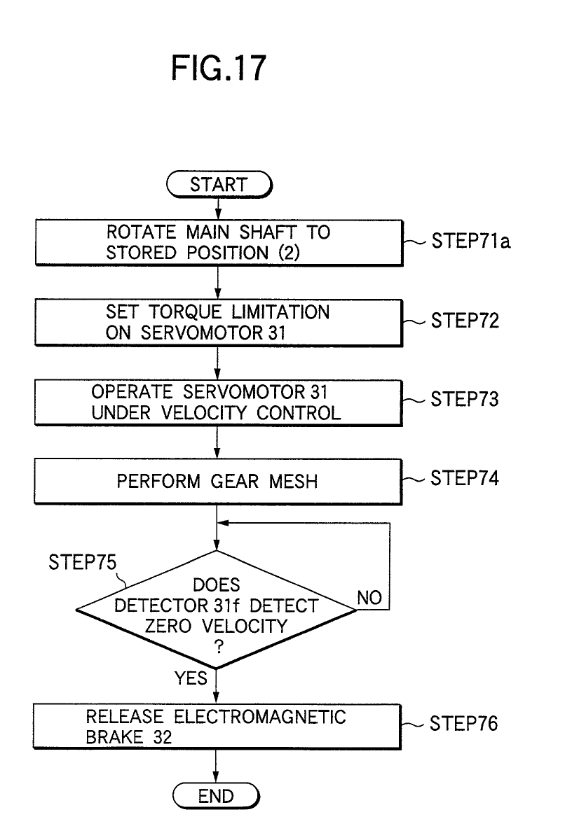

Tenth embodiment for carrying out the present invention will be described below with reference to FIGS. 16 and 17.

Incidentally, this embodiment relates to a controller for operating the thrust converter having the configuration described in Second embodiment (FIGS. 3 and 4). FIG. 16 is a flow chart for explaining the holding operation until the work 43 is held by the chuck claw 42. FIG. 17 is a flow chart for explaining the operation related to the mesh among respective gears.

The thrust converter described in Second embodiment and controlled by the controller in this Eleventh embodiment is equipped with a second driving gear 38 and second driven gears 39 and 40 instead of the electromagnetic brake 46 in First embodiment. The difference in rotational velocity is generated between the first driven gear 36 or 37 and the second driven gear 39 or 40 on the basis of the difference in the number of teeth between the first driving gear 35 and the second driving gear 38 to thereby operate the connection screw shaft 17. Hence, when, for example, the gears separated from each other as shown in (d) of FIG. 4 are to be connected to each other again as shown in (e) of FIG. 4, the connection of the first driving gear 35 to the first driven gear 36 or 37 and the connection of the second driving gear 38 to the second driven gear 39 or 40 cannot be made simultaneously if the respective gears are not located in specific positions respectively. Although it may be therefore conceived that, for such connections, the magnetic sensors as described in Tenth embodiment are used for detecting the positions of teeth of the gears to thereby perform rotational control of the positions of teeth of the gears to connect the gears to one another, considerably complex control is required for simultaneously connecting a large number gears different in the number of teeth.

Therefore, the controller according to this Tenth embodiment is devised to be provided as a controller in which the respective gears can be connected to one another simultaneously by simple control without using any magnetic sensor. Incidentally, the configuration of the controller is equivalent to the configuration described in Ninth embodiment with reference to FIG. 10 except the magnetic sensors 94 and 95 and the A/D converters 101 and 102 for converting the analog signals of the magnetic sensors 94 and 95 into digital signals to input the digital signals into the high-order controller 109 are removed.

The operation of the Tenth embodiment will be described below with reference to FIGS. 16 and 17.

That is, first, the holding operation in which the work 43 is finally held by the chuck claw 42 will be described with reference to the flow chart of FIG. 16 in connection with FIG. 4. Further, the operation related to the mesh of the respective gears will be described with reference to FIG. 17.

Incidentally, the thrust converter is shipped in a state in which the first and second driving gear 35 and 38 mesh with the first and second driven gears 36 and 39 respectively (in a state of (b) of FIG. 4) or in a state in which the first and second driving gears 35 and 38 mesh with the first and second driven gears 37 and 40 respectively (in a state of (f) of FIG. 4). Hence, the thrust converter initially runs from the state of (b) of FIG. 4 or from the state of (f) of FIG. 4. The following description of the operation will be made upon the operation after the initial running.

That is, in FIG. 16 (showing the operation of the second servomotor 31 in the left column and the operation of the first servomotor 20 in the right column), in a state of (a) of FIG. 4 in which the first driving gear 35 does not mesh with the first driven gear 36 and the second driving gear 38 does not mesh with the second driven gear 39, first, the second servomotor 31 and the first servomotor 20 are made servo-on by the controllers 96 and 105 (steps 51a and 51b). Incidentally, on this occasion, the first servomotor 20, the second servomotor 31 and the main shaft motor are in a stop state because no instruction is inputted to the first servomotor 20, the second servomotor 31, and the main shaft motor yet. Then, the gear mesh (step 52a) is executed to make the mesh of the first driving gear 35 with the first driven gear 36 and the mesh of the second driving gear 38 with the second driven gear 39 simultaneously.

Incidentally, the gear mesh (step 52a) is executed as shown in FIG. 17.

That is, in order to perform the mesh of the first driving gear 35 with the first driven gear 36 and the mesh of the second driving gear 38 with the second driven gear 39 simultaneously, it is necessary to return the angles of the first and second driving gears 35 and 38 and the first and second driven gears 36 and 39 to angles in a moment that the gears 35, 38 and 36, 39 are separated from the previous connection state. To prepare the gear mesh in this relation, the main shaft rotational position (2) in the moment that the gears are separated is stored in the memory 117 of the main shaft motor controller 113 (step 58a in FIG. 16). Further, during the separation of the gears, the electromagnetic brake 32 is locked to prevent the first and second driving gears 35 and 38 from rotating (step 59a in FIG. 16).

Hence, the main shaft rotational position (2) which is obtained in the moment that the gears are separated from each other and which is stored in the memory 117 in the step 58a in FIG. 16 is read by the control arithmetic operation portion 116 and the main shaft motor is driven toward the main shaft rotational position (2) by the controller 113 to thereby rotate the first and second driven gears 36, 37 and 39, 40 rotating integrally with the main shaft motor (step 71). As a result, the first driving gear 35, the first driven gear 36 (or 37), the second driving gear 38 and the second driven gear 39 (or 40) are located in positions where the mesh of the first driving gear 35 with the first driven gear 36 (or 37) and the mesh of the second driving gear 38 with the second driven gear 39 (or 40) can be made simultaneously.

Incidentally, the first driven gears 36 and 37 and the second driven gears 39 and 40 rotate in synchronism with the main shaft through the pull rod 23, the second linear guide 14 and the connection means 18. As described in Second embodiment, the first driven gears 36 and 37 and the second driven gears 39 and 40 are not rotated relatively by resistance given from the work 43 because the connection screw 17 is self-locked with negative efficiency. Accordingly, when the rotation angle of the main shaft is adjusted to the angle in the moment when the gears are separated, the teeth of the first and second driven gears 36, 37 and 39, 40 can be rotated to the angles allowed to mesh with first and second driving gears 35 and 38.

Then, a torque limitation of the second servomotor 31 required for pressing the step portion of the moving shaft 31d against the inner race of the bearing 33 is set (step 72). Then, the second servomotor 31 is rotated by velocity control (step 73). On this occasion, the feed screw nut 31c thread-engaged with the feed screw shaft 31b, the moving shafts 31d and 31e and the first and second driving gears 35 and 38 move away from the second servomotor 31 because motion of the nut 31c, the shafts 31d and 31e and the gears 35 and 38 in the rotating direction is stopped by the electromagnetic brake 32. Because the phase of the first driving gear 35 is made coincident with the phase of the first driven gear 36 and the phase of the second driving gear 38 is made coincident with the second driven gear 39 as described above, the step portion of the moving shaft 31d moves to come into contact with the inner race of the bearing 33 while the first driving gear 35 meshes with the first driven gear 36 and the second driving gear 38 meshes with the second driven gear 39 (step 74). Further, the control arithmetic operation portion 99 of the controller 96 monitors whether zero velocity is detected by the detector 31f or not (step 75). When the control arithmetic operation portion 99 confirms that zero velocity is detected by the detector 31f, the control arithmetic operation portion 99 unlocks the electromagnetic brake 32 (step 76) on the basis of the conclusion that the step portion of the moving shaft 31d is in contact with the inner race of the bearing 33. Thus, the simultaneous mesh of the two pairs of gears is terminated. At this point of time, a state of (b) of FIG. 4 is obtained.

Incidentally, a torque limitation is set on the second servomotor 31 in the step 72 to control the torque so that torque higher than required is not generated for the following reason. That is, if operation is made only by the normal position control, there is the possibility that the quantity of movement of the moving shaft 31d may run short or excessively so that the second servomotor 31 operates with the maximum torque, so that it is necessary that the step portion of the moving shaft 31d is pressed against the inner race of the bearing 33 by appropriate pressure as shown in (b) of FIG. 4.

The topic will be returned to the description of the flow chart shown in FIG. 16. After the gear mesh (step 52a) is executed as described above, that is, after the state of (b) of FIG. 4 is obtained, the second servomotor 31 is rotated continuously.

As a result, electromagnetic brake 32 is released so that the moving shaft 31d can move in the rotation direction by the release of the electromagnetic brake 32, and the step portion of the moving shaft 31d comes into contact with the inner race of the bearing 33 so as to be axially immovable. Accordingly, if the second servomotor 31 rotates continuously, the moving shaft 31d, the feed screw nut 31c, or the like, rotate in their positions. Along with this rotation, the first and second driving gears 35 and 38 fixed to the moving shaft 31d rotate to thereby rotate the connection screw shaft 17 and the connection nut 16 on which the first and second driven gears 36 and 39 driven by the first and second driving gears 35 and 38 are provided respectively.

Incidentally, on this occasion, as described above, the first driving gear 35 and the second driving gear 38 are formed to have different numbers of teeth. The numbers of teeth in the first driven gears 36 and 37 and the second driven gears 39 and 40 are set so that the rotational velocity Na of the connection screw shaft 17 rotated by the first driving gear 35 and the rotational velocity Nb of the connection nut 16 rotated by the second driving gear 38 satisfy the relation Na>Nb. In this relation, the connection screw shaft 17 and the connection nut 16 are different from each other in rotational velocity. Hence, the connection screw shaft 17 rotationally moves toward the side reverse to the load side by the differential motion, so that the reciprocation-to-rotation converting means 5 and the rotation-to-reciprocation converting means 11 connected to the connection screw shaft 59 through the bearing 24 are moved to positions just before the chuck claw 42 holds the work 43 (step 53a).

After the reciprocation-to-rotation converting means 5 and the rotation-to-reciprocation converting means 11 are moved to positions just before the chuck claw 42 holds the work 43, a torque limitation is set on the second servomotor 31 (step 54a). An instruction is output from the controller 96 to perform an operation (step 56a) until the chuck claw 42 stops while holding the work 43 under the set pressure by low velocity speed control (step 55a), that is, until the detector 31f detects zero velocity.

Incidentally, because the chuck claw 42 is moved to the position just before the work holding in step 53a, the steps 55a and 56a can be executed in a short time even if the moving velocity is set to be low.

Further, when the work holding performed by the drive of the moving means 92 (the drive of the second servomotor 31) is executed by simple position control, the work size may vary as follows. When, for example, the work size is larger than the designed value, the chuck claw 42 is urged to be operated excessively to thereby impose a high load onto the driving means 30 of the moving means 92. On the contrary, when the work size is smaller, the work is held imperfectly. The variation in the work size, however, can be taken into consideration by the manipulation in the steps 53a to 56a so that the chuck claw 42 can be moved to the work-holding position rapidly.

At the time of the operation in the steps 53a to 56a, the first servomotor 20 is operated to follow the second servomotor 31. On this occasion, the quantity of movement of the moving means 92 calculated on the basis of data of the detector 31f by the controller 96 is inputted as an instruction of the first servomotor 20 to the controller 105 from the controller 96, so that the controller 105 operates to control the position of the first servomotor 20 on the basis of the instruction (step 52b).

Incidentally, the reason why the first servomotor 20 is operated to follow the second servomotor 31 at the time of the operation in the step 53a to 56a is as follows. As described above also in Second embodiment, the rotation-to-reciprocation converting means 11 is connected to the connection screw shaft 17 through the bearing 24. The reciprocation-to-rotation converting means 5 is connected to the rotation-to-reciprocation converting means 11 through the first nut 7 and the first screw shaft 6. The reciprocating means 1 is connected to the reciprocation-to-rotation converting means 5 through the bearing 21. Configuration is made so that the first servomotor 20, or the like, of the reciprocating means 1 is axially immovable and so that the third screw shaft 3 is axially immovable if the third nut 2 is not rotated.

Hence, when the first servomotor 20 is operated to follow the second servomotor 31, the movement of the connection screw shaft 17 can be absorbed between the third nut 2 and the third screw shaft 3. As a result, the rotation-to-reciprocation converting means 11, the reciprocation-to-rotation converting means 5 and the third screw shaft 3 of the reciprocating means 1 integrally move left in the direction by a distance substantially equal to the moving distance of the connection screw shaft 17.

Incidentally, when the first servomotor 20 is driven, the motor rotary shaft 20a is rotated with predetermined torque. The torque rotates the third nut 2 fixed to the motor rotary shaft 20a. Because the third screw shaft 3 thread-engaged with the third nut 2 is whirl-stopped relative to the frame 20b by the linear guide 4, the third screw shaft 3 is not dragged with the third nut 2 but makes reciprocating motion.

On this occasion, the controller 96 inputs the data detected by the detector 31f. The control arithmetic operation portion 99 calculates the quantity of movement of the moving means 92 on the basis of the input detected data. The calculated value is outputted as an instruction to the controller 105. In the aforementioned relation, the first servomotor 20 operates the leading edge's time later after the second servomotor 31 operates. This delay reduces the quantity of movement of the reciprocating portion of the rotation-to-reciprocation converting means 11 correspondingly to the delay time through the reciprocation-to-rotation converting means 5 and the rotation-to-reciprocation converting means 11. The reduction of the quantity of movement, however, may be ignored in terms of operation because the reduction through the reciprocation-to-rotation converting means 5 or the like is very small and because the delay is recovered when the moving means 92 stops finally.

After the operation (118 in the dotted line in FIG. 16) in the second operation mode in which the second servomotor 31 (and the first servomotor 20) is operated to move the rotation-to-reciprocation converting means 11, the reciprocation-to-rotation converting means 5 and the third screw shaft 3 of the reciprocating means 58, the drive of the moving means 92 (the drive of the second servomotor 31) to move the reciprocation-to-rotation converting means 5 and the rotation-to-reciprocation converting means 11 becomes unnecessary. Hence, the torque limitation on the second servomotor 31 is released (step 57a).

Further, the main shaft rotational position (2) on this occasion is acquired from the rotation detector 114 and stored in the memory 117 (step 58a) and the electromagnetic brake 32 is locked (step 59a).

On the other hand, after the detector 31f detects zero velocity in the step 56a, the controller 105 performs an operation (119 in the dotted line frame in FIG. 16) in a so-called first operation mode in which the rotational torque of the first servomotor 20 is converted into predetermined axial thrust force by the rotation-to-reciprocation converting means 11, the reciprocation-to-rotation converting means 5, or the like, on the basis of the instruction given from the high-order controller 109 through the controller 96.

That is, the current position (the position where the chuck claw 42 holds the work 43 under the predetermined pressure by the drive of the second servomotor 31) transmitted to the controller 105 through the controller 96 is recorded as a record position (1) in the memory 112 contained in the controller 105 (step 53b). The required torque limitation is set on the holding force of the chuck claw 42 calculated by the expressions 1 to 4 (step 54b). Then, the first servomotor 20 is operated by a velocity-control operation (step 55b) to thereby generate the holding force set for the chuck claw 42. Incidentally, a torque-control operation may be made in the step 55b. When the detector 20c detects zero velocity (step 56b), the torque limitation on the first servomotor 20 is released (step 57b) and the first servomotor 20 is made servo-on (step 58b).

As a result, the thrust converter gets in a state of (c) of FIG. 4.

On the other hand, as described above, after the work 43 is held by the chuck claw 42 with predetermined torque, the main shaft rotational position (2) (obtained by the detector 114) where the respective gears mesh with each other is stored in the memory 117 through the control arithmetic operation portion 121 (step 58a). The second servomotor 31 is operated (rotated in a direction reverse to that in the holding operation) by position control in the condition that the electromagnetic brake 32 is locked (step 59a) to restrict the moving shaft 31e. With the rotation of the motor rotary shaft 31a, the feed screw shaft 31b also rotates. As a result, the feed screw nut 31c thread-engaged with the feed screw shaft 31b, the moving shaft 31e, or the like, move toward the second servomotor 31.

The first driving gear 35 fixed to the feed screw nut 31c and the second driving gear 38 fixed to the moving shaft 31e also move together from the state of (c) of FIG. 2 to a state of (d) of FIG. 2, that is, to a state in which the first driving gear 35 meshes neither with the first driven gear 36 nor with the first driven gear 37 and the second driving gear 38 meshes neither with the second driven gear 39 nor with the second driven gear 40 (step 60a). When the state of (d) of FIG. 4 is obtained, the second servomotor 31 is made servo-off to be stopped (step 61a).

Incidentally, the reason why the work is worked in the state of (d) of FIG. 4 is to prevent noise from being caused by the gear mesh and to prevent increase in load or the like from being imposed on the main shaft motor because of the unnecessary rotation of the driving gear 35, or the like, for working the work.

As a result, the thrust converter is in the state of (d) of FIG. 2.

Incidentally, the operation of opening the chuck claw 42 is performed in the same manner as that in the flow chart described in Ninth embodiment and shown in FIG. 15. The details of the description of the operation will be omitted.

Eleventh Embodiment

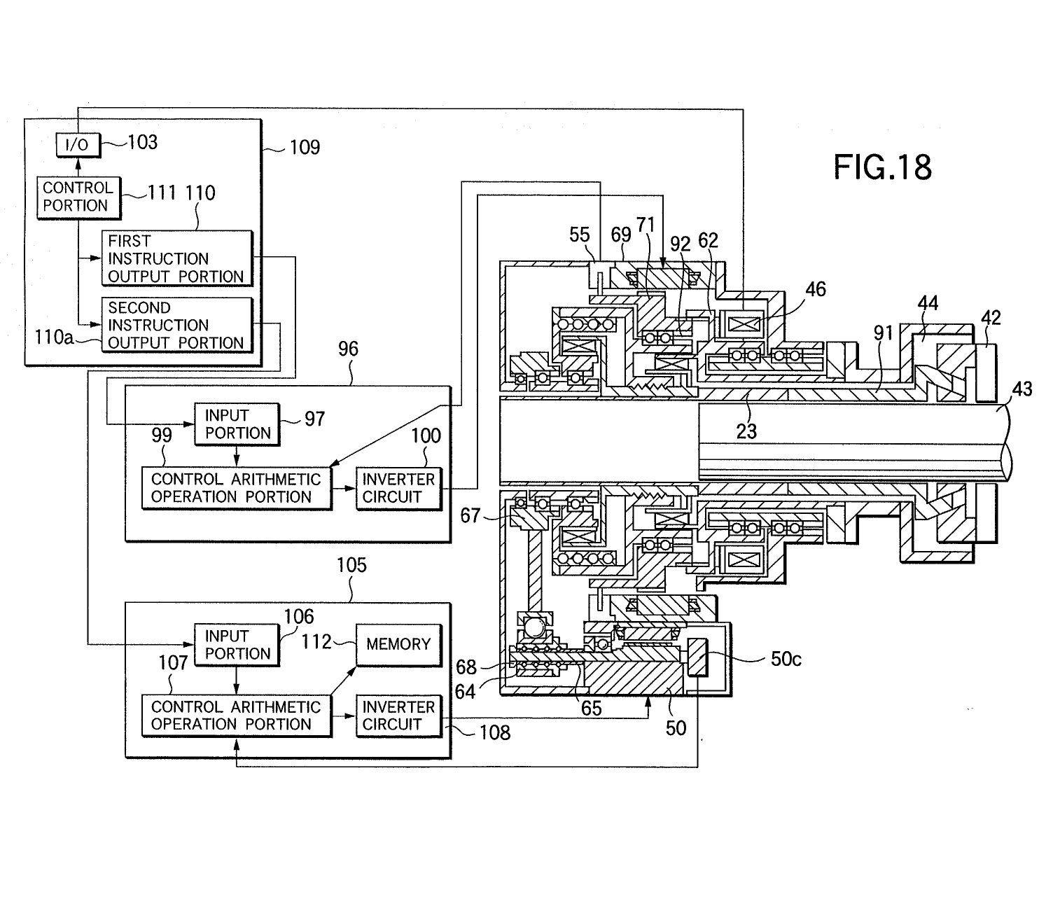

Eleventh embodiment will be described below with reference to FIGS. 18 through 23.

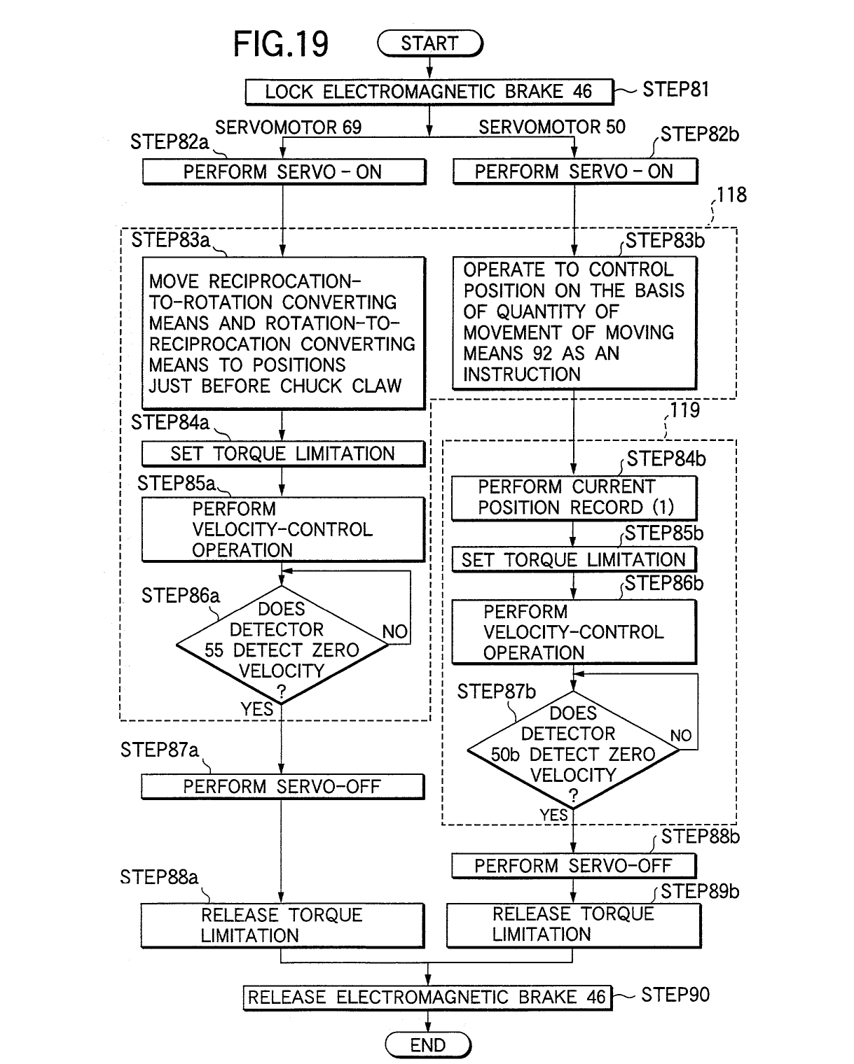

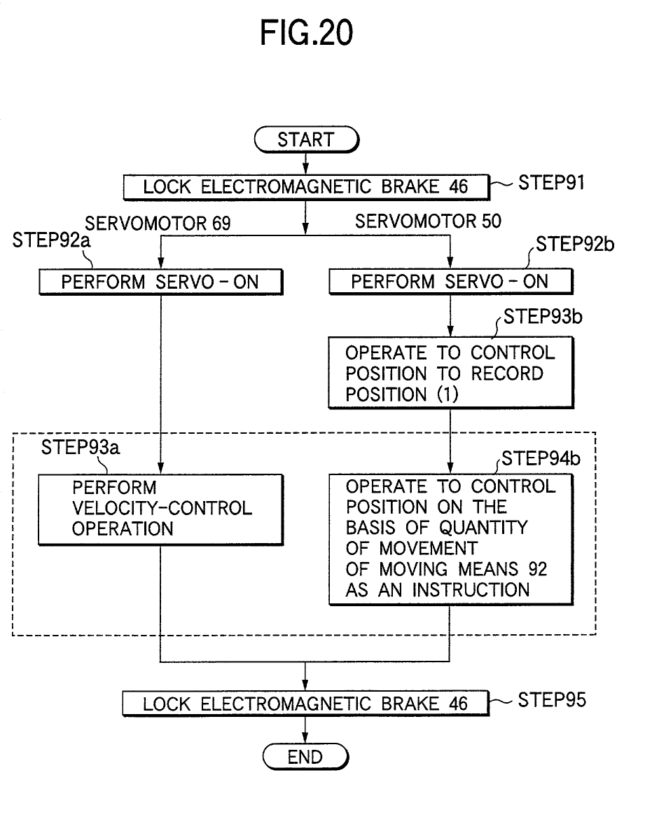

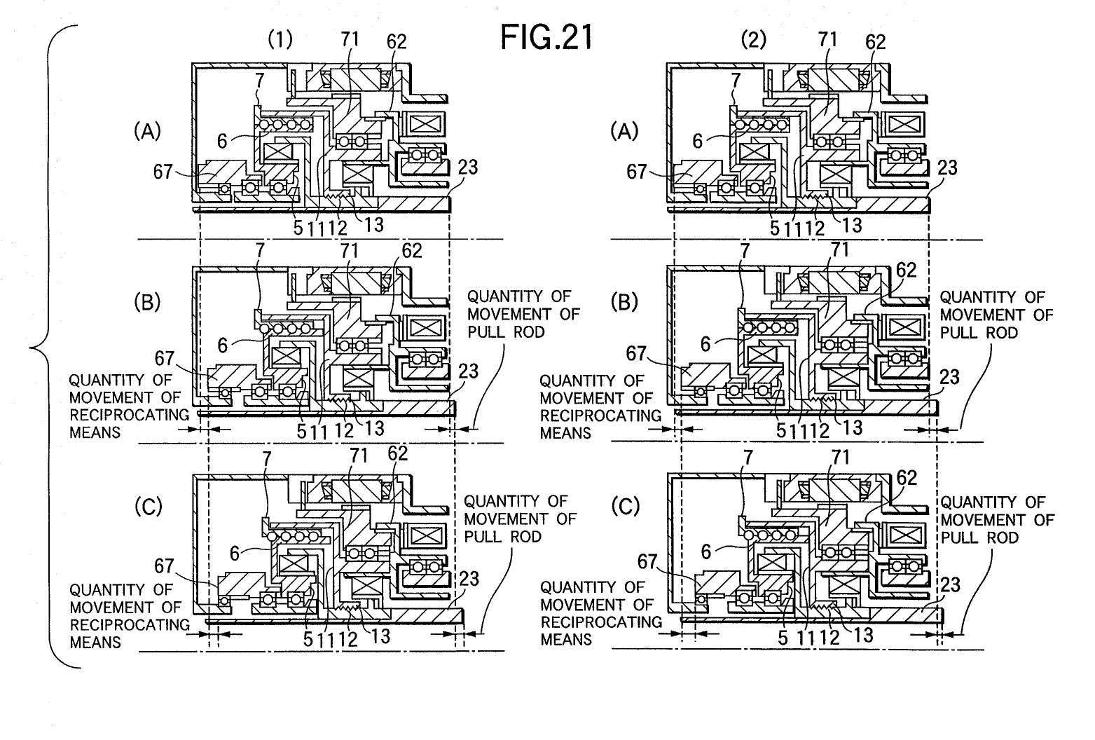

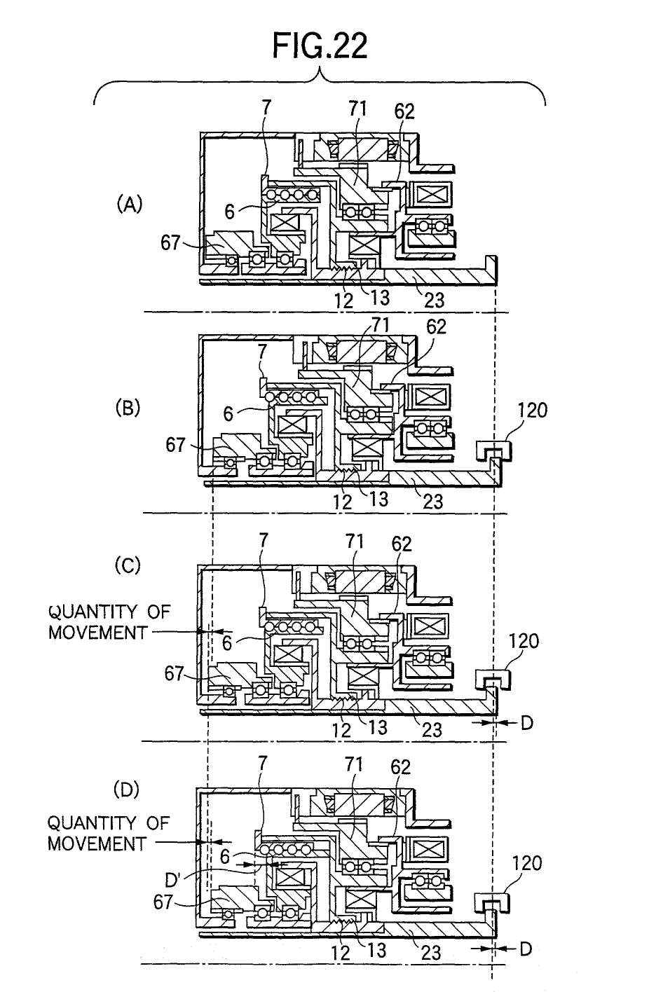

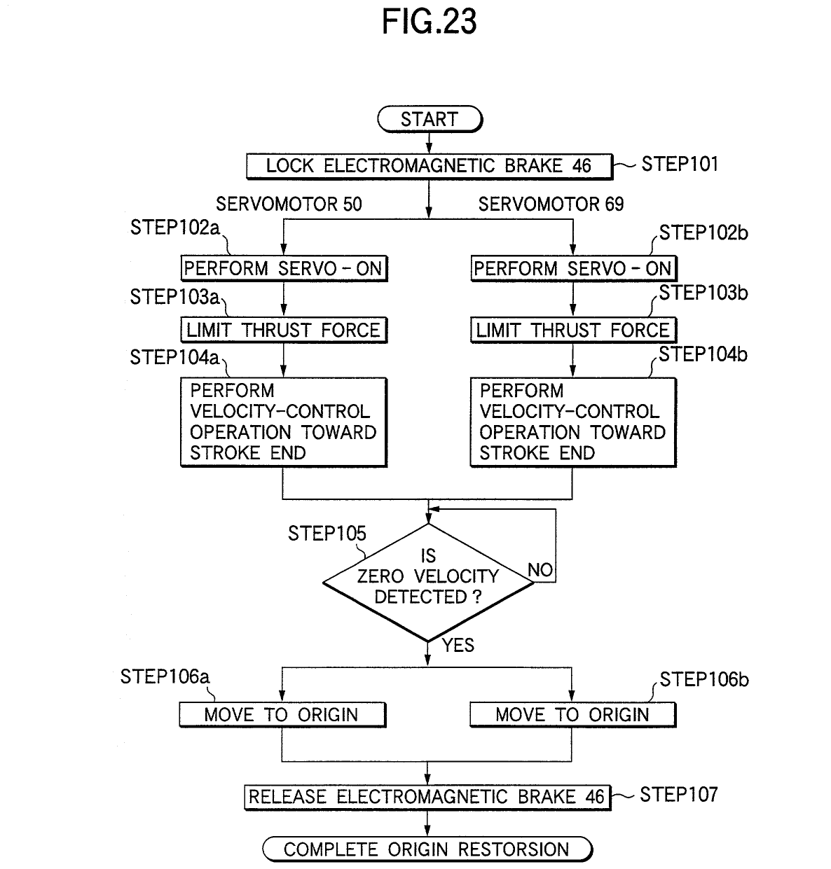

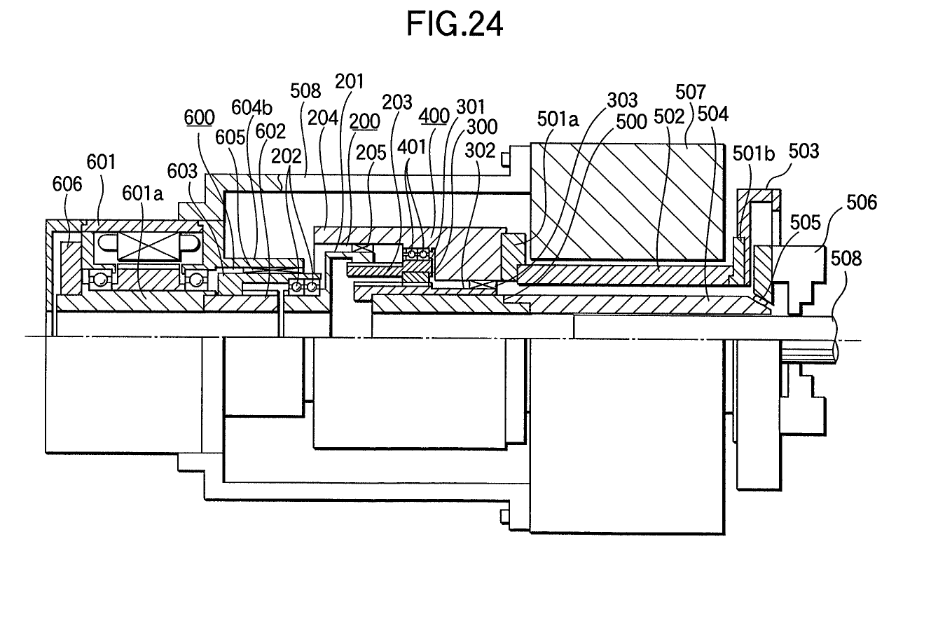

Incidentally, this embodiment relates to a controller for operating the thrust converter having the configuration described in Fifth embodiment (FIG. 7). FIG. 18 is a view showing the configuration of the controller. FIG. 19 is a flow chart for explaining the holding operation in which the work 43 is finally held by the chuck claw 42. FIG. 20 is a flow chart for explaining the operation of releasing the work 43 held by the chuck claw 42. FIG. 21 is a configuration view for explaining the operation of the thrust converter. FIG. 22 is a configuration view for explaining the origin-restoring operation in the case where the thrust converter is applied to a chucking machine for a lathe. FIG. 23 is a flow chart for explaining the origin-restoring operation.

That is, in FIG. 18, the controller 96 of the feed servomotor 69 inputs an instruction outputted from the first instruction output portion 110 of the high-order controller 109 to the control arithmetic operation portion 99 through an input portion 97. The control arithmetic operation portion 99 drives the inverter circuit 100 by feedback control on the basis of the instruction and the quantity of rotation detected by the rotation detector 55 of the feed servomotor 69 to thereby operate the feed servomotor 69.

On the other hand, the controller 105 of the first servomotor 50 inputs an instruction outputted from the second instruction output portion 110a of the high-order controller 109, to the control arithmetic operation portion 107 through the input portion 106. The control arithmetic operation portion 107 drives the inverter circuit 108 by feedback control on the basis of the instruction and the quantity of rotation detected by the rotation detector 50c of the first servomotor 50 to thereby operate the first servomotor 50. The memory 112 of the controller 105 stores the current position when the chuck claw 42 holds the work 43 by the drive of the second servomotor 69.

The high-order controller 109 further controls excitation/non-excitation of the electromagnetic brake 46 through the input/output portion 103.

The operation of the thrust converter in Eleventh embodiment will be described below with reference to FIGS. 19 and 20.

First, the holding operation in which the work 43 is finally held by the chuck claw 42 will be described with reference to the flow chart of FIG. 19.

That is, in FIG. 19 (showing the operation of the feed servomotor 69 in the left column and the operation of the first servomotor 50 in the right column), first the electromagnetic brake 46 is locked by the control portion 111 of the high-order controller 109 (step 81). The feed servomotor 69 and the first servomotor 50 are made servo-on by the controllers 96 and 105 (steps 82a and 82b). Incidentally, on this occasion, the first servomotor 50, the feed servomotor 69 and the main shaft motor are in a stop state because no instruction is inputted thereto yet.

Then, an instruction is inputted from the high-order controller 109 to the controller 96 to drive the feed servomotor 69.

As a result, the connection screw shaft 71 is rotated because the connection nut 62 is restricted by excitation of the electromagnetic brake 46. Because the connection nut 62 is whirl-stopped by the electromagnetic brake 46, the connection nut 62 is not dragged with the rotation of the connection screw shaft 71 but only the connection screw shaft 71 rotates so that the reciprocation-to-rotation converting means 5 and the rotation-to-reciprocation converting means 11 connected to the connection screw shaft 71 through the bearing 24 are moved by position control to positions just before the chuck claw 42 holds the work 43 (step 83a).

After the reciprocation-to-rotation converting means 5 and the rotation-to-reciprocation converting means 11 are moved to positions just before the chuck claw 42 holds the work 43, a torque limitation is set on the feed servomotor 69 (step 84a). An instruction is outputted from the controller 96 to perform an operation (step 86a) until the chuck claw 42 stops while holding the work 43 under the set pressure by low velocity speed control (step 85a), that is, until the detector 55 detects zero velocity.

Incidentally, the require d time for executing the steps 85a and 86a can be short because the chuck claw 42 is moved to the position just before the work holding in the step 83a.

When the work holding perfomed by the drive of the moving means 92 (the drive of the feed servomotor 69) is executed by simple position control, the work size may vary as follows. When, for example, the work size is larger than the designed value, the chuck claw 42 is urged to be operated excessively to thereby impose a high load onto the driving means 30 of the moving means 92. On the contrary, when the work size is smaller, the work is held imperfectly. The variation in the work size, however, can be taken into consideration by the manipulation in the steps 83a to 86a so that the chuck claw 42 can be moved to the work-holding position rapidly.

At the time of the operation in the steps 83a to 86a, the high-order controller 109 outputs an instruction to the controller 105 to operate the first servomotor 50 in synchronism with the feed servomotor 69 to thereby operate the first servomotor 50 to control the position of the first servomotor 50 with the quantity of movement of the moving means 92 as the instruction (step 83b). That is, the high-order controller 109 inputs the data detected by the detector 55 through the input/output portion 103. The quantity of movement of the moving means 92 is calculated by the control portion 111 on the basis of the input detected data. The calculated value is outputted as an instruction to the controller 105 to thereby operate the first servomotor 50 to control the position in accordance with the instruction.

Incidentally, the reason why the first servomotor 50 is operated to follow the feed servomotor 69 at the time of the operation in the step 83a to 86a is as follows. As described above also in Second embodiment or the like, the rotation-to-reciprocation converting means 11 is connected to the connection screw shaft 71 through the bearing 24. The reciprocation-to-rotation converting means 5 is connected to the rotation-to-reciprocation converting means 11 through the first nut 7 and the first screw shaft 6. The reciprocating means 68 is connected to the reciprocation-to-rotation converting means 5 through the bearing 21. Configuration is made so that the first servomotor 50, or the like, of the reciprocating means 68 is axially immovable and so that the third nut 64 connected to the reciprocating portion 67 through the reciprocating thrust transfer plate 66 and the flexible coupling 93 is axially immovable if the third screw shaft 65 is not rotated.

Hence, when the first servomotor 50 is operated to follow the feed servomotor 69, the movement of the connection screw shaft 71 can be absorbed between the third nut 64 and the third screw shaft 65. As a result, the rotation-to-reciprocation converting means 11, the reciprocation-to-rotation converting means 5, the reciprocating portion 67 of the reciprocating means 68, the third nut 64, or the like, integrally move left in the drawing by a distance substantially equal to the moving distance of the connection screw shaft 71.

On this occasion, the high-order controller 109 inputs the data detected by the detector 55 through the input/output portion 103. The control portion 111 calculates the quantity of movement of the moving means 92 on the basis of the input detected data. The calculated value is outputted as an instruction to the controller 105. In the aforementioned relation, the first servomotor 50 is operated with its position controlled in accordance with the instruction. In the relation, the first servomotor 50 operates the leading edge's time later after the feed servomotor 69 operates. This delay reduces the quantity of movement of the reciprocating portion of the rotation-to-reciprocation converting means 11 correspondingly to the delay time through the reciprocation-to-rotation converting means 5 and the rotation-to-reciprocation converting means 11. The reduction of the quantity of movement, however, may be ignored in terms of operation because the reduction through the reciprocation-to-rotation converting means 5 is very small or the like and because the delay is recovered when the moving means 92 stops finally.

After the operation (118 in the dotted line in FIG. 19) in the second operation mode in which the feed servomotor 69 (and the first servomotor 50) is operated to move the rotation-to-reciprocation converting means 11, the reciprocation-to-rotation converting means 5, etc., the drive of the moving means 92 (the drive of the feed servomotor 69) to move the reciprocation-to-rotation converting means 5 and the rotation-to-reciprocation converting means 11 becomes unnecessary. Hence, the feed servomotor 69 is made servo-off (step 87a) and the torque limitation on the feed servomotor 69 is released (step 88a).

On the other hand, as described above, after the operation (second operation eleventh embodiments) in which the first servomotor 50 and the feed servomotor 69 are operated to move the rotation-to-reciprocation converting means 11, the reciprocation-to-rotation converting means 5, the reciprocating portion 67 of the reciprocating means 68, the third nut 64, or the like, that is, after the detector 55 detects zero velocity in the step 86a, the controller 105 performs an operation (119 in the dotted line frame in FIG. 19) in a so-called first operation mode in which the rotational torque of the first servomotor 50 is converted into predetermined axial thrust force by the rotation-to-reciprocation converting means 11, the reciprocation-to-rotation converting means 5, or the like.

That is, the current position (the position where the chuck claw 42 holds the work 43 under the predetermined pressure by the drive of the feed servomotor 69) transmitted to the controller 105 through the high-order controller 109 is recorded as a record position (1) in the memory 112 contained in the controller 105 (step 84b). The required torque limitation is set on the holding force of the chuck claw 42 calculated by the expressions 1 to 4 (step 85b). Then, the first servomotor 50 is operated by a velocity-control operation (step 86b) to thereby generate the holding force set for the chuck claw 42. Incidentally, a torque-control operation may be made in the step 86b. When the detector 50c detects zero velocity (step 87b), the first servomotor 50 is made servo-off (step 88b) and the torque limitation on the first servomotor 50 is released (step 89b). Finally, the electromagnetic brake 46 is unlocked (step 90).

The operation of opening the chuck claw 42 will be described below on the basis of the flow chart of FIG. 20. Incidentally, in FIG. 20, the left column shows the operation of the feed servomotor 69 and the right column shows the operation of the first servomotor 50.

That is, first, after the electromagnetic brake 46 is locked (step 91) to lock the connection nut 62, the first servomotor 50 is made servo-on (step 92b). The control arithmetic operation portion 107 reads the record position (1) stored in the memory 112 and performs an operation of controlling the position to the record position (1) (rotates the motor rotary shaft 50b in a direction reverse to that in the holding) (step 93b) to thereby loosen the chuck claw 42.

The feed servomotor 69 is also made servo-on (step 92a) and operated with its position controlled (step 93a).

As a result, the connection nut 62 is whirl-stopped by the electromagnetic brake 46, so that the connection nut 62 is not dragged with the rotation of the connection screw shaft 71 but only the connection screw shaft 71 rotationally moves right in the drawing.

On this occasion, the rotation-to-reciprocation converting means 11 is connected to the connection screw shaft 71 through the bearing 24. The reciprocation-to-rotation converting means 5 is connected to the rotation-to-reciprocation converting means 11 through the first nut 7 and the first screw shaft 6. The reciprocating means 68 is connected to the reciprocation-to-rotation converting means 5 through the bearing 21. Configuration is made so that the first servomotor 50, or the like, of the reciprocating means 68 is axially immovable and so that the third nut 64 connected to the reciprocating portion 67 through the reciprocating thrust transfer plate 66 and the flexible coupling 93 is axially immovable if the third screw shaft 65 is not rotated. Therefore, the first servomotor 50 is operated in synchronism with the feed servomotor 69 (operated synchronously in a direction in which the third screw shaft 71 can move right in the drawing) (step 94b). That is, the high-order controller 109 inputs the data detected by the detector 55 through the input/output portion 103. The control portion 111 calculates the quantity of movement of the moving means 92 on the basis of the input detected data. The calculated value is outputted as an instruction to the controller 105 to thereby operate the first servomotor 50 with the position controlled in accordance with the instruction.

As a result, the third screw shaft 65 rotates with the operation of the first servomotor 50. The movement of the connection screw shaft 71 can be absorbed between the third nut 64 and the third screw shaft 65. The rotation-to-reciprocation converting means 11, the reciprocation-to-rotation converting means 5 and the reciprocating portion 67, or the like, of the reciprocating means 68 integrally move right in the drawing by a distance substantially equal to the moving distance of the connection screw shaft 71.

Incidentally, as described above, on this occasion, the connection screw shaft 71 is rotatably supported by the bearing 24 and the first servomotor 50 is operated in synchronism with the feed servomotor 69 of the driving means 70 to rotate the third screw shaft 65 so that the movement of the connection screw shaft 71 is absorbed between the third nut 64 and the third screw shaft 65. Hence, the first nut 7 moves (right in the drawing) axially toward the load side without rotation. Along with the movement of the rotation-to-reciprocation converting means 11, the pull rod 23 and the draw bar 91 move axially toward the load side. The axial operation of the pull rod 23 and the draw bar 91 is converted into the radial operation of the chuck claw 42 by the operation converting mechanism 41, so that the work 43 is released from the chuck claw 42.

Also on this occasion, the high-order controller 109 inputs the data detected by the detector 55 through the input/output portion 103. The control portion 111 calculates the quantity of movement of the moving means 92 on the basis of the input detected data. The calculated value is outputted as an instruction to the controller 105 to thereby operate the first servomotor 50 with the position controlled in accordance with the instruction. In the aforementioned relation, the first servomotor 50 operates the leading edge's time later after the feed servomotor 69 operates. This delay reduces the quantity of movement of the reciprocating portion of the rotation-to-reciprocation converting means 11 correspondingly to the delay time through the reciprocation-to-rotation converting means 5 and the rotation-to-reciprocation converting means 11. The reduction of the quantity of movement, however, can be ignored in terms of operation because the reduction through the reciprocation-to-rotation converting means 5 or the like is very small and because the delay is recovered when the moving means 92 stops finally.

Incidentally, the connection nut 62 is locked in the rotating direction with respect to the pull rod 23 by the action of the second linear guide 14, so that the connection nut 62 rotates together with the pull rod 23 driven to rotate by the main shaft motor at the time of working. Hence, as described above, the electromagnetic brake 46 provided for fixing the connection nut 62 at the time of opening/closing the chuck can be used also as a main shaft brake in addition to force for reducing the velocity of the main shaft motor when the rotational velocity of the main shaft is reduced.

The origin restoration in the thrust converter will be described below with reference to FIGS. 21 through 23.

The origin restoration stated here means an operation in which, when the origin disappears, the controllers 96 and 105 generate a state to determine the state of the third screw shaft 65 and the third nut 64, the first screw shaft 6 and the first nut 7, the second screw shaft 12 and the second nut 13 in the thrust converter and the rotational position of the servomotors 50 and 69 uniquely to recognize the position of the origin. Incidentally, in the following description, the output of the thrust converter is expressed in the position of the pull rod 23. As described above, the pull rod 23 is directly connected to the draw bar 91. Also when the pull rod 23 is combined with a chucking machine, the chuck claw 42 has one-to-one correspondence with the draw bar 91 and with the pull rod 23. Hence, the output of the thrust converter can be expressed in the position of the pull rod 23.

FIG. 21 is a view for explaining operations of the respective constituent portions when the thrust converter according to Eleventh embodiment is operated. (1) of FIG. 21 shows the quantity of movement of the pull rod 23 in the case where, after the first servomotor 50 is driven in the first operation mode (the operation mode in which only the first servomotor 50 is driven) from the state of (A), the feed servomotor 69 and the first servomotor 50 are driven in the second operation mode (the operation mode in which both the feed servomotor 69 and the first servomotor 50 are driven so that the first servomotor 50 is driven by the drive of the feed servomotor 69). (2) of FIG. 21 shows the quantity of movement of the pull rod 23 in the case where, after the feed servomotor 69 and the first servomotor 50 are driven in the second operation mode from the state of (A), the first servomotor 50 is driven in the first operation mode. In the drawing, the moving means of the connection screw shaft 71 in (A) of (1) of FIG. 21 and (A) of (2) of FIG. 21 has already moved (left in the drawing) to the limit toward the side reverse to the load side and the reciprocating portion 67 has also already moved toward the side reverse to the load side. Hence, the pull rod 23 is in a state in which the pull rod 23 is pulled in the most.

First, for understanding of items which will be described later, the relation between the quantity of rotation of the servomotor 50 and the position of the pull rod 23 at the time of operation in the first operation mode, the relation among the quantities of rotation of the first and quick-feed servomotors 50 and 69 and the position of the pull rod 23 at the time of operation in the second operation mode, the relation among the quantity θ₅₀ of rotation of the first servomotor 50, the quantity θ₆₉ of rotation of the quick-feed servomotor 69 and the position of the pull rod 23 in the state in which the first operation mode and the second operation mode are mixed, and so on, will be described.

That is, with respect to the relation between the quantity of rotation of the servomotor 50 and the position of the pull rod 23 at the time of operation in the first operation mode, when the servomotor 50 is rotated by θ₅₀ with the state of (A) in (1) of FIG. 21 as a reference, the position of the pull rod 23 with the state of (A) in (1) of FIG. 21 as a reference can be calculated as

$$\frac{{L}_{1} * {L}_{3}}{{L}_{2}} {θ}_{50} ,$$

in which L₁ is the screw lead length of the third screw shaft 65, L₂ is the screw lead length of the first screw shaft 6, and L₃ is the screw lead length of the second screw shaft 12.

The relation among the quantities of rotation of the first servomotor 50 and quick-feed servomotor 69 and the position of the pull rod 23 at the time of operation in the second operation mode is as follows.

That is, in the second operation mode, the quantities of movement of the reciprocating portion 67, the moving means 92 and the pull rod 23 are made coincident with one another. The position of the pull rod 23 is L₄θ₆₉ or L₁θ₅₀ when θ₅₀ is the quantity of rotation of the first servomotor 50, θ₆₉ is the quantity of rotation of the quick-feed servomotor 69, and L₄ is the screw lead length of the connection screw shaft.

The quantity of rotation of the first servomotor 50 is expressed as

$${θ}_{50} = \frac{{L}_{4}}{{L}_{1}} {θ}_{69} .$$

The relation among the quantity θ₅₀ of rotation of the first servomotor 50, the quantity θ₆₉ of rotation of the quick-feed servomotor 69 and the position of the pull rod 23 in the state where the first operation mode and the second operation mode are mixed is as follows.

That is, because all the quantity of rotation of the quick-feed servomotor 69 is made by rotation in the second operation mode, the quantity of movement of the pull rod 23 in the second operation mode is L₄θ₆₉ and the quantity of rotation of the first servomotor is

$$\frac{{L}_{4}}{{L}_{1}} {θ}_{69} .$$

Hence, the quantity of rotation of the first servomotor 50 contributing to the first operation mode is

$${θ}_{50} - \frac{{L}_{4}}{{L}_{1}} {θ}_{69}$$

and the quantity of movement of the pull rod 23 due to the first operation mode is expressed as

$$\frac{{L}_{1} * {L}_{3}}{{L}_{2}} [ {θ}_{50} - \frac{{L}_{4}}{{L}_{1}} {θ}_{69} ] .$$

Because the position of the pull rod 23 is the sum of the quantity of movement in the first operation mode and the quantity of movement in the second operation mode, the position of the pull rod 23 is calculated as follows.

$${L}_{4} {θ}_{69} + \frac{{L}_{1} * {L}_{3}}{{L}_{2}} [ {θ}_{50} - \frac{{L}_{4}}{{L}_{1}} {θ}_{69} ] \qquad ( Expression 6 )$$

The operation in the case where the thrust converter is operated singly will be described below with reference to (1) and (2) of FIG. 21. (A) shows the state in which the connection screw shaft 71 moves the moving means (left in the drawing) to the limit toward the side reverse to the load side, the state in which the reciprocating portion 67 also moves toward the side reverse to the load side and the state in which the pull rod 23 is pulled in the most.

Assume the case where the pull rod 23 is moved toward the load side in the first operation mode from the state of (A) in (1) of FIG. 21. (B) in (1) of FIG. 21 shows the state in which the reciprocating portion 67 is extruded (right in the drawing) to the load side without movement of the connection screw shaft 71 from (A) in (1) of FIG. 21. That is, the reciprocating portion 67 is moved (right in the drawing) by the maximum quantity to the load side in the first operation mode. On this occasion, the reciprocating means 67 pushes the pull rod 23 out by the L2/L3-fold quantity of movement through the reciprocation-to-rotation converting means 5 and the rotation-to-reciprocation converting means 11. Hence, in comparison between (A) of (1) of FIG. 21 and (B) of (1) of FIG. 21 in the lower stage thereof, the quantity of movement of the pull rod 23 becomes small compared with the quantity of movement of the reciprocating means 67. Incidentally, in (B) of (1) of FIG. 21, the first screw shaft 6 abuts on the rotation-to-reciprocation converting means 11 and cannot move any more. The position of the pull rod 23 in (B) of (1) of FIG. 21 can be calculated as

$$\frac{{L}_{1} * {L}_{3}}{{L}_{2}} {θ}_{50 E}$$

in which θ_{50E} is the quantity of rotation in the operating range limit due to a mechanical limitation.

The state in which the pull rod 23 in the state of (B) in (1) of FIG. 21 is moved by the maximum quantity in the second operation mode is the state of (C) in (1) of FIG. 21. The quantity of movement from the state of (B) in (1) of FIG. 21 is L₄θ_{69E} when θ_{69E} is the quantity of rotation of the quick-feed servomotor 69. The quantity of rotation of the first servomotor 50 can be calculated as

$${θ}_{50 E} + \frac{{L}_{4}}{{L}_{1}} {θ}_{69 E}$$

using θ_{50E} described above.

Incidentally, in (C) of (1) of FIG. 21, the rotation-to-reciprocation converting means 11 abuts on the connection nut 62 to thereby limit the movement in the direction of the load side.

Assume the case where the pull rod 23 is moved toward the load side in the second operation mode from (A) of (2) of FIG. 21. (B) in (2) of FIG. 21 shows the state in which the connection screw shaft 71 in (A) of (2) of FIG. 21 is pushed out to the load side and the reciprocating portion 67 is operated to follow the connection screw shaft 71. In this state, the first screw shaft 6 and the second screw shaft 12 are not operated. That is, the reciprocating portion 67 is moved to an operating range limit due to a mechanical limitation in the direction of the load side (right in the drawing) in the second operation mode. The pull rod 23 is pushed out by the quantity of movement of the connection screw shaft 71 compared with the state of (A) in (2) of FIG. 21. In the drawing, the quantity of movement of the reciprocating portion reaches the limit. When the quantity of rotation of the quick-feed servomotor 69 on this occasion is θ_{69E}, the position of the pull rod 23 from (A) of (2) of FIG. 21 can be calculated as L₄θ_{69E}. Incidentally, the first servomotor 50 is also operated synchronously and the quantity of rotation of the first servomotor 50 can be calculated as

$${θ}_{50} = \frac{{L}_{4} {θ}_{69 E}}{{L}_{1}} .$$

The state in which the pull rod 23 is moved by the maximum quantity in the first operation mode from the aforementioned state is the right column in (C) of (2) of FIG. 21. The connection screw shaft 71 is not moved from (B) of (2) of FIG. 21 and the reciprocating portion 67 is pushed out to the load side (right in the drawing). On this occasion, the pull rod 23 is pushed out by the L2/L3-fold quantity of movement through the reciprocation-to-rotation converting means 5 and the rotation-to-reciprocation converting means 11. On this occasion, the servomotors 50 and 69 push the pull rod 23 out to the limit toward the load side (right in the drawing). With (A) of (2) of FIG. 21 as a reference, the quantity of movement of the pull rod 23 can be calculated as follows:

$$( Quantity of movement D ) = {L}_{2} {θ}_{69 E} + \frac{{L}_{1} {L}_{3}}{{L}_{2}} * ( {θ}_{50 E} - \frac{{L}_{4} {θ}_{69 E}}{{L}_{1}} )$$

in which θ_{69E} is the quantity of rotation of the quick-feed servomotor 69, and θ_{50E} is the quantity of rotation of the first servomotor 50.

Incidentally, in the equation, the first term shows the quantity of movement in the second operation mode, and the second term shows the quantity of movement in the first operation mode.

Although (1) and (2) of FIG. 21 show different states in which the pull rod 23 is moved, one state is finally obtained in (C) of (1) of FIG. 21 and (C) of (2) of FIG. 21. In any case of (A) to (C) in (1) of FIG. 21 and (A) to (C) in (2) of FIG. 21, the quantities of rotation of the servomotors 50 and 69 from (A) as a reference are known. Hence, when the thrust converter operates singly, the quantities of rotation of the motors from a reference position can be determined at the time of arrival at the operating range limit due to the mechanical limitation if the servomotors 50 and 69 are operated up to the operating range limit due to the mechanical limitation.

That is, the origin restoration is completed if the first operation mode and the second operation mode are one by one operated up to the operating limit. In the case where a position displaced from the reference position is taken as the origin, the origin restoration is completed if the first operation mode and the second operation mode are one by one operated up to the operating limit and then the quantity of displacement is moved.

On the other hand, if the case where the thrust converter is mounted on a machine is considered, the operating range of the pull rod 23 is reduced compared with the case where the thrust converter is operated singly.

FIG. 22 shows a state in which the thrust converter is mounted on a machine and the stroke is limited. Incidentally, the reference numeral 120 designates as a model a stopper for limiting the operation of the pull rod 23 of the thrust converter. When the thrust converter is applied to chucking, the stopper 120 is equivalent to the operating restriction of the chuck claw (that is, the output of the thrust converter) due to the work holding. (A) of FIG. 22 shows a state in which the pull rod 23 is pulled in the single thrust converter, that is, the same state as (A) in (1) of FIG. 22 or (A) in (2) of FIG. 22. Description will be made with this position as a reference. (B) of FIG. 22 shows a state of a machine before the origin restoration. (C) of FIG. 22 shows a state in which the pull rod 23 is moved (left in the drawing) toward the side reverse to the load side in the second operation mode from the state of (B) of FIG. 22 so as to collide with the stopper 120 of the machine. Because the position of the pull rod 23 (D in FIG. 22) in (C) of FIG. 22 with (A) of FIG. 22 as a reference is determined by the relative positional relation between the machine and the thrust converter and is not changed, the position of the pull rod 23 in (C) of FIG. 22 can be determined even in the case where the position of the origin disappears. Because two servomotors are used, in the thrust converter, however, the internal state of the thrust converter, that is, the state of the first screw shaft 6, the second screw shaft 12 and the reciprocating portion 67 cannot be determined uniquely. For example, in the example of (C) of FIG. 22, the quantity of movement of the pull rod 23 is a known value of D but the relation among the pull rod 23 and the quantities of rotation of the servomotors 50 and 69 can be calculated as follows.

$$( Quantity of movement D ) = {L}_{2} {θ}_{69} + \frac{{L}_{1} {L}_{3}}{{L}_{2}} * ( {θ}_{50} - \frac{{L}_{4} {θ}_{69}}{{L}_{1}} )$$

In the aforementioned expression, θ₅₀ and θ₆₉ cannot be determined uniquely even in the case where the pull rod 23 is stopped in the mechanically locked position and the position of the pull rod 23 is known because both the servomotors 50 and 69 may not rotate up to the operating range limit positions in the single thrust converter.

Therefore, while the pull rod 23 is pushed out (right in the drawing) toward the load side in the first operation mode, the pull rod 23 is pulled in (left in the drawing) toward the side reverse to the load side in the second operation mode in the reverse direction. Because the moving velocity of the pull rod 23 in the second operation mode is higher than that in the first operation mode, the state of (C) of FIG. 22 may be obtained temporarily. Because the pull rod 23 is pushed out toward the load side in the first operation mode, the movement in the second operation mode can be continued by the quantity of movement in the first operation mode. Finally, the state of (D) of FIG. 22 is obtained. (D) of FIG. 22 shows the state in which the second screw shaft in the first operation mode reaches the operating range limit due to the mechanical limitation and the pull rod 23 is locked by the stopper of the machine. That is, calculation can be made as follows.

$$\{ \begin{matrix}D = {L}_{2} {θ}_{69} + \frac{{L}_{1} {L}_{3}}{{L}_{2}} * ( {θ}_{50} - \frac{{L}_{4} {θ}_{69}}{{L}_{1}} ) \\ {D}^{′} = {L}_{3} * ( {θ}_{50} - \frac{{L}_{4} {θ}_{69}}{{L}_{1}} )\end{matrix} \qquad ( Expression 7 )$$

Incidentally, because L₁, L₂, L₃, L₄, D and D′ in the aforementioned expression are known, an equation for calculating the position of the pull rod 23 and the quantities of rotation of the servomotors 50 and 69 with (A) of FIG. 22 as a reference can be obtained.

Assume that θ₅₀ is the angle of rotation of the servomotor 50 and θ₆₉ is the angle of rotation of the servomotor 69, the origin restoration from the position of the origin in (A) of FIG. 22 is completed if the servomotor 50 is rotated by θ₅₀-θ₅₀ and the servomotor 69 is rotated by θ₆₉-θ_{69E} using θ₅₀ and θ_{69E} calculated by the expression 6 from the state of (D) of FIG. 22.

A flow chart when the origin restoration is performed by the aforementioned method is shown in FIG. 23. Incidentally, in FIG. 23, the left column shows the operation of the servomotor 50 and the right column shows the operation of the quick-feed servomotor 69.

First, the electromagnetic brake 4 6 is locked (step 101). The servomotors 50 and 69 are made servo-on (steps 102a and 102b). Torque limitations are set on the servomotors 50 and 69 (steps 103a and 103b). A low velocity speed control operation is performed (steps 104a and 104b). Incidentally, the velocity setting is performed so that the sign of the value of time differentiation of the first term in the expression 6 is reverse to the sign of the value of time differentiation of the second term in the expression 6. This means that the direction of movement of the pull rod 23 in the first operation mode is reverse to the direction of movement of the pull rod 23 in the second operation mode. After both the rotation detectors 50c and 55 of the servomotors 50 and 69 detect zero velocity (step 105) so that the positions of the servomotors 50 and 69 are determined, the servomotors 50 and 69 are moved to the origin (steps 106a and 106b) and finally the electromagnetic brake 46 is unlocked (step 107).

As described above, the present invention has a configured to have: a reciprocating means; a reciprocation-to-rotation converting means for converting a reciprocating motion of the reciprocating means into a rotary motion; a rotation-to-reciprocation converting means located on the same axial line as that of the reciprocation-to-rotation converting means for converting the rotary motion of the reciprocation-to-rotation converting means into a reciprocating motion; a reaction force receiving means for receiving reaction force against the reciprocating motion of the rotation-to-reciprocation converting means; and a moving means for moving the reciprocation-to-rotation converting means and the rotation-to-reciprocation converting means in an axial direction separately from driving force due to the reciprocating motion of the reciprocating means. Accordingly, the reciprocation-to-rotation converting means and the rotation-to-reciprocation converting means can be moved to any positions without rotation at all or almost without rotation, that is, the thrust force given to the reciprocating means can be made to act on the load side without amplification/reduction at all or almost without amplification/reduction.

Hence, after the reciprocation-to-rotation converting means and the rotation-to-reciprocation converting means are moved to any positions, the thrust force given to the reciprocating means can be amplified/reduced to act on the load side. Hence, there can be obtained a thrust converter in which the length of the thrust conversion portion can be shortened relative to the rate of the necessary stroke.

Further, the present invention has a configuration such that, when the reciprocation-to-rotation converting means and the rotation-to-reciprocation converting means are moved by the moving means, a quantity of the movement is absorbed by a part of the reciprocating means. Accordingly, it is unnecessary to move the reciprocating means together when the reciprocation-to-rotation converting means and the rotation-to-reciprocation converting means are moved. Hence, in addition to the aforementioned effect, the configuration that the reciprocating means is moved together with the reciprocation-to-rotation converting means and the rotation-to-reciprocation converting means is not required so that the configuration of the thrust converter in this portion is not complicated.

Further, according to the present invention, the moving means includes: a connection means having a first screw, and a second screw thread-engaged with the first screw; and a driving means for driving rotation of at least one screw of the connection means to thereby move the reciprocation-to-rotation converting means and the rotation-to-reciprocation converting means. Accordingly, the reciprocation-to-rotation converting means and the rotation-to-reciprocation converting means can be moved to any positions easily by a simple means of rotating screws. Moreover, working can be made easily and inexpensively. Moreover, because the lead of each screw can be determined freely, the efficiency can be set to be negative. Accordingly, the screw can receive reaction force continuously without loosening the screw even in the case where the reaction force is added.

Further, according to the present invention, the moving means includes: a connection means having a first screw, and a second screw thread-engaged with the first screw; a driving means for driving rotation of both screws of the connection means to thereby move the reciprocation-to-rotation converting means and the rotation-to-reciprocation converting means; and a rotation transferring means constituted by gears and interposed between the driving means and the connection means for transferring the driving force of the driving means so that the first and second screws of the connection means rotate at different rotational velocities. Accordingly, the reciprocation-to-rotation converting means and the rotation-to-reciprocation converting means can be moved to any positions easily by a simple means of rotating screws. Moreover, because the lead of each screw can be determined freely, the efficiency can be set to be negative. Accordingly, the screw can receive reaction force continuously without loosening the screw even in the case where the reaction force is added.

Further, the driving force of the driving means can be transferred to the connection means simply and easily. Moreover, the transfer can be disconnected simply, and the relative rotation velocity between the first and second screws can be set to be a desired rotation velocity easily by simply changing the numbers of teeth.

Further, according to the present invention, the moving means includes: a connection means having a first screw, and a second screw thread-engaged with the first screw; a driving means for driving rotation of at least one screw of the connection means to thereby move the reciprocation-to-rotation converting means and the rotation-to-reciprocation converting means; and a transfer/disconnection means interposed between the driving means and the connection means for transferring the driving force of the driving means to the coupling means and disconnecting the transfer. Accordingly, the reciprocation-to-rotation converting means and the rotation-to-reciprocation converting means can be moved to any positions easily by a simple means of rotating screws. Moreover, because the lead of each screw can be determined freely, the efficiency can be set to be negative. Accordingly, the screw can receive reaction force continuously without loosening the screw even in the case where the reaction force is added.

Further, the driving force of the driving means can be transferred to the connection means simply and easily. Moreover, the transfer can be disconnected easily. Hence, when, for example, the thrust converter is applied to a chucking machine, it is unnecessary to transfer the rotation of the main shaft to the driving means at the time of working. Accordingly, increase in the rotational velocity of the main shaft, elongation in the life of the driving means, and so on, can be attained.

Further, according to the present invention, the moving means includes: a motor having a feed screw on its rotary shaft; a moving shaft thread-engaged with a feed screw portion of the rotary shaft so that the moving shaft moves axially with the rotation of the rotary shaft and stops in a predetermined position to rotate; a first driving gear provided on the moving shaft; a second driving gear provided on the moving shaft at a predetermined distance from the first driving gear; a connection means having a first screw, and a second screw thread-engaged with the first screw; a first driven gear provided on the first screw of the connection means so as to mesh with the first driving gear; and a second driven gear provided on the second screw of the connection means so as to mesh with the second driving gear and having teeth different in number from those of the first driven gear, wherein: the motor is driven to move the moving shaft to a position where the first and second driving gears and the first and second driven gears mesh with each other simultaneously; the moving shaft is stopped in this position and driven to rotate to thereby drive the first and second screws of the connection means to rotate by differential motion through the first and second driving gears and the first and second driven gears to move the reciprocation-to-rotation converting means and the rotation-to-reciprocation converting means to predetermined positions; and when the reciprocation-to-rotation converting means and the rotation-to-reciprocation converting means are moved to the predetermined positions, the moving shaft is moved to a position where the first and second driving gears do not mesh with the first and second driven gears respectively. Accordingly, the reciprocation-to-rotation converting means and the rotation-to-reciprocation converting means can be moved to any positions easily by a simple means of rotating screws. Moreover, because the lead of each screw can be determined freely, the efficiency can be set to be negative. Accordingly, the screw can receive reaction force continuously without loosening the screw even in the case where the reaction force is added.

Further, the first and second screws can be driven by use of one driving means, so that an inexpensive thrust converter can be obtained.

Further, because of gear connection, the gear position can be changed to a neutral position easily. Hence, even in the case where a load is applied onto the driven gear, the load is not applied onto the motor so that reliability is improved.

Further, according to the present invention, the moving means includes: a motor having a feed screw on its rotary shaft; a moving shaft thread-engaged with a feed screw portion of the rotary shaft so that the moving shaft moves axially with rotation of the rotary shaft and stops in a predetermined position to rotate; a driving gear provided on the moving shaft; a connection means having a first screw, and a second screw thread-engaged with the first screw; a driven gear provided on the first screw of the connection means so as to mesh with the driving gear; and a whirl-stop means for whirl-stopping the second screw of the connection means at a desired time, wherein: the motor is driven to move the moving shaft to a position where the driving gear and the driven gear mesh with each other; the moving shaft is stopped in this position and driven to rotate while the second screw is whirl-stopped by the whirl-stop means to thereby drive the first screw of the connection means to rotate through the driving gear and the driven gear to move the reciprocation-to-rotation converting means and the rotation-to-reciprocation converting means to predetermined positions; and when the reciprocation-to-rotation converting means and the rotation-to-reciprocation converting means are moved to the predetermined positions, the moving shaft is moved to a position where the driving gear does not mesh with the driven gear. Accordingly, the reciprocation-to-rotation converting means and the rotation-to-reciprocation converting means can be moved to any positions easily by a simple means of rotating screws. Moreover, because the lead of each screw can be determined freely, the efficiency can be set to be negative. Accordingly, the screw can receive reaction force continuously without loosening the screw even in the case where the reaction force is added.

Further, because drive of the first screw is sufficient for the structure, the structure is simple.

Further, because of gear connection, the gear position can be changed to a neutral position easily. Hence, even in the case where a load is imposed on the driven gear, the load is not imposed on the motor. Moreover, because the gear connection is provided in only one place, reliability is improved.

Further, according to the present invention, the moving means includes: a connection means having a first screw, and a second screw thread-engaged with the first screw; a motor using the first screw of the connection means as a rotor; and a whirl-stop means for whirl-stopping the second screw of the connection means at a desired time, wherein, in a condition that the second screw of the connection means is whirl-stopped by the whirl-stop means, the motor is driven to drive the first screw of the connection means to rotate to thereby move the reciprocation-to-rotation converting means and the rotation-to-reciprocation converting means to predetermined positions. Accordingly, the reciprocation-to-rotation converting means and the rotation-to-reciprocation converting means can be moved to any positions easily by a simple means of rotating screws. Moreover, because the lead of each screw can be determined freely, the efficiency can be set to be negative. Accordingly, the screw can receive reaction force continuously without loosening the screw even in the case where the reaction force is added.

Further, because the first screw is used as a rotor of the motor which is a driving means, the number of parts can be reduced. Hence, reliability is improved more greatly and assembling time is reduced, so that the cost can be reduced.

Further, because the first screw is driven so contactlessly that there is no portion worn out, the life of the moving means is made long.

Further, according to the present invention, the moving means includes: a connection means having a first screw, and a second screw thread-engaged with the first screw; a first motor using the first screw of the connection means as a rotor; and a second motor using the second screw of the connection means as a rotor, wherein, in a condition that the second screw of the connection means is whirl-stopped by excitation of the second motor, the first motor is driven to drive the first screw of the connection means to rotate to thereby move the reciprocation-to-rotation converting means and the rotation-to-reciprocation converting means to predetermined positions. Accordingly, the reciprocation-to-rotation converting means and the rotation-to-reciprocation converting means can be moved to any positions easily by a simple means of rotating screws. Moreover, because the lead of each screw can be determined freely, the efficiency can be set to be negative. Accordingly, the screw can receive reaction force continuously without loosening the screw even in the case where the reaction force is added. Because the rotation of the second screw is locked by servo-locking contactlessly, there is no abrading dust generated. Hence, reliability is improved. Moreover, because the first screw is driven so contactlessly that there is no portion worn out, the life of the moving means is made long.

Further, according to the present invention, the moving means includes: a connection means having a first screw, and a second screw thread-engaged with the first screw; and a motor using the first screw of the connection means as a first rotor and using the second screw of the connection means as a second rotor, the first rotor being different in number of poles from the second rotor, wherein the motor is driven to drive the first and second screws of the connection means to rotate to thereby move the reciprocation-to-rotation converting means and the rotation-to-reciprocation converting means to predetermined positions. Accordingly, the reciprocation-to-rotation converting means and the rotation-to-reciprocation converting means can be moved to any positions easily by a simple means of rotating screws. Moreover, because the lead of each screw can be determined freely, the efficiency can be set to be negative. Accordingly, the screw can receive reaction force continuously without loosening the screw even in the case where the reaction force is added.

Further, the electromagnetic brake or another motor for locking the second screw is not required, so that the cost can be reduced more greatly. Because the electromagnetic brake need not be used, there is no abrading dust generated. Hence, reliability is improved. Moreover, because the first screw is driven so contactlessly that there is no portion worn out, the life of the moving means is made long.

Further, according to the present invention, the reciprocating means includes: a motor; and a motor rotation-to-reciprocation converting means for converting a rotary motion of the rotary shaft of the motor into a reciprocating motion. Maintenance is not required so that the running cost can be reduced compared with the case where hydraulic or pneumatic equipment is used as the reciprocating portion.

Further, the thrust force outputted at the load-side end can be controlled steplessly and easily, so that a good-response thrust converter can be obtained.

Further, according to the present invention, the reciprocating means includes: a motor disposed on an axis different from the axial line of the reciprocation-to-rotation converting means; a motor rotation-to-reciprocation converting means disposed on the same axis as the axial line of the reciprocation-to-rotation converting means for converting a rotary motion of the rotary shaft of the motor into a reciprocating motion; and a motor rotation transferring means for transferring the rotation driving force of the motor to the motor rotation-to-reciprocation converting means. Maintenance is not required so that the running cost can be reduced compared with the case where hydraulic or pneumatic equipment is used as the reciprocating portion. Further, the thrust force outputted at the load-side end can be controlled steplessly and easily, so that a good-response thrust converter can be obtained. Moreover, the whole length of the thrust converter can be shortened more.

Further, according to the present invention, the reciprocating means includes: a motor disposed on an axis different from the axial line of the reciprocation-to-rotation converting means; a motor rotation-to-reciprocation converting means disposed on an axis the same as an axial line of a rotary axis of the motor for converting a rotary motion of the rotary shaft of the motor into a reciprocating motion; and a thrust transferring means for transferring an axial thrust force of the motor rotation-to-reciprocation converting means to the reciprocation-to-rotation converting means. Maintenance is not required so that the running cost can be reduced compared with the case where hydraulic or pneumatic equipment is used as the reciprocating portion. Further, the thrust force outputted at the load-side end can be controlled steplessly and easily, so that a good-response thrust converter can be obtained. Moreover, the whole length of the thrust converter can be shortened more.

Further, according to the present invention, the motor rotation-to-reciprocation converting means has a screw provided on the rotary shaft of the motor, and a nut thread-engaged with the screw, and the thrust transferring means has a reciprocating portion for supporting a bearing for rotatably bearing the reciprocation-to-rotation converting means, and a thrust transfer plate for connecting the reciprocating portion and the nut to each other. Maintenance is not required so that the running cost can be reduced compared with the case where hydraulic or pneumatic equipment is used as the reciprocating portion. Further, the thrust force outputted at the load-side end can be controlled steplessly and easily, so that a good-response thrust converter can be obtained. Moreover, the whole length of the thrust converter can be shortened more.

Further, according to the present invention, the thrust transfer plate is connected to the nut through a flexible coupling. Complication between different axes can be avoided so that the nut, or the like, can be moved smoothly.

Further, the thrust transfer plate's own weight or the reciprocation-to-rotation converting means' own weight can be supported by the flexible coupling so that the weight's force can be prevented from being applied onto the nut. Hence, the life of the nut and the life of the screw shaft are improved, so that reliability is improved.

Further, according to the present invention, one screw of the connection means is rotatably supported with respect to the reciprocation-to-rotation converting means. Accordingly, the reciprocation-to-rotation converting means can only make reciprocating motion without rotation even in the case where the driving means rotates the connection means. Further, the driving means need not rotate the reciprocation-to-rotation converting means, so that the load is light. Hence, the driving means can be constituted by a driving means of small driving force.

Further, according to the present invention, one screw of the connection means is rotatably supported with respect to the reciprocation-to-rotation converting means; and the other screw of the connection means is rotatably supported with respect to a part of the reaction force receiving means. Accordingly, the reciprocation-to-rotation converting means can only make reciprocating motion without rotation even in the case where the driving means rotates the connection means. Further, the driving means need not rotate the reciprocation-to-rotation converting means, so that the load is light. Hence, the driving means can be constituted by a driving means of small driving force.

Further, in the case where the thrust converter of the type of locking the second screw contactlessly as shown in FIG. 8 or 9 is used in a chucking machine for a lathe, even if the main shaft of the lathe is rotating, the moving means can be operated to move the reciprocation-to-rotation converting means and the rotation-to-reciprocation converting means to thereby open the chuck. Hence, the exchange of the work, the feeding of the bar material, and so on, can be performed easily without stopping of the main shaft of the lathe.

According to the present invention, the whirl-stop means is constituted by an electromagnetic brake, and a part of the whirl-stopped screw of the connection means is provided as a brake disk. Accordingly, the number of parts is reduced, so that the cost is reduced.

Further, according to the present invention, the whirl-stop means is constituted by an electromagnetic brake, and the second screw prohibited from rotating by the electromagnetic brake is connected to an external driving means. Accordingly, when the external driving means such as the main shaft motor or the like is to be reduced in velocity or stopped, the external driving means such as the main shaft motor or the like can be reduced in velocity or stopped rapidly because the second screw is locked in the rotating direction by the electromagnetic brake.

Further, according to the present invention, control is performed by the steps of: driving the moving means to move the reciprocation-to-rotation converting means and the rotation-to-reciprocation converting means to predetermined positions; and driving the reciprocating means after the arrival of the reciprocation-to-rotation converting means and the rotation-to-reciprocation converting means at the predetermined positions to thereby operate the reciprocating portion of the rotation-to-reciprocation converting means through the reciprocation-to-rotation converting means and the rotation-to-reciprocation converting means. Accordingly, the reciprocation-to-rotation converting means and the rotation-to-reciprocation converting means can be moved to predetermined positions rapidly. Moreover, after the reciprocation-to-rotation converting means and the rotation-to-reciprocation converting means are moved to the predetermined positions, any thrust force can be generated in the output portion of the rotation-to-reciprocation converting means. Hence, the operation for generating any thrust force in the output portion of the rotation-to-reciprocation converting means in the predetermined position becomes rapid.

Further, according to the present invention, control is carried out by the steps of: performing an operation in a first operation mode in which, in a condition that the moving means is stopped, the reciprocating means is driven to operate the reciprocating portion of the rotation-to-reciprocation converting means through a reciprocation-rotation means and the rotation-to-reciprocation converting means; performing an operation in a second operation mode in which the moving means is driven to move the reciprocation-to-rotation converting means and the rotation-to-reciprocation converting means; and limiting driving force for at least one of the reciprocating means and the moving means when thrust force is generated. Accordingly, the reciprocation-to-rotation converting means and the rotation-to-reciprocation converting means can be moved to predetermined positions rapidly. Moreover, after the reciprocation-to-rotation converting means and the rotation-to-reciprocation converting means are moved to the predetermined positions, any thrust force can be generated in the output portion of the rotation-to-reciprocation converting means. Hence, the operation for generating any thrust force in the output portion of the rotation-to-reciprocation converting means in the predetermined position becomes rapid.

Further, according to the present invention, when the driving gear and the driven gear are made to mesh with each other, controlling is made so that the positions of teeth of the driving gear and the driven gear are detected by sensors and so that the gears are rotated at angles enabling gear mesh on the basis of signals detected by the sensors. Hence, the gears can be made to mesh with each other smoothly.

Further, according to the present invention, controlling is made so that the gear angles at the time of shifting from the gear mesh state to the gear separation state are stored, so that the rotation of the first and second driving gears are stopped in the gear separation state, and so that the first and second driven gears are rotated at the stored gear angles when the first and second driving gears are made to mesh with the first and second driven gears from the gear separation state. Hence, two pairs of gears can be made to mesh with each other smoothly by simple control.

Further, according to the present invention, control is performed by the steps of: performing an operation to drive the moving means and the reciprocating portion of the rotation-to-reciprocation converting means in reverse directions to each other; and restoring the thrust converter to an origin on the basis of a position where the thrust converter at an operating range limit due to a mechanism limitation of either a mechanical stopper or the thrust converter. Accordingly, the origin restoration can be performed automatically.

Further, the present invention has the configuration to be constituted by: a high-order controller; a first controller for controlling the moving means; and a second controller for controlling the reciprocating means, wherein, in a second operation mode in which the moving means is driven to move the reciprocation-to-rotation converting means and the rotation-to-reciprocation converting means, the first controller controls the moving means on the basis of an instruction given from the high-order controller and outputs an instruction based on a quantity of movement of the moving means to the second controller, and the second controller controls the reciprocating means on the basis of the instruction based on the quantity of movement of the moving means from the first controller, and in a first operation mode in which the reciprocating means is driven to operate the reciprocating portion of the rotation-to-reciprocation converting means through a reciprocation-rotation means and the rotation-to-reciprocation converting means in a condition that the moving means is stopped, the second controller controls the reciprocating means on the basis of an instruction outputted from the high-order controller and inputted through the first controller. Accordingly, the high-order controller treats the thrust converter as one driving source so that the signal processing load or output portion, wiring, or the like, can be reduced.

Industrial Applicability

The thrust converter and the method and apparatus for controlling the thrust converter according to the present invention can be applied to a press working machine and a chucking machine of a lathe. They can be applied also to any other apparatus which needs a reduction gear.

1. A thrust converter comprising:
a reciprocating means;
a reciprocation-to-rotation converting means for converting a reciprocating motion of the reciprocating means into a rotary motion;
a rotation-to-reciprocation converting means located on the same axial line as that of the reciprocation-to-rotation converting means for converting the rotary motion of the reciprocation-to-rotation converting means into a reciprocating motion;
a reaction force receiving means for receiving reaction force against the reciprocating motion of the rotation-to-reciprocation converting means; and
a moving means for moving the reciprocation-to-rotation converting means and the rotation-to-reciprocation converting means in an axial direction separately from driving force due to the reciprocating motion of the reciprocating means.

2. The thrust converter according to claim 1, wherein when the reciprocation-to-rotation converting means and the rotation-to-reciprocation converting means are moved by the moving means, a quantity of the movement is absorbed by a part of the reciprocating means.

3. The thrust converter according to claim 1, wherein the moving means includes:
a connection means having a first screw, and a second screw thread-engaged with the first screw; and
a driving means for driving rotation of at least one screw of the connection means to thereby move the reciprocation-to-rotation converting means and the rotation-to-reciprocation converting means.

4. The thrust converter according to claim 1, wherein the moving means includes:
a connection means having a first screw, and a second screw thread-engaged with the first screw;
a driving means for driving rotation of both screws of the connection means to thereby move the reciprocation-to-rotation converting means and the rotation-to-reciprocation converting means; and
a rotation transferring means constituted by gears and interposed between the driving means and the connection means for transferring the driving force of the driving means so that the first and second screws of the connection means rotate at different rotational velocities.

5. The thrust converter according to claim 1, wherein the moving means includes:
a connection means having a first screw, and a second screw thread-engaged with the first screw;
a driving means for driving rotation of at least one screw of the connection means to thereby move the reciprocation-to-rotation converting means and the rotation-to-reciprocation converting means; and
a transfer/disconnection means interposed between the driving means and the connection means for transferring the driving force of the driving means to the coupling means and disconnecting the transfer.

6. The thrust converter according to claim 1, wherein the moving means includes:
a motor having a feed screw on its rotary shaft;
a moving shaft thread-engaged with a feed screw portion of the rotary shaft so that the moving shaft moves axially with the rotation of the rotary shaft and stops in a predetermined position to rotate;
a first driving gear provided on the moving shaft; a second driving gear provided on the moving shaft at a predetermined distance from the first driving gear;
a connection means having a first screw, and a second screw thread-engaged with the first screw;
a first driven gear provided on the first screw of the connection means so as to mesh with the first driving gear; and
a second driven gear provided on the second screw of the connection means so as to mesh with the second driving gear and having teeth different in number from those of the first driven gear,
wherein the motor is driven to move the moving shaft to a position where the first and second driving gears and the first and second driven gears mesh with each other simultaneously;
the moving shaft is stopped in this position and driven to rotate to thereby drive the first and second screws of the connection means to rotate by differential motion through the first and second driving gears and the first and second driven gears to move the reciprocation-to-rotation converting means and the rotation-to-reciprocation converting means to predetermined positions; and
when the reciprocation-to-rotation converting means and the rotation-to-reciprocation converting means are moved to the predetermined positions, the moving shaft is moved to a position where the first and second driving gears do not mesh with the first and second driven gears respectively.

7. The thrust converter according to claim 1, wherein the moving means includes:
a motor having a feed screw on its rotary shaft;
a moving shaft thread-engaged with a feed screw portion of the rotary shaft so that the moving shaft moves axially with rotation of the rotary shaft and stops in a predetermined position to rotate;
a driving gear provided on the moving shaft;
a connection means having a first screw, and a second screw thread-engaged with the first screw;
a driven gear provided on the first screw of the connection means so as to mesh with the driving gear; and
a whirl-stop means for whirl-stopping the second screw of the connection means at a desired time,
wherein the motor is driven to move the moving shaft to a position where the driving gear and the driven gear mesh with each other;
the moving shaft is stopped in this position and driven to rotate while the second screw is whirl-stopped by the whirl-stop means to thereby drive the first screw of the connection means to rotate through the driving gear and the driven gear to move the reciprocation-to-rotation converting means and the rotation-to-reciprocation converting means to predetermined positions; and
when the reciprocation-to-rotation converting means and the rotation-to-reciprocation converting means are moved to the predetermined positions, the moving shaft is moved to a position where the driving gear does not mesh with the driven gear.

8. The thrust converter according to claim 1, wherein the moving means includes:
a connection means having a first screw, and a second screw thread-engaged with the first screw;
a motor using the first screw of the connection means as a rotor; and awhirl-stop means for whirl-stopping the second screw of the connection means at a desired time,
wherein in a condition that the second screw of the connection means is whirl-stopped by the whirl-stop means, the motor is driven to drive the first screw of the connection means to rotate to thereby move the reciprocation-to-rotation converting means and the rotation-to-reciprocation converting means to predetermined positions.

9. The thrust converter according to claim 1, wherein the moving means includes:
a connection means having a first screw, and a second screw thread-engaged with the first screw;
a first motor using the first screw of the connection means as a rotor; and
a second motor using the second screw of the connection means as a rotor,
wherein in a condition that the second screw of the connection means is whirl-stopped by excitation of the second motor, the first motor is driven to drive the first screw of the connection means to rotate to thereby move the reciprocation-to-rotation converting means and the rotation-to-reciprocation converting means to predetermined positions.

10. The thrust converter according to claim 1, wherein the moving means includes:
a connection means having a first screw, and a second screw thread-engaged with the first screw; and
a motor using the first screw of the connection means as a first rotor and using the second screw of the connection means as a second rotor, the first rotor being different in number of poles from the second rotor,
wherein the motor is driven to drive the first and second screws of the connection means to rotate to thereby move the reciprocation-to-rotation converting means and the rotation-to-reciprocation converting means to predetermined positions.

11. The thrust converter according to any one of claims 1 through 10, wherein the reciprocating means includes:
a motor; and
a motor rotation-to-reciprocation converting means for converting a rotary motion of the rotary shaft of the motor into a reciprocating motion.

12. The thrust converter according to any one of claims 1 through 10, wherein the reciprocating means includes:
a motor disposed on an axis different from the axial line of the reciprocation-to-rotation converting means;
a motor rotation-to-reciprocation converting means disposed on the same axis as the axial line of the reciprocation-to-rotation converting means for converting a rotary motion of the rotary shaft of the motor into a reciprocating motion; and
a motor rotation transferring means for transferring the rotation driving force of the motor to the motor rotation-to-reciprocation converting means.

13. The thrust converter according to any one of claims 1 through 10, wherein the reciprocating means includes:
a motor disposed on an axis different from the axial line of the reciprocation-to-rotation converting means;
a motor rotation-to-reciprocation converting means disposed on an axis the same as an axial line of a rotary axis of the motor for converting a rotary motion of the rotary shaft of the motor into a reciprocating motion; and
a thrust transferring means for transferring an axial thrust force of the motor rotation-to-reciprocation converting means to the reciprocation-to-rotation converting means.

14. The thrust converter according to claim 13, wherein the motor rotation-to-reciprocation converting means has a screw provided on the rotary shaft of the motor, and a nut thread-engaged with the screw; and
the thrust transferring means has a reciprocating portion for supporting a bearing for rotatably bearing the reciprocation-to-rotation converting means, and a thrust transfer plate for connecting the reciprocating portion and the nut to each other.

15. The thrust converter according to claim 14, wherein the thrust transfer plate is connected to the nut through a flexible coupling.

16. The thrust converter according to any one of claims 3 through 13, wherein one screw of the connection means is rotatably supported with respect to the reciprocation-to-rotation converting means.

17. The thrust converter according to any one of claims 3 through 13, wherein one screw of the connection means is rotatably supported with respect to the reciprocation-to-rotation converting means; and
the other screw of the connection means is rotatably supported with respect to a part of the reaction force receiving means.

18. The thrust converter according to claim 7 or 8, wherein the whirl-stop means is constituted by an electromagnetic brake; and
a part of the whirl-stopped screw of the connection means is provided as a brake disk.

19. The thrust converter according to claim 7 or 8, wherein the whirl-stop means is constituted by an electromagnetic brake; and the second screw prohibited from rotating by the electromagnetic brake is connected to an external driving means.

20. A control method for controlling a thrust converter defined in claim 1, comprising the steps of:
driving the moving means to move the reciprocation-to-rotation converting means and the rotation-to-reciprocation converting means to predetermined positions; and
driving the reciprocating means after the arrival of the reciprocation-to-rotation converting means and the rotation-to-reciprocation converting means at the predetermined positions to thereby operate the reciprocating portion of the rotation-to-reciprocation converting means through the reciprocation-to-rotation converting means and the rotation-to-reciprocation converting means.

21. A control method for controlling a thrust converter defined in claim 1, comprising the steps of:
performing an operation in a first operation mode in which, in a condition that the moving means is stopped, the reciprocating means is driven to operate the reciprocating portion of the rotation-to-reciprocation converting means through a reciprocation-rotation means and the rotation-to-reciprocation converting means;
performing an operation in a second operation mode in which the moving means is driven to move the reciprocation-to-rotation converting means and the rotation-to-reciprocation converting means; and
limiting driving force for at least one of the reciprocating means and the moving means when thrust force is generated.

22. A controller for controlling a thrust converter defined in claim 1, comprising:
means for driving the moving means to move the reciprocation-to-rotation converting means and the rotation-to-reciprocation converting means to predetermined positions and for driving the reciprocating means after the arrival of the reciprocation-to-rotation converting means and the rotation-to-reciprocation converting means at the predetermined positions to thereby operate the reciprocating portion of the rotation-to-reciprocation converting means through the reciprocation-to-rotation converting means and the rotation-to-reciprocation converting means.

23. A controller for controlling a thrust converter defined in claim 1, comprising:
means for performing an operation in a first operation mode in which, in a condition that the moving means is stopped, the reciprocating means is driven to operate the reciprocating portion of the rotation-to-reciprocation converting means through a reciprocation-rotation means and the rotation-to-reciprocation converting means, for performing an operation in a second operation mode in which the moving means is driven to move the reciprocation-to-rotation converting means and the rotation-to-reciprocation converting means, and for limiting driving force for at least one of the reciprocating means and the moving means when thrust force is generated.

24. A method for controlling a thrust converter defined in claim 6 or 7, comprising the steps of:
making sensors detect the positions of teeth of the driving gear and the driven gear when the driving gear is made to mesh with the driven gear; and
rotating the gears at angles enabling the mesh on the basis of signals detected by the sensors.

25. A controller for controlling a thrust converter defined in claim 6 or 7, comprising:
a plurality of sensors for detecting the positions of teeth of the driving gear and the driven gear; and
means for rotating the gears at angles enabling gear mesh on the basis of signals detected by the sensors when the driving gear is made to mesh with the driven gear.

26. A controlling method for controlling a thrust converter defined in claim 6, comprising the steps of:
storing gear angles at a time of shifting from a gear mesh state to a gear separation state;
stopping rotation of the first and second driving gears in the gear separation state; and
rotating the first and second driven gears at the stored gear angles when the first and second driving gears are made to mesh with the first and second driven gears from the gear separation state.

27. A controller for controlling a thrust converter defined in claim 6, comprising:
a storage means for storing gear angles at the time of shifting from a gear mesh state to a gear separation state;
means for stopping the rotation of the first and second driving gears in the gear separation state; and
means for reading the gear angles stored in the storage means and rotating the first and second driven gears at the gear angles when the first and second driving gears are made to mesh with the first and second driven gears from the gear separation state.

28. A method for controlling a thrust converter defined in claim 1, comprising the steps of:
performing an operation to drive the moving means and the reciprocating portion of the rotation-to-reciprocation converting means in reverse directions to each other; and
restoring the thrust converter to an origin on the basis of a position where the thrust converter at an operating range limit due to a mechanism limitation of either a mechanical stopper or the thrust converter.

29. A controller for controlling a thrust converter defined in claim 1, comprising:
means for performing an operation to drive the moving means and the reciprocating portion of the rotation-to-reciprocation converting means in reverse directions to each other and for restoring a position arriving at an operating range limit due to a mechanism limitation of either a mechanical stopper or the thrust converter to the origin.

30. A controller for controlling a thrust converter defined in claim 1, comprising:
a high-order controller;
a first controller for controlling the moving means; and
a second controller for controlling the reciprocating means,
wherein in a second operation mode in which the moving means is driven to move the reciprocation-to-rotation converting means and the rotation-to-reciprocation converting means, the first controller controls the moving means on the basis of an instruction given from the high-order controller and outputs an instruction based on a quantity of movement of the moving means to the second controller, and the second controller controls the reciprocating means on the basis of the instruction based on the quantity of movement of the moving means from the first controller; and
in a first operation mode in which the reciprocating means is driven to operate the reciprocating portion of the rotation-to-reciprocation converting means through a reciprocation-rotation means and the rotation-to-reciprocation converting means in a condition that the moving means is stopped, the second controller controls the reciprocating means on the basis of an instruction outputted from the high-order controller and inputted through the first controller.
